(19) United States
(12) Patent Application Publication
(10) Pub. No.: US 2026/0056604 A1
(43) Pub. Date: Feb. 26, 2026

(54) USER INTERFACES AND TECHNIQUES FOR RESPONDING TO NOTIFICATIONS

(71) Applicant: Apple Inc., Cupertino, CA (US)

(72) Inventors: Agatha Y. YU, Oakland, CA (US); Hans C. LEE, San Martin, CA (US); Jamie L. MYROLD, Chicago, IL (US); Ji Chen Jason YUAN, Cupertino, CA (US); Mark A. PAULEY, Mountain View, CA (US); Tuhin KUMAR, San Francisco, CA (US)

(21) Appl. No.: 19/375,080

(22) Filed: Oct. 30, 2025

Related U.S. Application Data
(63) Continuation of application No. PCT/US2024/048449, filed on Sep. 25, 2024.
(60) Provisional application No. 63/541,844, filed on Sep. 30, 2023.
(60) Provisional application No. 63/541,845, filed on Sep. 30, 2023.
(60) Provisional application No. 63/541,824, filed on Sep. 30, 2023.

(51) Int. Cl. G06F 3/01

(52) U.S. Cl. CPC G06F 3/011

(57) ABSTRACT

The present disclosure generally relates to user interfaces.

### CROSS-REFERENCE TO RELATED APPLICATIONS

This application is a continuing application of International Patent Application Serial No. PCT/US2024/048449, entitled “USER INTERFACES AND TECHNIQUES FOR RESPONDING TO NOTIFICATIONS,” filed Sep. 25, 2024, which claims priority to U.S. Provisional Patent Application Ser. No. 63/541,844, filed Sep. 30, 2023, to U.S. Provisional Patent Application Ser. No. 63/541,845, filed Sep. 30, 2023, and to U.S. Provisional Patent Application Ser. No. 63/541,824, filed Sep. 30, 2023. The content of these application(s) is hereby incorporated by reference in their entirety.

### BACKGROUND

Users often use communication applications stored on a computer system to communicate with others. Such communication applications often provide images of the user via the communication applications.

Computer systems are often used to research steps for various processes. Such processes can include recipes, proper workout form, and/or self-improvement.

Users often use computer systems to share content. Such content can be shared and generated across multiple computer systems.

### SUMMARY

Existing techniques for moving a computer system based on a notification using electronic devices are generally cumbersome and inefficient. For example, some existing techniques use a complex and time-consuming user interface, which may include multiple key presses or keystrokes. Some existing techniques require more time than necessary, wasting user time and device energy. This latter consideration is particularly important in battery-operated devices.

Accordingly, the present technique provides electronic devices with faster, more efficient methods for various operations. Such methods and interfaces optionally complement or replace other methods. Such methods and interfaces reduce the cognitive burden on a user and produce a more efficient human-machine interface. For battery-operated computing devices, such methods and interfaces conserve power and increase the time between battery charges. Such methods and interfaces may complement or replace other methods for the same operation.

In some embodiments, a method that is performed at a computer system that is in communication with a movement component is described. In some embodiments, the method comprises: while the computer system is at a first position in an environment, receiving a notification corresponding to a first user; and in response to receiving the notification corresponding to the first user, moving, via the movement component, a portion of the computer system to a second position, different from the first position, in the environment, wherein the second position corresponds to a location of the first user in the environment.

In some embodiments, a non-transitory computer-readable storage medium storing one or more programs configured to be executed by one or more processors of a computer system that is in communication with a movement component is described. In some embodiments, the one or more programs includes instructions for: while the computer system is at a first position in an environment, receiving a notification corresponding to a first user; and in response to receiving the notification corresponding to the first user, moving, via the movement component, a portion of the computer system to a second position, different from the first position, in the environment, wherein the second position corresponds to a location of the first user in the environment.

In some embodiments, a transitory computer-readable storage medium storing one or more programs configured to be executed by one or more processors of a computer system that is in communication with a movement component is described. In some embodiments, the one or more programs includes instructions for: while the computer system is at a first position in an environment, receiving a notification corresponding to a first user; and in response to receiving the notification corresponding to the first user, moving, via the movement component, a portion of the computer system to a second position, different from the first position, in the environment, wherein the second position corresponds to a location of the first user in the environment.

In some embodiments, a computer system that is in communication with a movement component is described. In some embodiments, the computer system comprises one or more processors and memory storing one or more programs configured to be executed by the one or more processors. In some embodiments, the one or more programs includes instructions for: while the computer system is at a first position in an environment, receiving a notification corresponding to a first user; and in response to receiving the notification corresponding to the first user, moving, via the movement component, a portion of the computer system to a second position, different from the first position, in the environment, wherein the second position corresponds to a location of the first user in the environment.

In some embodiments, a computer system that is in communication with a movement component is described. In some embodiments, the computer system comprises means for performing each of the following steps: while the computer system is at a first position in an environment, receiving a notification corresponding to a first user; and in response to receiving the notification corresponding to the first user, moving, via the movement component, a portion of the computer system to a second position, different from the first position, in the environment, wherein the second position corresponds to a location of the first user in the environment.

In some embodiments, a computer program product is described. In some embodiments, the computer program product comprises one or more programs configured to be executed by one or more processors of a computer system that is in communication with a movement component. In some embodiments, the one or more programs include instructions for: while the computer system is at a first position in an environment, receiving a notification corresponding to a first user; and in response to receiving the notification corresponding to the first user, moving, via the movement component, a portion of the computer system to a second position, different from the first position, in the environment, wherein the second position corresponds to a location of the first user in the environment.

In some embodiments, a method that is performed at a computer system that is in communication with one or more output devices and a microphone is described. In some embodiments, the method comprises: detecting, via the microphone, a verbal request corresponding to a request to identify one or more objects present in a physical environment; and in response to detecting the verbal request: in accordance with a determination that a first object is present in the physical environment and that the verbal request corresponds to the first object, outputting, via the one or more output devices, a first indication of the first object; and in accordance with a determination that a second object is present in the physical environment and that the verbal request corresponds to the second object, outputting, via the one or more output devices, a second indication of the second object, wherein the second indication is different from the first indication.

In some embodiments, a non-transitory computer-readable storage medium storing one or more programs configured to be executed by one or more processors of a computer system that is in communication with one or more output devices and a microphone is described. In some embodiments, the one or more programs includes instructions for: detecting, via the microphone, a verbal request corresponding to a request to identify one or more objects present in a physical environment; and in response to detecting the verbal request: in accordance with a determination that a first object is present in the physical environment and that the verbal request corresponds to the first object, outputting, via the one or more output devices, a first indication of the first object; and in accordance with a determination that a second object is present in the physical environment and that the verbal request corresponds to the second object, outputting, via the one or more output devices, a second indication of the second object, wherein the second indication is different from the first indication.

In some embodiments, a transitory computer-readable storage medium storing one or more programs configured to be executed by one or more processors of a computer system that is in communication with one or more output devices and a microphone is described. In some embodiments, the one or more programs includes instructions for: detecting, via the microphone, a verbal request corresponding to a request to identify one or more objects present in a physical environment; and in response to detecting the verbal request: in accordance with a determination that a first object is present in the physical environment and that the verbal request corresponds to the first object, outputting, via the one or more output devices, a first indication of the first object; and in accordance with a determination that a second object is present in the physical environment and that the verbal request corresponds to the second object, outputting, via the one or more output devices, a second indication of the second object, wherein the second indication is different from the first indication.

In some embodiments, a computer system that is in communication with one or more output devices and a microphone is described. In some embodiments, the computer system comprises one or more processors and memory storing one or more programs configured to be executed by the one or more processors. In some embodiments, the one or more programs includes instructions for: detecting, via the microphone, a verbal request corresponding to a request to identify one or more objects present in a physical environment; and in response to detecting the verbal request: in accordance with a determination that a first object is present in the physical environment and that the verbal request corresponds to the first object, outputting, via the one or more output devices, a first indication of the first object; and in accordance with a determination that a second object is present in the physical environment and that the verbal request corresponds to the second object, outputting, via the one or more output devices, a second indication of the second object, wherein the second indication is different from the first indication.

In some embodiments, a computer system that is in communication with one or more output devices and a microphone is described. In some embodiments, the computer system comprises means for performing each of the following steps: detecting, via the microphone, a verbal request corresponding to a request to identify one or more objects present in a physical environment; and in response to detecting the verbal request: in accordance with a determination that a first object is present in the physical environment and that the verbal request corresponds to the first object, outputting, via the one or more output devices, a first indication of the first object; and in accordance with a determination that a second object is present in the physical environment and that the verbal request corresponds to the second object, outputting, via the one or more output devices, a second indication of the second object, wherein the second indication is different from the first indication.

In some embodiments, a computer program product is described. In some embodiments, the computer program product comprises one or more programs configured to be executed by one or more processors of a computer system that is in communication with one or more output devices and a microphone. In some embodiments, the one or more programs include instructions for: detecting, via the microphone, a verbal request corresponding to a request to identify one or more objects present in a physical environment; and in response to detecting the verbal request: in accordance with a determination that a first object is present in the physical environment and that the verbal request corresponds to the first object, outputting, via the one or more output devices, a first indication of the first object; and in accordance with a determination that a second object is present in the physical environment and that the verbal request corresponds to the second object, outputting, via the one or more output devices, a second indication of the second object, wherein the second indication is different from the first indication.

In some embodiments, a method that is performed at a computer system that is in communication with one or more output devices, a microphone, and a movement component is described. In some embodiments, the method comprises: while a portion of the computer system is in a first orientation, detecting, via the microphone, an input corresponding to a verbal request; in response to detecting the input corresponding to the verbal request, physically moving, via the movement component, the portion of the computer system from the first orientation to a second orientation different from the first orientation; and after physically moving the portion to the second orientation: in accordance with a determination that a first user is detected in a first image of a physical environment, outputting, via the one or more output devices, a first response to the verbal request; and in accordance with a determination that a second user is detected in a second image of the physical environment, outputting, via the one or more output devices, a second response to the verbal request, wherein the second user is different from the first user, and wherein the second response is different from the first response.

In some embodiments, a non-transitory computer-readable storage medium storing one or more programs configured to be executed by one or more processors of a computer system that is in communication with one or more output devices, a microphone, and a movement component is described. In some embodiments, the one or more programs includes instructions for: while a portion of the computer system is in a first orientation, detecting, via the microphone, an input corresponding to a verbal request; in response to detecting the input corresponding to the verbal request, physically moving, via the movement component, the portion of the computer system from the first orientation to a second orientation different from the first orientation; and after physically moving the portion to the second orientation: in accordance with a determination that a first user is detected in a first image of a physical environment, outputting, via the one or more output devices, a first response to the verbal request; and in accordance with a determination that a second user is detected in a second image of the physical environment, outputting, via the one or more output devices, a second response to the verbal request, wherein the second user is different from the first user, and wherein the second response is different from the first response.

In some embodiments, a transitory computer-readable storage medium storing one or more programs configured to be executed by one or more processors of a computer system that is in communication with one or more output devices, a microphone, and a movement component is described. In some embodiments, the one or more programs includes instructions for: while a portion of the computer system is in a first orientation, detecting, via the microphone, an input corresponding to a verbal request; in response to detecting the input corresponding to the verbal request, physically moving, via the movement component, the portion of the computer system from the first orientation to a second orientation different from the first orientation; and after physically moving the portion to the second orientation: in accordance with a determination that a first user is detected in a first image of a physical environment, outputting, via the one or more output devices, a first response to the verbal request; and in accordance with a determination that a second user is detected in a second image of the physical environment, outputting, via the one or more output devices, a second response to the verbal request, wherein the second user is different from the first user, and wherein the second response is different from the first response.

In some embodiments, a computer system that is in communication with one or more output devices, a microphone, and a movement component is described. In some embodiments, the computer system comprises one or more processors and memory storing one or more programs configured to be executed by the one or more processors. In some embodiments, the one or more programs includes instructions for: while a portion of the computer system is in a first orientation, detecting, via the microphone, an input corresponding to a verbal request; in response to detecting the input corresponding to the verbal request, physically moving, via the movement component, the portion of the computer system from the first orientation to a second orientation different from the first orientation; and after physically moving the portion to the second orientation: in accordance with a determination that a first user is detected in a first image of a physical environment, outputting, via the one or more output devices, a first response to the verbal request; and in accordance with a determination that a second user is detected in a second image of the physical environment, outputting, via the one or more output devices, a second response to the verbal request, wherein the second user is different from the first user, and wherein the second response is different from the first response.

In some embodiments, a computer system that is in communication with one or more output devices, a microphone, and a movement component is described. In some embodiments, the computer system comprises means for performing each of the following steps: while a portion of the computer system is in a first orientation, detecting, via the microphone, an input corresponding to a verbal request; in response to detecting the input corresponding to the verbal request, physically moving, via the movement component, the portion of the computer system from the first orientation to a second orientation different from the first orientation; and after physically moving the portion to the second orientation: in accordance with a determination that a first user is detected in a first image of a physical environment, outputting, via the one or more output devices, a first response to the verbal request; and in accordance with a determination that a second user is detected in a second image of the physical environment, outputting, via the one or more output devices, a second response to the verbal request, wherein the second user is different from the first user, and wherein the second response is different from the first response.

In some embodiments, a computer program product is described. In some embodiments, the computer program product comprises one or more programs configured to be executed by one or more processors of a computer system that is in communication with one or more output devices, a microphone, and a movement component. In some embodiments, the one or more programs include instructions for: while a portion of the computer system is in a first orientation, detecting, via the microphone, an input corresponding to a verbal request; in response to detecting the input corresponding to the verbal request, physically moving, via the movement component, the portion of the computer system from the first orientation to a second orientation different from the first orientation; and after physically moving the portion to the second orientation: in accordance with a determination that a first user is detected in a first image of a physical environment, outputting, via the one or more output devices, a first response to the verbal request; and in accordance with a determination that a second user is detected in a second image of the physical environment, outputting, via the one or more output devices, a second response to the verbal request, wherein the second user is different from the first user, and wherein the second response is different from the first response.

In some embodiments, a method that is performed at a computer system that is in communication with one or more input devices and one or more output devices is described. In some embodiments, the method comprises: detecting, via the one or more input devices, a request to perform a process including a plurality of steps; after detecting the request to perform the process, outputting, via the one or more output devices, an indication of a first step of the plurality of steps; after outputting the indication of the first step, detecting, via the one or more input devices, an action performed by a user; and in response to detecting the action performed by the user and without detecting an input directed to the one or more input devices, displaying, via the one or more output devices, an indication of a second step of the plurality of steps, wherein the second step is different from the first step, and wherein the indication of the second step is different from the indication of the first step.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, a request to perform a process including a plurality of steps; after detecting the request to perform the process, outputting, via the one or more output devices, an indication of a first step of the plurality of steps; after outputting the indication of the first step, detecting, via the one or more input devices, an action performed by a user; and in response to detecting the action performed by the user and without detecting an input directed to the one or more input devices, displaying, via the one or more output devices, an indication of a second step of the plurality of steps, wherein the second step is different from the first step, and wherein the indication of the second step is different from the indication of the first step.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, a request to perform a process including a plurality of steps; after detecting the request to perform the process, outputting, via the one or more output devices, an indication of a first step of the plurality of steps; after outputting the indication of the first step, detecting, via the one or more input devices, an action performed by a user; and in response to detecting the action performed by the user and without detecting an input directed to the one or more input devices, displaying, via the one or more output devices, an indication of a second step of the plurality of steps, wherein the second step is different from the first step, and wherein the indication of the second step is different from the indication of the first step.

In some embodiments, a computer system that is in communication with one or more input devices and one or more output devices is described. In some embodiments, the computer system comprises one or more processors and memory storing one or more programs configured to be executed by the one or more processors. In some embodiments, the one or more programs includes instructions for: detecting, via the one or more input devices, a request to perform a process including a plurality of steps; after detecting the request to perform the process, outputting, via the one or more output devices, an indication of a first step of the plurality of steps; after outputting the indication of the first step, detecting, via the one or more input devices, an action performed by a user; and in response to detecting the action performed by the user and without detecting an input directed to the one or more input devices, displaying, via the one or more output devices, an indication of a second step of the plurality of steps, wherein the second step is different from the first step, and wherein the indication of the second step is different from the indication of the first step.

In some embodiments, a computer system that is in communication with one or more input devices and one or more output devices is described. In some embodiments, the computer system comprises means for performing each of the following steps: detecting, via the one or more input devices, a request to perform a process including a plurality of steps; after detecting the request to perform the process, outputting, via the one or more output devices, an indication of a first step of the plurality of steps; after outputting the indication of the first step, detecting, via the one or more input devices, an action performed by a user; and in response to detecting the action performed by the user and without detecting an input directed to the one or more input devices, displaying, via the one or more output devices, an indication of a second step of the plurality of steps, wherein the second step is different from the first step, and wherein the indication of the second step is different from the indication of the first step.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting, via the one or more input devices, a request to perform a process including a plurality of steps; after detecting the request to perform the process, outputting, via the one or more output devices, an indication of a first step of the plurality of steps; after outputting the indication of the first step, detecting, via the one or more input devices, an action performed by a user; and in response to detecting the action performed by the user and without detecting an input directed to the one or more input devices, displaying, via the one or more output devices, an indication of a second step of the plurality of steps, wherein the second step is different from the first step, and wherein the indication of the second step is different from the indication of the first step.

In some embodiments, a method that is performed at a computer system that is in communication with one or more sensors and one or more output devices is described. In some embodiments, the method comprises: detecting, via the one or more sensors, that a user is performing a first set of one or more actions to complete a task; while detecting that the user is performing the first set of one or more actions to complete the task, detecting a performance of a first action by the user; and in response to detecting the performance of the first action by the user: in accordance with a determination that the performance of the first action satisfies a set of one or more criteria with respect to a respective action in the first set of one or more actions to complete the task, outputting, via the one or more output devices, an indication that an error occurred with respect to the respective action being performed; and in accordance with a determination that the performance of the first action does not satisfy the set of one or more criteria with respect to the respective action in the first set of one or more actions to complete the task, forgoing outputting, via the one or more output devices, the indication that the error occurred with respect to the respective action being performed.

In some embodiments, a non-transitory computer-readable storage medium storing one or more programs configured to be executed by one or more processors of a computer system that is in communication with one or more sensors and one or more output devices is described. In some embodiments, the one or more programs includes instructions for: detecting, via the one or more sensors, that a user is performing a first set of one or more actions to complete a task; while detecting that the user is performing the first set of one or more actions to complete the task, detecting a performance of a first action by the user; and in response to detecting the performance of the first action by the user: in accordance with a determination that the performance of the first action satisfies a set of one or more criteria with respect to a respective action in the first set of one or more actions to complete the task, outputting, via the one or more output devices, an indication that an error occurred with respect to the respective action being performed; and in accordance with a determination that the performance of the first action does not satisfy the set of one or more criteria with respect to the respective action in the first set of one or more actions to complete the task, forgoing outputting, via the one or more output devices, the indication that the error occurred with respect to the respective action being performed.

In some embodiments, a transitory computer-readable storage medium storing one or more programs configured to be executed by one or more processors of a computer system that is in communication with one or more sensors and one or more output devices is described. In some embodiments, the one or more programs includes instructions for: detecting, via the one or more sensors, that a user is performing a first set of one or more actions to complete a task; while detecting that the user is performing the first set of one or more actions to complete the task, detecting a performance of a first action by the user; and in response to detecting the performance of the first action by the user: in accordance with a determination that the performance of the first action satisfies a set of one or more criteria with respect to a respective action in the first set of one or more actions to complete the task, outputting, via the one or more output devices, an indication that an error occurred with respect to the respective action being performed; and in accordance with a determination that the performance of the first action does not satisfy the set of one or more criteria with respect to the respective action in the first set of one or more actions to complete the task, forgoing outputting, via the one or more output devices, the indication that the error occurred with respect to the respective action being performed.

In some embodiments, a computer system that is in communication with one or more sensors and one or more output devices is described. In some embodiments, the computer system comprises one or more processors and memory storing one or more programs configured to be executed by the one or more processors. In some embodiments, the one or more programs includes instructions for: detecting, via the one or more sensors, that a user is performing a first set of one or more actions to complete a task; while detecting that the user is performing the first set of one or more actions to complete the task, detecting a performance of a first action by the user; and in response to detecting the performance of the first action by the user: in accordance with a determination that the performance of the first action satisfies a set of one or more criteria with respect to a respective action in the first set of one or more actions to complete the task, outputting, via the one or more output devices, an indication that an error occurred with respect to the respective action being performed; and in accordance with a determination that the performance of the first action does not satisfy the set of one or more criteria with respect to the respective action in the first set of one or more actions to complete the task, forgoing outputting, via the one or more output devices, the indication that the error occurred with respect to the respective action being performed.

In some embodiments, a computer system that is in communication with one or more sensors and one or more output devices is described. In some embodiments, the computer system comprises means for performing each of the following steps: detecting, via the one or more sensors, that a user is performing a first set of one or more actions to complete a task; while detecting that the user is performing the first set of one or more actions to complete the task, detecting a performance of a first action by the user; and in response to detecting the performance of the first action by the user: in accordance with a determination that the performance of the first action satisfies a set of one or more criteria with respect to a respective action in the first set of one or more actions to complete the task, outputting, via the one or more output devices, an indication that an error occurred with respect to the respective action being performed; and in accordance with a determination that the performance of the first action does not satisfy the set of one or more criteria with respect to the respective action in the first set of one or more actions to complete the task, forgoing outputting, via the one or more output devices, the indication that the error occurred with respect to the respective action being performed.

In some embodiments, a computer program product is described. In some embodiments, the computer program product comprises one or more programs configured to be executed by one or more processors of a computer system that is in communication with one or more sensors and one or more output devices. In some embodiments, the one or more programs include instructions for: detecting, via the one or more sensors, that a user is performing a first set of one or more actions to complete a task; while detecting that the user is performing the first set of one or more actions to complete the task, detecting a performance of a first action by the user; and in response to detecting the performance of the first action by the user: in accordance with a determination that the performance of the first action satisfies a set of one or more criteria with respect to a respective action in the first set of one or more actions to complete the task, outputting, via the one or more output devices, an indication that an error occurred with respect to the respective action being performed; and in accordance with a determination that the performance of the first action does not satisfy the set of one or more criteria with respect to the respective action in the first set of one or more actions to complete the task, forgoing outputting, via the one or more output devices, the indication that the error occurred with respect to the respective action being performed.

In some embodiments, a method that is performed at a first computer system that is in communication with a movement component is described. In some embodiments, the method comprises: detecting a request corresponding to transferring content between the first computer system and a second computer system; and in response to detecting the request corresponding to transferring content between the first computer system and the second computer system, moving, via the movement component, a portion of the first computer system toward the second computer system.

In some embodiments, a non-transitory computer-readable storage medium storing one or more programs configured to be executed by one or more processors of a first computer system that is in communication with a movement component is described. In some embodiments, the one or more programs includes instructions for: detecting a request corresponding to transferring content between the first computer system and a second computer system; and in response to detecting the request corresponding to transferring content between the first computer system and the second computer system, moving, via the movement component, a portion of the first computer system toward the second computer system.

In some embodiments, a transitory computer-readable storage medium storing one or more programs configured to be executed by one or more processors of a first computer system that is in communication with a movement component is described. In some embodiments, the one or more programs includes instructions for: detecting a request corresponding to transferring content between the first computer system and a second computer system; and in response to detecting the request corresponding to transferring content between the first computer system and the second computer system, moving, via the movement component, a portion of the first computer system toward the second computer system.

In some embodiments, a first computer system that is in communication with a movement component is described. In some embodiments, the first computer system comprises one or more processors and memory storing one or more programs configured to be executed by the one or more processors. In some embodiments, the one or more programs includes instructions for: detecting a request corresponding to transferring content between the first computer system and a second computer system; and in response to detecting the request corresponding to transferring content between the first computer system and the second computer system, moving, via the movement component, a portion of the first computer system toward the second computer system.

In some embodiments, a first computer system that is in communication with a movement component is described. In some embodiments, the first computer system comprises means for performing each of the following steps: detecting a request corresponding to transferring content between the first computer system and a second computer system; and in response to detecting the request corresponding to transferring content between the first computer system and the second computer system, moving, via the movement component, a portion of the first computer system toward the second computer system.

In some embodiments, a computer program product is described. In some embodiments, the computer program product comprises one or more programs configured to be executed by one or more processors of a first computer system that is in communication with a movement component. In some embodiments, the one or more programs include instructions for: detecting a request corresponding to transferring content between the first computer system and a second computer system; and in response to detecting the request corresponding to transferring content between the first computer system and the second computer system, moving, via the movement component, a portion of the first computer system toward the second computer system.

In some embodiments, a method that is performed at a first computer system that is in communication with one or more output devices is described. In some embodiments, the method comprises: while operating in a first mode, receiving data corresponding to content from a second computer system different from the first computer system; and in response to receiving the data corresponding to the content from the second computer system: transitioning from operating in the first mode to operating in a second mode different from the first mode; in accordance with a determination that a first skill corresponds to the content, outputting, via the one or more output devices, a first set of one or more instructions corresponding to the first skill; and in accordance with a determination that a second skill, different from the first skill, corresponds to the content, outputting, via the one or more output devices, a second set of one or more instructions corresponding to the second skill, wherein the second set of one or more instructions is different from the first set of one or more instructions.

In some embodiments, a non-transitory computer-readable storage medium storing one or more programs configured to be executed by one or more processors of a first computer system that is in communication with one or more output devices is described. In some embodiments, the one or more programs includes instructions for: while operating in a first mode, receiving data corresponding to content from a second computer system different from the first computer system; and in response to receiving the data corresponding to the content from the second computer system: transitioning from operating in the first mode to operating in a second mode different from the first mode; in accordance with a determination that a first skill corresponds to the content, outputting, via the one or more output devices, a first set of one or more instructions corresponding to the first skill; and in accordance with a determination that a second skill, different from the first skill, corresponds to the content, outputting, via the one or more output devices, a second set of one or more instructions corresponding to the second skill, wherein the second set of one or more instructions is different from the first set of one or more instructions.

In some embodiments, a transitory computer-readable storage medium storing one or more programs configured to be executed by one or more processors of a first computer system that is in communication with one or more output devices is described. In some embodiments, the one or more programs includes instructions for: while operating in a first mode, receiving data corresponding to content from a second computer system different from the first computer system; and in response to receiving the data corresponding to the content from the second computer system: transitioning from operating in the first mode to operating in a second mode different from the first mode; in accordance with a determination that a first skill corresponds to the content, outputting, via the one or more output devices, a first set of one or more instructions corresponding to the first skill; and in accordance with a determination that a second skill, different from the first skill, corresponds to the content, outputting, via the one or more output devices, a second set of one or more instructions corresponding to the second skill, wherein the second set of one or more instructions is different from the first set of one or more instructions.

In some embodiments, a first computer system that is in communication with one or more output devices is described. In some embodiments, the first computer system comprises one or more processors and memory storing one or more programs configured to be executed by the one or more processors. In some embodiments, the one or more programs includes instructions for: while operating in a first mode, receiving data corresponding to content from a second computer system different from the first computer system; and in response to receiving the data corresponding to the content from the second computer system: transitioning from operating in the first mode to operating in a second mode different from the first mode; in accordance with a determination that a first skill corresponds to the content, outputting, via the one or more output devices, a first set of one or more instructions corresponding to the first skill; and in accordance with a determination that a second skill, different from the first skill, corresponds to the content, outputting, via the one or more output devices, a second set of one or more instructions corresponding to the second skill, wherein the second set of one or more instructions is different from the first set of one or more instructions.

In some embodiments, a first computer system that is in communication with one or more output devices is described. In some embodiments, the first computer system comprises means for performing each of the following steps: while operating in a first mode, receiving data corresponding to content from a second computer system different from the first computer system; and in response to receiving the data corresponding to the content from the second computer system: transitioning from operating in the first mode to operating in a second mode different from the first mode; in accordance with a determination that a first skill corresponds to the content, outputting, via the one or more output devices, a first set of one or more instructions corresponding to the first skill; and in accordance with a determination that a second skill, different from the first skill, corresponds to the content, outputting, via the one or more output devices, a second set of one or more instructions corresponding to the second skill, wherein the second set of one or more instructions is different from the first set of one or more instructions.

In some embodiments, a computer program product is described. In some embodiments, the computer program product comprises one or more programs configured to be executed by one or more processors of a first computer system that is in communication with one or more output devices. In some embodiments, the one or more programs include instructions for: while operating in a first mode, receiving data corresponding to content from a second computer system different from the first computer system; and in response to receiving the data corresponding to the content from the second computer system: transitioning from operating in the first mode to operating in a second mode different from the first mode; in accordance with a determination that a first skill corresponds to the content, outputting, via the one or more output devices, a first set of one or more instructions corresponding to the first skill; and in accordance with a determination that a second skill, different from the first skill, corresponds to the content, outputting, via the one or more output devices, a second set of one or more instructions corresponding to the second skill, wherein the second set of one or more instructions is different from the first set of one or more instructions.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a computer system in accordance with some embodiments.

FIGS. 2A-2C are diagrams illustrating exemplary components and user interfaces of device 200 in accordance with some embodiments.

FIG. 3 is a block diagram illustrating exemplary components of a device in accordance with some embodiments.

FIG. 4 is a functional diagram of an exemplary actuator device in accordance with some embodiments.

FIG. 5 is a functional diagram of an exemplary agent system in accordance with some embodiments.

FIGS. 6A-6D illustrate exemplary user interfaces for moving to a location corresponding to a user in accordance with some embodiments.

FIG. 7 is a flow diagram illustrating methods for moving to a location corresponding to a user in accordance with some embodiments.

FIGS. 8A-8H illustrate exemplary user interfaces for outputting a response to an input in accordance with some embodiments.

FIG. 9 is a flow diagram illustrating methods for outputting an indication of an object in accordance with some embodiments.

FIG. 10 is a flow diagram illustrating methods for outputting a response after moving a portion of the computer system in accordance with some embodiments.

FIG. 11 is a flow diagram illustrating methods for displaying an indication of a step in accordance with some embodiments.

FIG. 12 is a flow diagram illustrating methods for outputting an indication of an error in accordance with some embodiments.

FIGS. 13A-13E illustrate exemplary user interfaces for moving a computer system toward another computer system for transferring content in accordance with some embodiments.

FIG. 14 is a flow diagram illustrating methods for moving a computer system toward another computer system for transferring content in accordance with some embodiments.

FIG. 15 is a flow diagram illustrating methods for outputting generated instructions to perform a skill related to content in accordance with some embodiments.

### DETAILED DESCRIPTION

The description to follow sets forth exemplary methods, components, parameters, and the like. While specific examples are set out below, it should be recognized that such examples should not be understood as limiting the scope of the present disclosure to the explicit descriptions of the examples set forth herein but instead should be understood as providing illustrative examples.

Each of the identified modules and applications herein corresponds to a set of executable instructions for performing one or more functions described above and the methods described in this application (e.g., the computer-implemented methods and other information processing methods described herein). These modules (e.g., sets of instructions) optionally need not be implemented as separate software programs (such as computer programs (e.g., including instructions)), procedures, or modules, and thus various subsets of these modules are, optionally, combined or otherwise rearranged in various embodiments. For example, a video player module is, optionally, combined with a music player module into a single module. In some embodiments, memory optionally stores a subset of the modules and data structures identified above. Furthermore, memory optionally stores additional modules and data structures not described above.

One or more steps of the methods described herein can rely on (be contingent on) one or more conditions being satisfied. In some embodiments, a method is performed by iterating a process multiple times. In some embodiments, contingent steps can be satisfied on different iterations of the same process and still be within the scope of the methods described herein. For example, for a given method that includes two steps that are contingent on different conditions, one of ordinary skill in the art would understand that the given method is considered performed even when a process is repeated multiple times until the contingent steps are satisfied. In some embodiments, multiple iterations of a process are not required to in order to practice claims as presented herein. For example, electronic device, system, or computer readable medium claims can be performed without iteratively repeating a process. In some embodiments, the electronic device, system, or computer readable medium claims include instructions for performing one or more steps that are contingent upon one or more conditions being satisfied. Because such instructions are stored in one or more processors and/or at one or more memory locations, the electronic device, system, or computer readable medium claims can include logic that determines whether the one or more conditions have been satisfied without needing to repeat steps of a process.

Although elements are described below using numerical descriptors, such as “a first” and/or “a second,” these elements do not correspond to order or distinct representations and should not be limited to the stated numerical term. In some embodiments, these terms simply used as prefix to distinguish a reference to one element from a reference to another element. For example, a “first” device and a “second” device can be two separate references to the same device. In contrast, for example, a “first” device and a “second” device can be a reference to two different devices (e.g., not the same device and/or not the same type of device). For example, a first computer system and a second computer system do not correspond to a first and a second in time, and merely are used to distinguish between two computer systems. As such, the first computer system can be termed a second computer system, and the second computer system can be termed a first computer system without departing from the scope of the various described embodiments.

For description of various elements and examples, the use of certain terminology is used to provide productive descriptions of the subject matter below and should not be read as limiting. As used to describe various examples herein, the singular forms of “a,” “an,” and “the” should not be interpreted as precluding or excluding the plural forms as well, unless the context clearly indicates otherwise. As well, “and/or” is used to encompasses any and all possible combinations of one or more associated listed items. For example, “x and/or y” should be interpreted as including “x,” or “y,” as well as “x and y” as possible permutations. Further, the use of the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

When describing choices and/or logical possibilities, the term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

The processes described below enhance the operability of the devices and make the user-device and/or user-device interfaces more efficient (e.g., by helping the user to provide proper inputs and reducing user mistakes when operating/interacting with the device) through various techniques, including by providing improved feedback (e.g., visual, haptic, audible, and/or tactile feedback) to the user, reducing the number of inputs needed to perform an operation, providing additional control options without cluttering the user interface with additional displayed controls, performing an operation when a set of conditions has been met without requiring further input (e.g., input by a user), and/or additional techniques, such as increasing the security and/or privacy of the computer system and reducing burn-in of one or more portions of a user interface of a display. These techniques also reduce power usage and improve battery life of the device by enabling the user to use the device more quickly and efficiently.

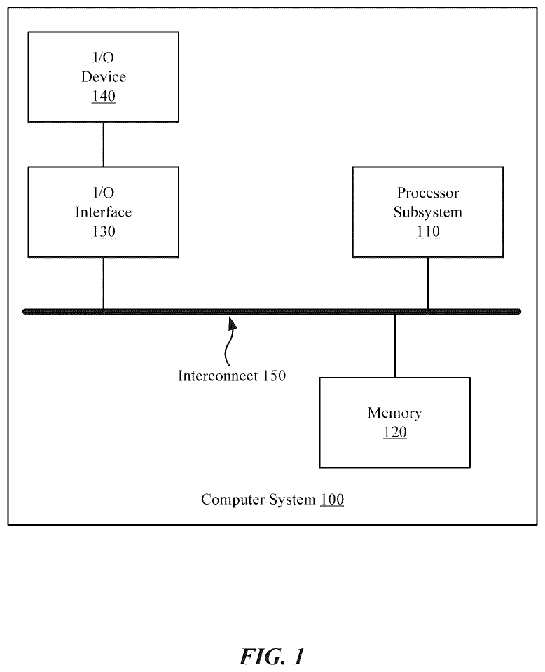

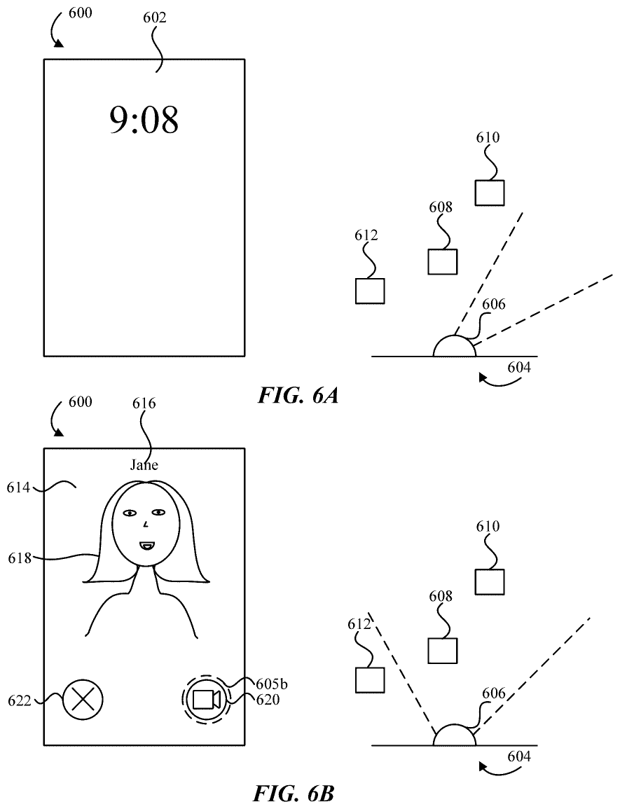

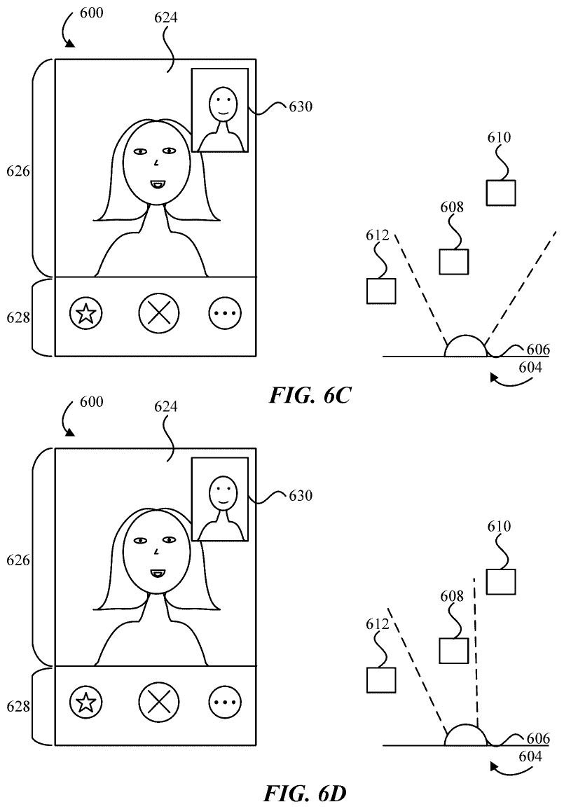

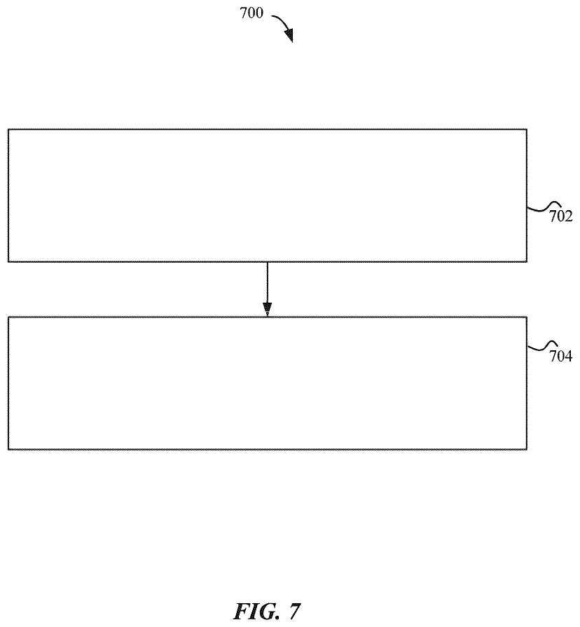

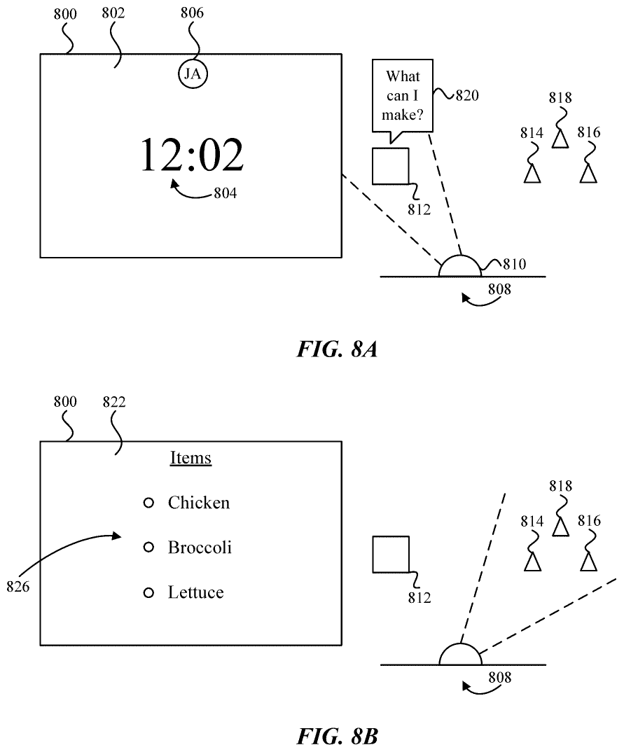

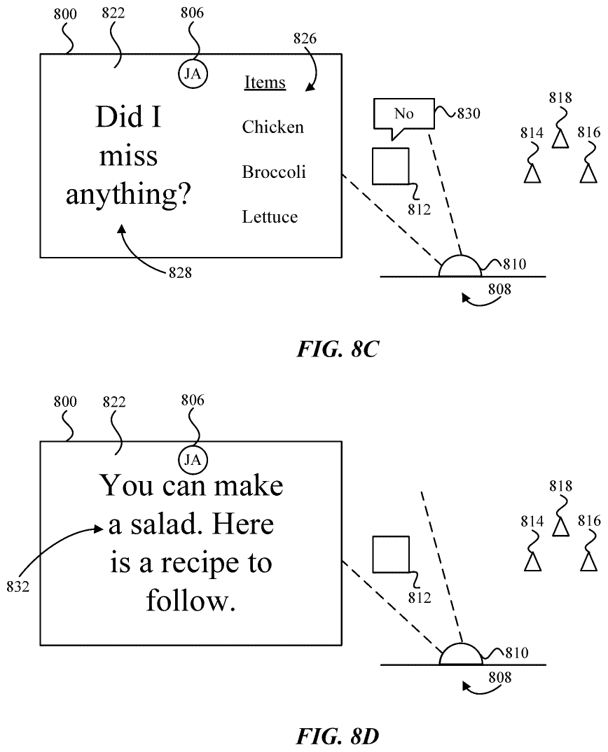

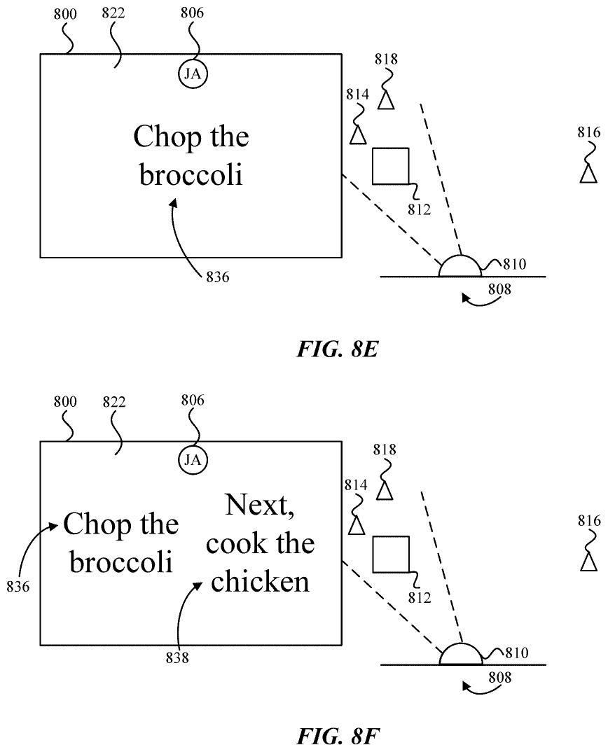

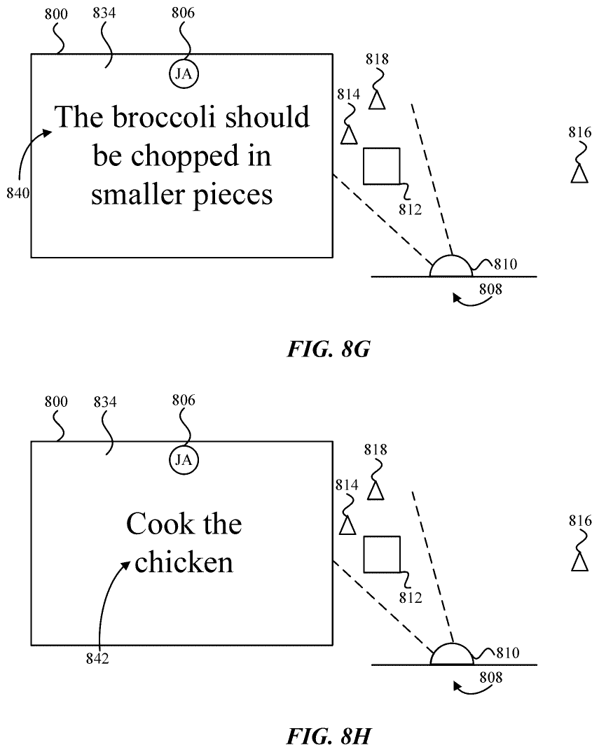

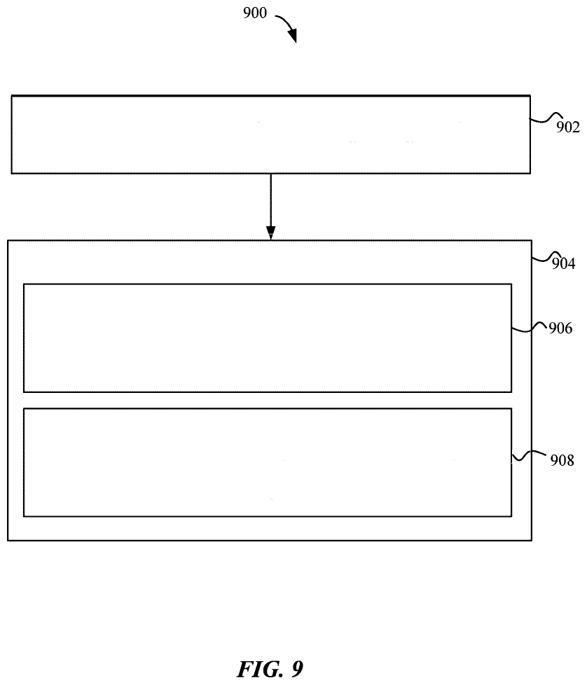

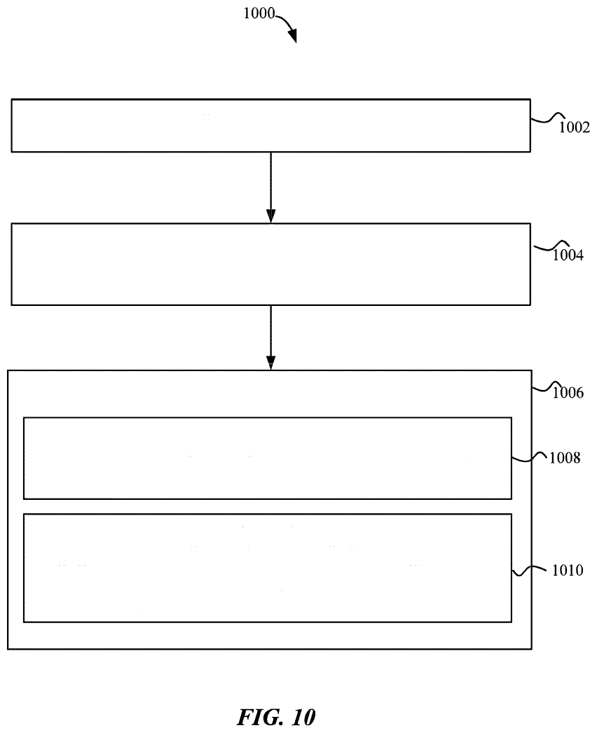

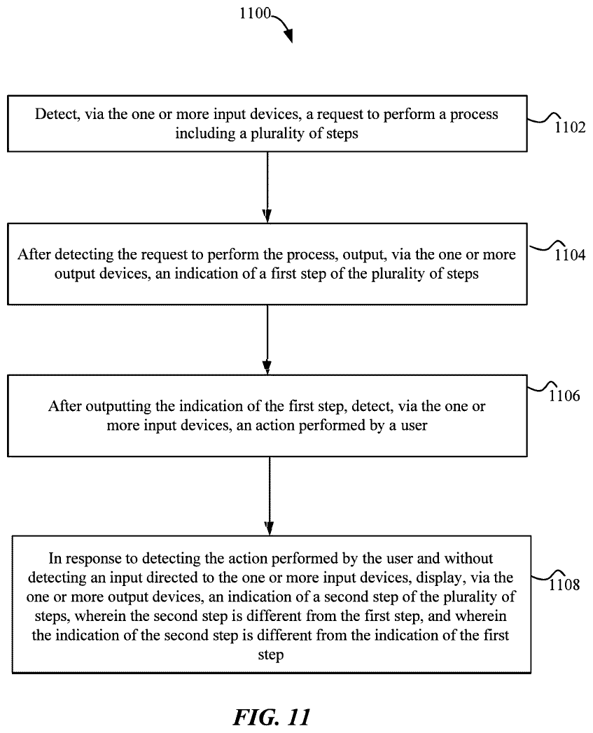

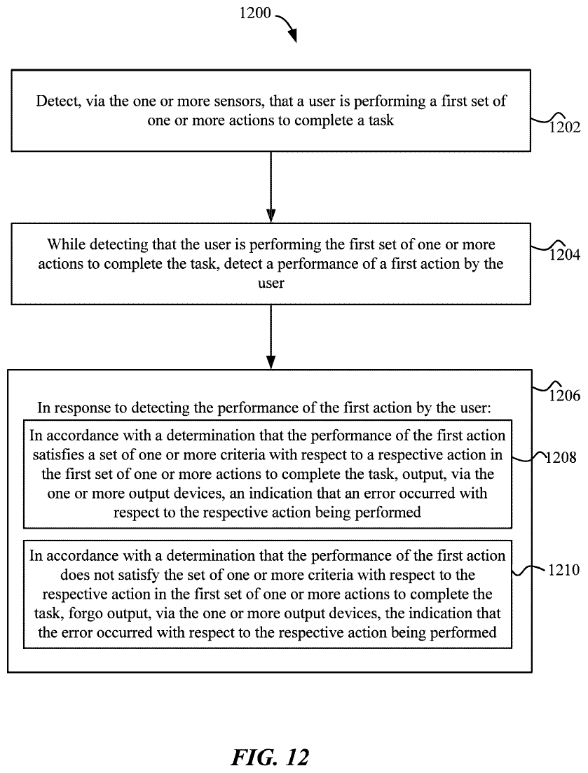

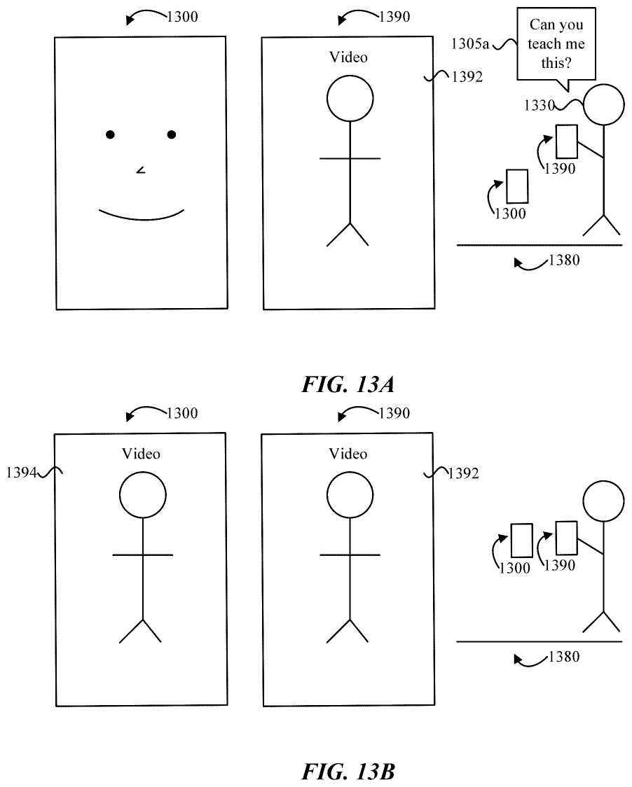

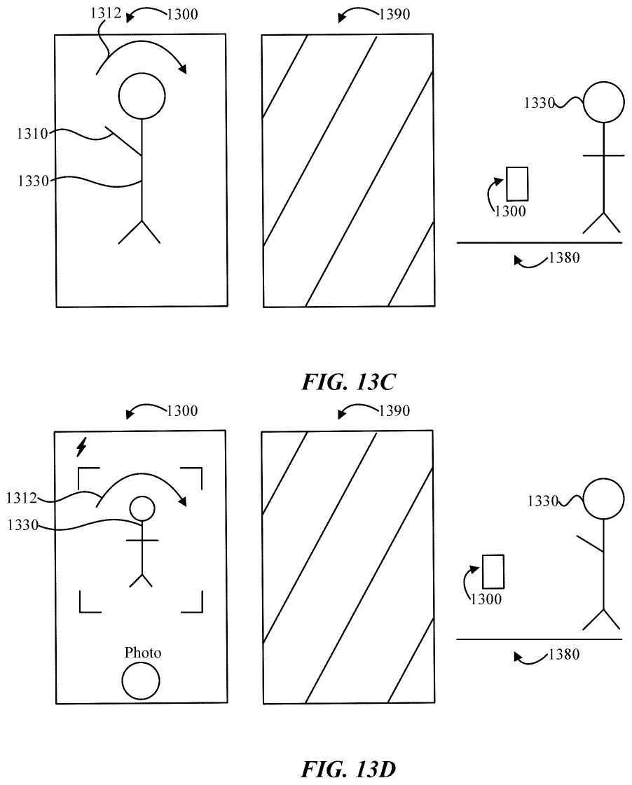

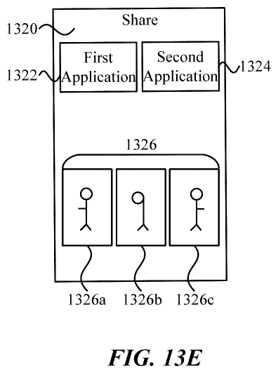

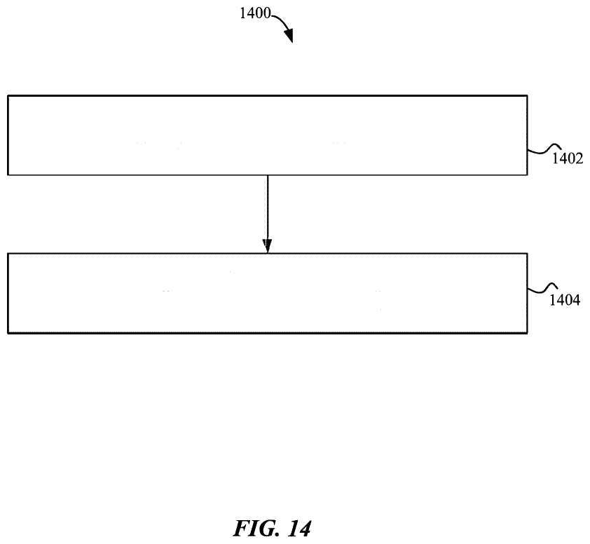

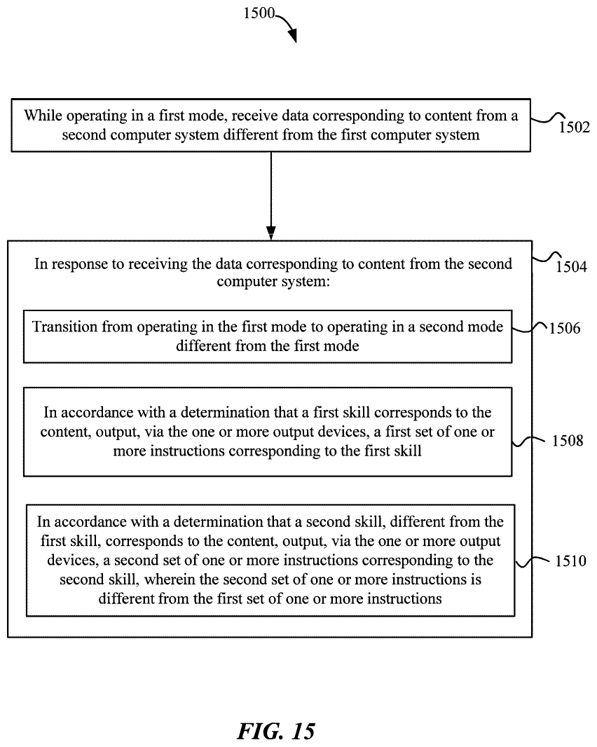

Below, FIGS. 1, 2A-2C, and 3-5 provide a description of exemplary devices for performing the techniques described herein. FIGS. 6A-6D illustrate exemplary user interfaces for moving to a location corresponding to a user in accordance with some embodiments. FIG. 7 is a flow diagram illustrating methods for moving to a location corresponding to a user in accordance with some embodiments. The user interfaces in FIGS. 6A-6D are used to illustrate the processes described below, including the processes in FIG. 7. FIGS. 8A-8H illustrate exemplary user interfaces for outputting a response to an input in accordance with some embodiments. FIG. 9 is a flow diagram illustrating methods for outputting an indication of an object in accordance with some embodiments. FIG. 10 is a flow diagram illustrating methods for outputting a response after moving a portion of the computer system in accordance with some embodiments. FIG. 11 is a flow diagram illustrating methods for displaying an indication of a step in accordance with some embodiments. FIG. 12 is a flow diagram illustrating methods for outputting an indication of an error in accordance with some embodiments. The user interfaces in FIGS. 8A-8H are used to illustrate the processes described below, including the processes in FIGS. 9, 10, 11, and 12. FIGS. 13A-13E illustrate exemplary user interfaces for moving a computer system toward another computer system for transferring content in accordance with some embodiments. FIG. 14 is a flow diagram illustrating methods for moving a computer system toward another computer system for transferring content in accordance with some embodiments. FIG. 15 is a flow diagram illustrating methods for outputting generated instructions to perform a skill related to content in accordance with some embodiments. The user interfaces in FIGS. 13A-13E are used to illustrate the processes described below, including the processes in FIGS. 14 and 15.

FIG. 1 depicts a block diagram of computer system 100 (e.g., electronic device and/or electronic system) including a set of electronic components in communication with (e.g., connected to) (e.g., wired or wirelessly) to each other. It should be understood that computer system 100 is merely one example of a computer system that can be used to perform functionality described below and that one or more other computer systems can be used to perform the functionality described below. Additionally, while FIG. 1 depicts a computer architecture of computer system 100, other computer architectures (e.g., including more components, similar components, and/or fewer components) of a computer system can be used to perform functionality described herein.

In some embodiments, computer system 100 can correspond to (e.g., be and/or include) a system on a chip, a server system, a personal computer system, a smart phone, a smart watch, a wearable device, a tablet, a laptop computer, a fitness tracking device, a head-mounted display (HMD) device, a desktop computer, a communal device (e.g., smart speaker, connected thermostat, and/or additional home based computer systems), an accessory (e.g., switch, light, speaker, air conditioner, heater, window cover, fan, lock, media playback device, television, and so forth), a controller, a hub, and/or a sensor.

In some embodiments, a sensor includes one or more hardware components capable of detecting (e.g., sensing, generating, and/or processing) information about a physical environment in proximity to the sensor. For example, a sensor can be configured to detect information surrounding the sensor, detect information in one or more directions casting away from the sensor, and/or detect information based on contact of the sensor with an element of the physical environment. In some embodiments, a hardware component of a sensor includes a sensing component (e.g., a temperature and/or image sensor), a transmitting component (e.g., a radio and/or laser transmitter), and/or a receiving component (e.g., a laser and/or radio receiver). In some embodiments, a sensor includes an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a microphone, a motion sensor, a range or depth sensor (e.g., RADAR, LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. While only a single computer system is depicted in FIG. 1, functionality described below can be implemented with two or more computer systems operating together. Additionally, in some embodiments, computer system 100 includes one or more sensors as described above, and information about the physical environment is captured by combining data from one sensor with data from one or more additional sensors (e.g., that are part of the computer and/or one or more additional computer systems).

As illustrated in FIG. 1, computer system 100 consists of processor subsystem 110, memory 120, and I/O interface 130. Memory 120 corresponds to system memory in communication with processor subsystem 110. The electronic components making up computer system 100 are electrically connected through interconnect 150, which allows communication between the components of computer system 100. For example, interconnect 150 can be a system bus, one or more memory locations, and/or additional electrical channels for connective multiple components of computer system 100. Also, I/O interface 130 is connected to, via a wired and/or wireless connection, I/O device 140. In some embodiments, computer system 100 includes a component made up of I/O interface 130 and I/O device 140 such that the functionality of the individual components is included in the component. Additionally, it should be understood that computer system 100 can include one or more I/O interfaces, communicating with one or more I/O devices. In some embodiments, computer system 100 consists of multiple processor subsystem 100s, each electrically connected through interconnect 150.

In some embodiments, processor subsystem 110 includes one or more processors or individual processing units capable of executing instructions (e.g., program, system, and/or interrupt) to perform functionality described herein. For example, operating system level and/or application-level instructions executed by processor subsystem 110. In some embodiments, processor subsystem 110 includes one or more components (e.g., implemented as hardware, software, and/or a combination thereof) capable of supporting, interpreting, and/or performing machine learning instructions and/or operations. For example, computer system 100 can perform operations according to a machine learning model locally. Alternatively, or in addition, computer system 100 can communicate with (e.g., performing calculations on and/or executing instructions corresponding to) a remote interactive knowledge base (e.g., a processing resource that implements a machine learning model, artificial intelligence model, and/or large language model) to perform operations that can be otherwise outside a set of capabilities of computer system 100. For example, computer system 100 can determine a set of inputs (e.g., instructions, data, and/or parameters) to the interactive knowledge base for performing desired machine learning operations.

Memory 120 in communication with processor subsystem 110 can be implemented by a variety of different physical, non-transitory memory media. In some embodiments, computer system 100 includes multiple memory components and/or multiple types of memory components, each connected to processor subsystem 110 directly and/or via interconnect 150. For example, memory 120 can be implemented using a removable flash drive, storage array, a storage area network (e.g., SAN), flash memory, hard disk storage, optical drive storage, floppy disk storage, removable disk storage, random access memory (e.g., SDRAM, DDR SDRAM, RAM-SRAM, EDO RAM, and/or RAMBUS RAM), and/or read only memory (e.g., PROM and/or EEPROM). Additionally, in some embodiments, processor subsystem 110 and/or interconnect 150 is connected to a memory controller that is electrically connected to memory 120.

In some embodiments, instructions can be executed by processor subsystem 110. In this example, memory 120 can include a computer readable medium (e.g., non-transitory or transitory computer readable medium) usable to store (e.g., configured to store, assigned to store, and/or that stores) instructions to be executable by processor subsystem 110. In some embodiments each instruction stored by memory 120 and executed by processor subsystem 110 corresponds to an operation for completing the functionality described herein. For example, memory 120 can store program instructions to implement the functionality associated with the methods described below including processes 700, 900, 1000, 1100, 1200, 1400, and/or 1500 (FIGS. 7, 9, 10, 11, 12, 14, and/or 15).

As mentioned above, I/O interface 130 can be one or more types of interfaces enabling computer system 100 to communicate with other devices. In some embodiments, I/O interface 130 includes a bridge chip (e.g., Southbridge) from a front-side bus to one or more back-side buses. In some embodiments, I/O interface 130 enables communication with one or more I/O devices, illustrated as I/O device 140, via one or more corresponding buses or other interfaces. For example, an I/O device can include one or more: a physical user-interface devices (e.g., a physical keyboard, a mouse, and/or a joystick), storage devices (e.g., as described above with respect to memory 120), network interface devices (e.g., to a local or wide-area network), sensor devices (e.g., as described above with respect to sensors), and/or auditory and/or visual output devices (e.g., screen, speaker, light, and/or projector). In some embodiments, the visual output device is referred to as a display component. For example, the display component can be configured to provide visual output, such as displaying images on a physically viewable medium via an LED display or image projection. As used herein, “displaying” content includes causing to display the content (e.g., video data rendered and/or decoded by a display controller) by transmitting, via a wired or wireless connection, data (e.g., image data and/or video data) to an integrated or external display component to visually produce the content.

In some embodiments, computer system 100 includes a component that integrates I/O device 140 with other components (e.g., a component that includes I/O interface 130 and I/O device 140). In some embodiments, I/O device 140 is separate from other components of computer system 100 (e.g., is a discrete component). In some embodiments, I/O device 140 includes a network interface device that permits computer system 100 to connect to (e.g., communicate with) a network or other computer systems, in a wired or wireless manner. In some embodiments, a network interface device can include Wi-Fi, Bluetooth, NFC, USB, Thunderbolt, Ethernet, and so forth. For example, computer system 100 can utilize an NFC connection to facilitate a bank, credit, financial, token (e.g., fungible or non-fungible token), and/or cryptocurrency transaction between computer system 100 and another computer system within proximity.

In some embodiments, I/O device 140 includes components for detecting a user (e.g., a user, a person, an animal, another computer system different from the computer system, and/or an object) and/or an input (e.g., a tap input and/or a non-tap input (e.g., a verbal input, an audible request, an audible command, an audible statement, a swipe input, a hold-and-drag input, a gaze input, an air gesture, and/or a mouse click)) from a detected user. In some embodiments, I/O device 140 enables computer system 100 to identify users associated with and/or without an account within an environment. For example, computer system 100 can detect a known user (e.g., a user that corresponds to an account) and access information about the user using the known user's account. In some embodiments, as part of computer system 100 detecting a user, computer system 100 detects that the user's account is associated with (e.g., is included in and/or identified with respect to) a group of users. For example, computer system 100 can access information associated with a family of accounts in response to detecting a member of the family that is defined as a group of accounts. In some embodiments, as account corresponding to a user can be connected with additional accounts and/or additional computer systems. For example, computer system 100 can detect such additional computer systems and/or detect such computer systems for detecting the user. In some embodiments, computer system 100 detects unknown users and enables guest accounts for the unknown users to utilize computer system 100.

In some embodiments, I/O device 140 includes one or more cameras. In some embodiments, a camera includes an image sensor (e.g., one or more optical sensors and/or one or more depth camera sensors) that provides computer system 100 with the ability to detect a user and/or a user's gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). In some embodiments, the one or more cameras enable computer system 100 to transmit pictorial and/or video information to an application. For example, image data captured by a camera can enable computer system 100 to complete a video phone call by transmitting video data to an application for performing the video phone call.

In some embodiments, I/O device 140 includes one or more microphones. For example, a microphone can be used by 100 to obtain data and/or information from a user without a contact input. In some embodiments, a microphone enables computer system 100 to detect verbal and/or speech input from a user. In some embodiments, computer system 100 utilizes speech input to enable personal assistant functionality. For example, a user eliciting a request to computer system 100 to perform an action and/or obtain information for the user. In some embodiments, computer system 100 utilizes speech input (e.g., along with one or more other input and/or output techniques) to request and/or detect information from a user without requiring the user to make physical contact with computer system 100.

In some embodiments, I/O device 140 includes physical input mediums for a user to interact directly with computer system 100. In some embodiments, a physical input medium includes one or more physical buttons (e.g., tactile depressible button and/or touch sensitive non-depressible component) on computer system 100 and/or connected to computer system 100, a mouse and keyboard input method (e.g., connected to computer system 100 together and/or separately with one or more I/O interfaces), and/or a touch sensitive display component.

In some embodiments, I/O device 140 includes one or more components for outputting information (e.g., a display component, an audio generation component, a speaker, a haptic output device, a display screen, a projector, and/or a touch-sensitive display). In some embodiments, computer system 100 uses I/O device 140 to convey information and/or a state of computer system 100. In some embodiments, I/O device 140 includes a tactile output component. For example, a tactile output component can be a haptic generation component that enables computer system 100 to convey information to a user in contact with (e.g., holding, touching, and/or nearby) computer system 100. In some embodiments, I/O device 140 includes one or more components for outputting visual outputs (e.g., video, image, animation, 3D rendering, augmented reality overlay, motion graphics, data visualization, digital art, etc.). For example, displaying content from one or more applications and/or system applications, and/or displaying a widget (e.g., a control that displays real-time information and/or data) corresponding to one or more applications.

In some embodiments, I/O device 140 includes one or more components for outputting audio (e.g., smart speakers, home theater system, soundbars, headphones, earphones, earbuds, speakers, television speakers, augmented reality headset speakers, audio jacks, optical audio output, Bluetooth audio outputs, HDMI audio outputs, audio sensors, etc.). In some embodiments, computer system 100 is able to output audio through the one or more speakers. For example, computer system 100 outputting audio-based content and/or information to a user. In some embodiments, the one or more speakers enable spatial audio (e.g., an audio output corresponding to an environment (e.g., computer system 100 detecting materials and/or objects within the environment and/or computer system 100 altering the audio pattern, intensity, and/or waveform to compensate for varying characteristics of an environment)).

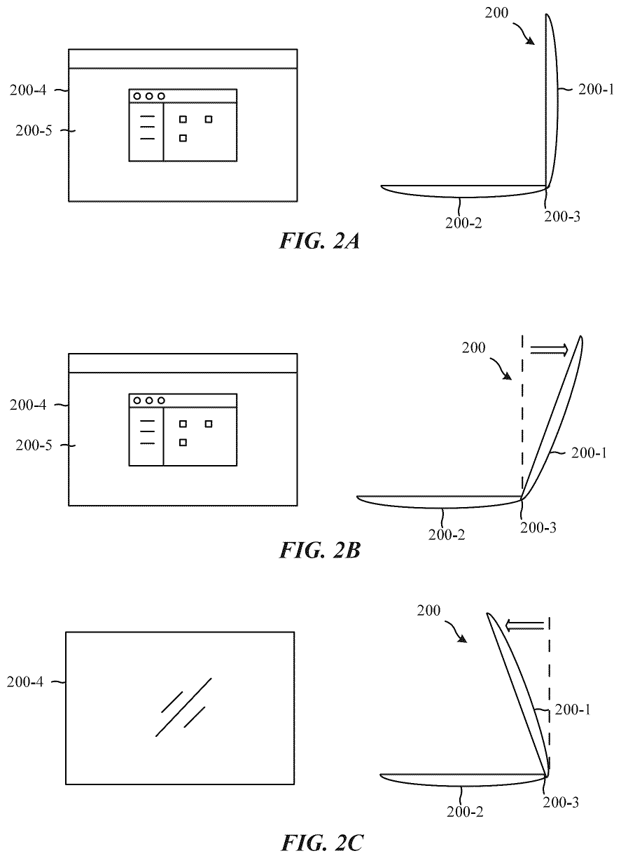

FIGS. 2-5 illustrate exemplary components and user interfaces of device 200 in accordance with some embodiments. Device 200 (sometimes referred to herein as device 200) can include one or more features of computer system 100. In the examples described with respect to FIGS. 2-5, device 200 is a laptop computer. In some embodiments, device 200 is not limited to being a laptop computer and one of ordinary skill in the art should recognize that device 200 can be one or more other devices (e.g., as described herein and/or that include one or more of the components and/or functions described herein with respect to device 200). For example, device 200 can be a communal device (such as a smart display, a smart speaker, and/or a television) and/or a personal device (such as a smart phone, a smart watch, a tablet, a desktop computer, a fitness tracking device, and/or a head mounted display device). In some embodiments, a communal device is configured to provide functionality to multiple users (e.g., at the same time and/or at different times). In such embodiments, the communal device can be administered and/or set up by a single user. In some embodiments, a personal device is configured to provide functionality to a single user (e.g., at a time, such as when the single user is logged into the personal device).

FIGS. 2A-2C illustrate device 200 in three different physical positions. As illustrated in FIG. 2A, device 200 is a laptop computer (also referred to herein as a “laptop”) that includes base portion 200-2 (e.g., that rests on a surface, such as a desk, horizontally as shown in FIG. 2A) and display portion 200-1 that is connected to base portion 200-2 at connection 200-3 (e.g., one or more connection points, a motorized arm, a hinge, and/or a joint) that enables display portion 200-1 to pivot and/or change orientation with respect to base portion 200-2. For example, device 200 can pivot at connection 200-3 to rotate display portion 200-1 and/or device 200 to one or more positions corresponding to an “OFF” internal state (e.g., as further described below in relation to FIG. 2C). In some embodiments, a position corresponding to an “OFF” internal state is a position in which device 200 is in a predetermined pose. For example, a predetermined pose can include display portion 200-1 positioned parallel to base portion 200-2 or display portion 200-1 forming a predetermined angle (e.g., 60-degree angle) with respect to base portion 200-2. In some embodiments, in the “OFF” internal state, an area in which content is displayed by device 200 is positioned in a manner that corresponds to (e.g., represents, is associated with, and/or is configured to accompany) the “OFF” internal state (e.g., facing down, not visible, and/or obscuring the area in which content is displayed). In some embodiments, in the “OFF” internal state, an area in which content is displayed by device 200 is not positioned in a manner that corresponds to (e.g., represents, is associated with, and/or is configured to accompany) the “OFF” internal state (e.g., instead is positioned in a manner that corresponds to an “ON” internal state). For example, when not in the “OFF” internal state, device 200 can be positioned within a range of different open positions (e.g., in which display portion 200-1 is not parallel to base portion 200-2 and the area in which content is displayed by device 200 is visible and/or not obscured). It should be recognized that display portion 200-1 being parallel to base portion 200-2 is an example of a position corresponding to an “OFF” internal state (e.g., a closed position) of device 200. In some embodiments, another configuration could set another orientation of display portion 200-1 with respect to base portion 200-2 as the closed position of device 200, such as illustrated in FIG. 2C.

FIG. 2A illustrates display screen 200-4 (representing the area in which content is displayed by device 200) on the left and device 200 in a corresponding pose on the right. As illustrated in FIG. 2A, device 200 is in a first position (e.g., display portion 200-1 is perpendicular to base portion 200-2 forming a 90-degree angle). In FIG. 2A, display screen 200-4 represents what is currently being displayed (e.g., via a display component) by device 200 while open in the first position. In FIG. 2A, display screen 200-4 illustrates an internal state in which device 200 is “ON” (e.g., operational, powered on, awake, a higher powered and/or more resource intensive state than the “OFF” state, and/or activated). In some embodiments, device 200 displays (e.g., via display screen 200-4) one or more user interfaces (e.g., user interface objects, windows, application user interfaces, system user interfaces, controls, and/or other visual content). In some embodiments, device 200 displays (e.g., via display screen 200-4) the one or more user interfaces while in the “ON” internal state. For example, in FIG. 2A, device 200 is in the “ON” internal state and display screen 200-4 displays a desktop user interface 200-5 that includes an application window. In some embodiments, a user interface includes (and/or is) one or more user interface objects (e.g., windows, icons, and/or other graphical objects). For example, a user interface (e.g., 200-5) can include one or more graphical objects different than, and/or the same as, an application window.

FIG. 2B illustrates display screen 200-4 on the left and device 200 in a corresponding pose on the right. As illustrated in FIG. 2B, device 200 is in a second position (e.g., display portion 200-1 is angled (e.g., via connection 200-3) with respect to base portion 200-2 forming at a 120-degree angle (e.g., a larger angle than in FIG. 2A)). In FIG. 2B, display screen 200-4 represents what is being displayed by device 200 while in the second position. Display screen 200-4 illustrates an internal state in which device 200 is “ON” (e.g., the same internal state as the top diagram of FIG. 2A). In FIG. 2B, device 200 displays (e.g., via display screen 200-4) desktop user interface 200-5 (e.g., and is the same as displayed in FIG. 2A). In some embodiments, device 200 displays a different user interface (e.g., other than desktop user interface 200-5). For example, although FIG. 2B illustrates device 200 displaying the same desktop user interface 200-5 as in FIG. 2A while in a different position than in FIG. 2A, device 200 can display a different user interface. In some embodiments, device 200 displays a user interface that corresponds to (e.g., is based on, due to, caused by, related to, and/or configured to accompany) a physical state (e.g., position, location, and/or orientation), including content that is specific to a particular angle or specific to a current context.

FIG. 2C illustrates display screen 200-4 on the left and device 200 in a corresponding pose on the right. As illustrated in FIG. 2C, device 200 is in a third position (e.g., display portion 200-1 is angled (e.g., via connection 200-3) with respect to base portion 200-2 forming at a 60-degree angle (e.g., a smaller angle than in FIG. 2A and FIG. 2B)). In FIG. 2C, display screen 200-4 represents what is being displayed by device 200 while in the third position. In FIG. 2C, display screen 200-4 illustrates an internal state in which device 200 is “OFF” (e.g., not operational, not powered on, not awake, not activated, powered off, asleep, hibernating, inactive, and/or deactivated). In some embodiments, device 200 does not display (e.g., via display screen 200-4) (e.g., forgoes displaying) the one or more user interfaces while in the “OFF” internal state (e.g., does not display any visual content). In some embodiments, device 200 displays (e.g., via display screen 200-4) one or more user interfaces while in the “OFF” internal state (e.g., the same and/or different from one or more user interfaces displayed while in the “ON” internal state) (e.g., a user interface specific to the “OFF” state and/or a manner of displaying a user interface that is not specific to the “OFF” internal state). In FIG. 2C, display screen 200-4 is blank because nothing is being displayed on the display of device 200 (e.g., display screen 200-4 is off and/or not displaying a user interface) (e.g., desktop user interface 200-5 is not displayed on display screen 200-4).

In some embodiments, device 200 includes one or more components (also referred to herein as “movement components”) that enable device 200 to perform (e.g., cause and/or control) movement (and/or be moved). For example, performing movement can include moving a portion of device 200 (e.g., less than or all components of the device move), moving all of device 200 (e.g., the entire device (including all of its components) moves, such as by changing location), and/or moving one or more other devices and/or components (e.g., that are in communication with device 200 and/or movement components of device 200). For example, device 200 can automatically move (e.g., pivot), cause, and/or control movement of display portion 200-1 relative to base portion 200-2, such as to any of the positions illustrated in FIGS. 2A-2C. In some embodiments, device 200 performs movement based on an internal state of device 200. Performing movement based on an internal state can enable new (e.g., otherwise unavailable) interactions by device 200. For example, such new interactions of device 200 can be configured using special features, functions, modes, and/or programs that take advantage of the ability of device 200 to perform movement. Examples of such interaction include using movement to communicate (e.g., to a user) an internal state (e.g., on, off, sleeping, and/or hibernating) of the device, to assist with user input (e.g., reduce distance to a user), and/or to augment interaction behavior of the device (e.g., moving in particular ways, during an interaction with a user, that convey information such as importance and/or direction of attention). In some embodiments, the movement performed corresponds to (e.g., is caused by, is in response to, and/or is determined and/or performed based on) one or more of: detected input, detected context (e.g., environmental context and/or user context), and/or an internal state of device 200 (e.g., an internal state and/or a set of multiple internal states). For example, device 200 can perform a movement of the display portion such that device 200 moves from being in the first position illustrated in FIG. 2A to being in the second position illustrated in FIG. 2B. In this example, device 200 can detect that a user has repositioned with respect to device 200 (e.g., the user stood up), and in response, device 200 can perform the movement to the second position so that the display is at an optimized viewing angle based on the repositioned height and/or angle of the user's eyes with respect to the display of device 200. As another example, device 200 can perform a movement such that device 200 moves from being in the first position illustrated in FIG. 2A to being in the third position illustrated in FIG. 2C. In this example, device 200 can perform the movement to the third position in response to detecting an internal state with reduced activity (e.g., the “OFF” internal state as described above). In this way, the movement of device 200 to one or more positions can indicate an internal state of device 200.

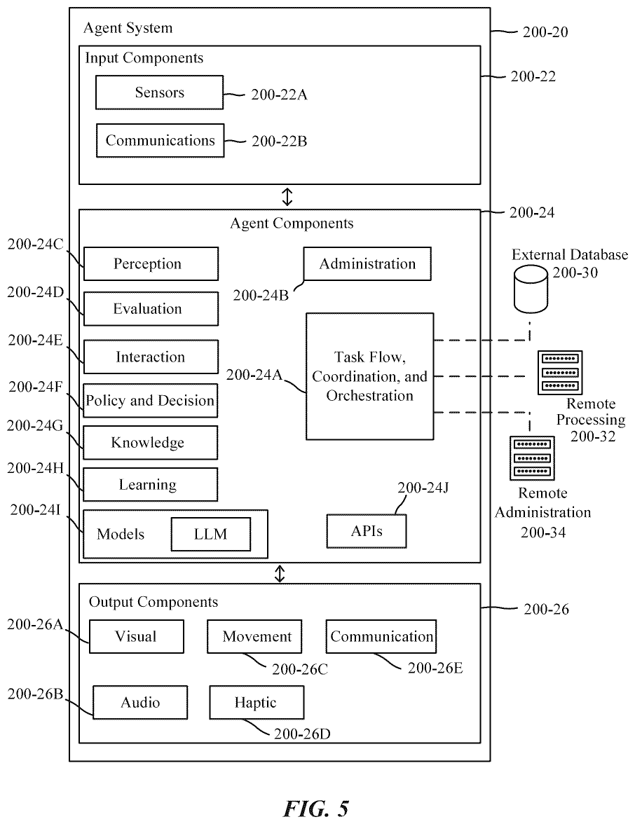

FIGS. 2A-2C illustrate device 200 having a display portion that is able to move with one degree of freedom via connection 200-3 (e.g., a hinge) connecting display portion 200-1 to base portion 200-2. In some embodiments, device 200 includes one or more components that have one or more degrees of freedom. For example, a movement component (e.g., an output component that causes and/or allows movement) (e.g., 200-26C of FIG. 5) of device 200 can include multiple degrees of freedom (e.g., six degrees of freedom including three components of translation and three components of rotation). For example, device 200 can be implemented to be able to move the display portion in a telescoping forward or backward motion (e.g., display portion 200-1 moves forward while base portion 200-2 remains stationary in space relative to the base portion (e.g., to reduce and/or extend viewing distance for a user)). As yet another example, device 200 can be implemented to be able to move the display portion to rotate about an axis that is perpendicular to the hinge such that the display portion can turn to position the display to follow a user as they walk around device 200. While the examples shown in FIGS. 2A-2C illustrate a hinge, other movement components can be included in device 200, such as an actuator (e.g., a pneumatic actuator, hydraulic actuator and/or an electric actuator), a movable base, a rotatable component, and/or a rotatable base. In some embodiments, one or more movement components can cause device 200 to move in different ways, such as to rotate (e.g., 0-360 degrees), to move laterally (e.g., right, left, down, up, and/or any combination thereof), and/or to tilt (e.g., 0-360 degrees).

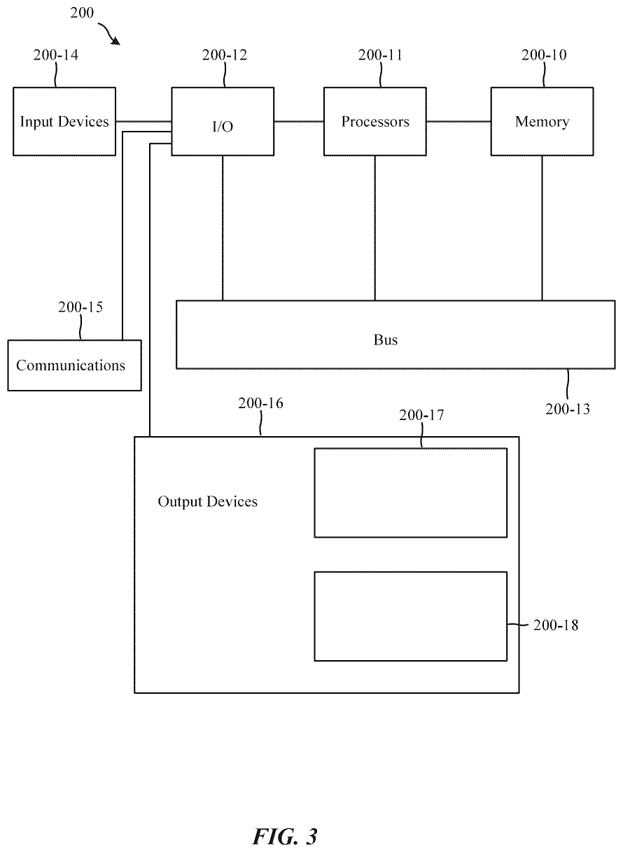

FIG. 3 illustrates exemplary block diagram of device 200. In some embodiments, device 200 includes some or all of the components described with respect to FIGS. 1A, 1B, 3, and 5B. As illustrated in FIG. 3, device 200 has bus 200-13 that operatively couples I/O section 200-12 (also referred to as an I/O subsection and/or an I/O interface) with processors 200-11 and memory 200-10. As illustrated in FIG. 3, I/O section 200-12 is connected to output devices 200-16 (also referred to herein as “output components”). In some embodiments, output devices 200-16 include one or more visual output devices (e.g., a display component, such as a display, a display screen, a projector, and/or a touch-sensitive display), one or more haptic output devices (e.g., a device that causes vibration and/or other tactile output), one or more audio output devices (e.g., a speaker), and/or one or more movement components (e.g., an actuator, a motor, a mechanical linkage, devices that cause and/or allow movement, and/or one or more movement components as described above). As illustrated in FIG. 3, output devices 200-16 include two exemplary movement components (e.g., movement controller 200-17 and actuator 200-18). Actuator 200-18 can be any component that performs physical movement (e.g., of a portion and/or of the entirety) of a device (e.g., device 200 and/or a device coupled to and/or in contact with device 200). Movement controller 200-17 can be any component (e.g., a control device) that controls (e.g., provides control signals to) actuator 200-18. For example, movement controller 200-17 can provide control signals that cause actuator 200-18 to actuate (e.g., cause physical movement). In some embodiments, movement controller 200-17 includes one or more logic component (e.g., a processor), one or more feedback component (e.g., sensor), and/or one or more control components (e.g., for applying control signals, such as a relay, a switch, and/or a control line). In some embodiments, movement controller 200-17 and actuator 200-18 are embodied in the same device and/or component as each other (e.g., a dedicated onboard movement controller 200-17 that is affixed to actuator 200-18). In some embodiments, movement controller 200-17 and actuator 200-18 are embodied in different devices and/or components from each other (e.g., one or more processors 200-11 can function as the movement controller 200-17 of actuator 200-18). In some embodiments, movement controller 200-17 and/or actuator 200-18 are embodied in a device (or one or more devices) other than device 200 (e.g., device 200 is coupled to (e.g., temporarily and/or removably) another device and can instruct movement controller 200-17 and/or control actuator 200-18 of the other device). Actuator 200-18 can function to cause one or more types of mechanical movement (e.g., linear and/or rotational) in one or more manners (e.g., using electric, magnetic, hydraulic, and/or pneumatic power). Examples of actuator 200-18 can include electromechanical actuators, linear actuators, and/or rotary actuators.

As illustrated in FIG. 3, I/O section 200-12 is connected to input devices 200-14. In some embodiments, input devices 200-14 include one or more visual input devices (e.g., a camera and/or a light sensor), one or more physical input devices (e.g., a button, a slider, a switch, a touch-sensitive surface, and/or a rotatable input mechanism), one or more audio input devices (e.g., a microphone), and/or other input devices (e.g., accelerometer, a pressure sensor (e.g., contact intensity sensor), a ranging sensor, a temperature sensor, a GPS sensor, an accelerometer, a directional sensor (e.g., compass), a gyroscope, a motion sensor, and/or a biometric sensor). In addition, I/O section 200-12 can be connected with communication unit 200-15 for receiving application and operating system data, using Wi-Fi, Bluetooth, near field communication (NFC), cellular, and/or other wireless (and/or wired) communication techniques.

Memory 200-10 of device 200 can include one or more non-transitory computer-readable storage mediums, for storing computer-executable instructions, which, when executed by one or more computer processors 200-11, for example, cause the computer processors to perform the techniques described below, including processes 700, 900, 1000, 1100, 1200, 1400, and/or 1500 (FIGS. 7, 9, 10, 11, 12, 14, and/or 15). A computer-readable storage medium can be any medium that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, and Blu-ray technologies, as well as persistent solid-state memory such as flash and solid-state drives. Device 200 is not limited to the components and configuration of FIG. 3 but can include other and/or additional components in a multitude of possible configurations, all of which are intended to be within the scope of this disclosure.

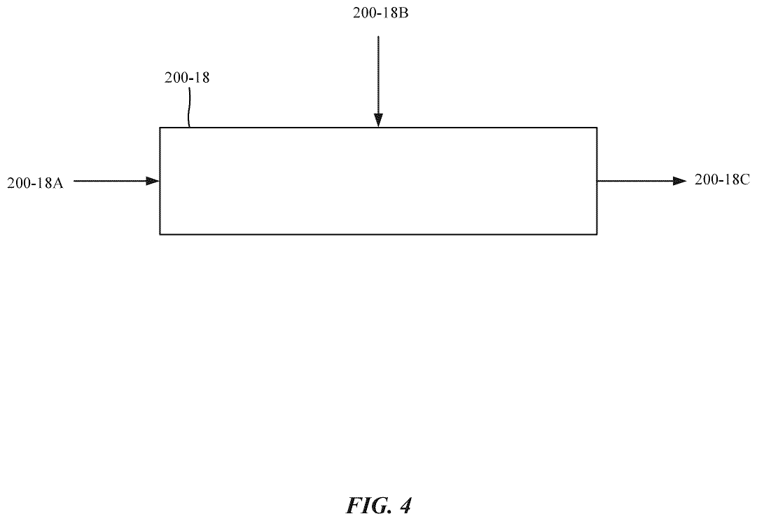

FIG. 4 illustrates a functional diagram of actuator 200-18B in accordance with some embodiments. As described above, actuator 200-18B can be any component that performs physical movement. In some embodiments, actuator 200-18B operates using input that includes control signal 200-18A and/or energy source 200-18B. For example, actuator 200-18 can be a rotary actuator that converts electric energy into rotational movement. This rotational movement can cause the movement of the display portion of device 200 described above with respect to FIGS. 2A-2C (e.g., a counterclockwise rotational movement of the actuator causes device 200 to move to a position having a larger angle (e.g., the second position illustrated in FIG. 2B) and a clockwise (e.g., opposite) rotational movement of the actuator causes device 200 to move to a position having a smaller angle (e.g., the third position illustrated in FIG. 2C)). Control signal 200-18A can indicate one or more start and/or stop instructions, a movement and/or actuation direction, a movement and/or actuation speed, an amount of time to move and/or actuate, a goal position (e.g., pose and/or location) for movement and/or actuation, and/or one or more other characteristics of movement and/or actuation. In some embodiments, the control signal and the energy source are the same signal and/or input. In some embodiments, one or more additional components (e.g., mechanical and/or electric) are coupled (e.g., removably or permanently) to actuator 200-18B for affecting movement and/or actuation (e.g., mechanical linkage such as a lead screw, gears, and/or other component for changing (e.g., converting) a characteristic of movement and/or actuation). In some embodiments, actuator 200-18B includes one or more feedback components (e.g., position sensor, encoder, overcurrent sensor, and/or force sensor) that form part of a feedback loop for modifying and/or ceasing movement and/or actuation (e.g., slowing actuation as a goal position is reached and/or ceasing actuation if physical resistance to actuation is detected via a sensor). In some embodiments, the one or more feedback components are included (e.g., partially and/or wholly) in a movement controller (e.g., movement controller 200-13) operatively coupled to the actuator.

Attention is now turned to functionality (e.g., features and/or capabilities) of one or more devices (e.g., computer system 100 and/or device 200). One such functionality is implementing an “agent,” which can alternatively be referred to as a software agent, an intelligent agent, an interactive agent, a virtual assistant, an intelligent virtual assistant, an interactive virtual assistant, a personal assistant, an intelligent personal assistant, an interactive personal assistant, an intelligent interactive personal assistant, and/or an artificial intelligence (AI) assistant. In some embodiments, an agent refers to a set of one or more functions implemented in hardware and/or software (e.g., locally and/or remotely) on an agent system (e.g., a single device and/or multiple devices). In some embodiments, an agent performs operations to perceive an environment, acquire knowledge, retrieve knowledge, learn skills, interact with users, and/or perform tasks. The agent can, for example, perform these (and/or other) operations in response to user input and/or automatically (e.g., at an appropriate time determined based on a perceived context). A non-exhaustive list of exemplary operations that an agent can be used for and/or with includes: tracking a user's eyes, face, and/or body (e.g., to move with the user and/or identify an intent and/or activity of the user); detecting, recognizing, and/or classifying a user in the environment; detecting and/or responding to input (e.g., verbal input, air gestures, and/or physical input, such as touch input and/or force inputs to physical hardware components (e.g., button, knobs, and/or sliders)); detecting context (e.g., user context, operating context, and/or environmental context); moving (e.g., changing pose, position, orientation, and/or location); performing one or more operations in response to input, context, and/or stimulus (e.g., an object or event (e.g., external and/or internal to a device) that causes one or more responsive operations by a device); providing intelligent interaction capabilities (e.g., due to in part to one or more machine learning (“ML”) models such as a large language model (“LLM”)) for responding and/or causing operations to be performed; and/or performing tasks (e.g., a set of operations for achieving a particular goal) (e.g., automatically and/or intelligently). In some embodiments, an agent performs operations in response to non-contact inputs (e.g., air gestures and/or natural language commands). The preceding list is meant to be illustrative of operations that can be performed using an agent but is not meant to be an exhaustive list. Other operations fall within the intended scope of the capabilities of an agent. Additionally, for the purposes of this disclosure, an agent does not need to include all of the functionality mentioned herein but can include less functionality or more functionality (e.g., an agent can be implemented on an agent system that does not have movement functionality but that otherwise includes an intelligent personal assistant that can interact with a user).

In some embodiments, a user is (e.g., represents, includes, and/or is included in) one or more of a user, person, object, and/or animal in an environment (e.g., a physical and/or virtual environment) (e.g., of the device). In some embodiments, a user is (e.g., represents, includes, and/or is included in) an entity that is perceived (e.g., detected by the device, one or more other devices, and/or one or more components thereof). In some embodiments, an entity is something that is distinguished from surrounding entities (e.g., pieces of environments and/or other users) and/or that is considered as a discrete logical construct via one or more components (e.g., perception components and/or other components). In some embodiments, a user is physical and/or virtual. For example, a physical user can represent a user standing in front of, and being perceived by, the device. As another example, a virtual user can represent an avatar in a virtual scene perceived by the device (e.g., the avatar is detected in a media stream received by the device and/or captured by a camera of the device). Although presented above as examples of a “user,” the terms and/or concepts referred to as “person,” “object,” and/or “animal” can be interchanged with “user” throughout this disclosure, unless explicitly indicated otherwise. For example, use the term “user” can likewise be understood to also refer to “person,” unless explicitly indicated otherwise.

As an example, and referring back to FIGS. 2A-2C, an agent implemented at least partially on device 200 can perform operations that cause display portion 200-1 of device 200 to move with respect to base portion 200-2. For example, the agent detects (e.g., perceives and determines the occurrence of) a context that includes the user standing up (e.g., based on facial detection and tracking); and, in response, the agent causes device 200 to open and/or device 200 opens display portion 200-1 to the larger angle. As another example, the agent can detect verbal input that corresponds to (e.g., is interpreted as and/or that refers to an operation that includes) a request to move the display (e.g., “Please move my display,” or “Please enter sleep mode.”); and, in response, the agent causes device 200 to move and/or device 200 moves display portion 200-1.

FIG. 5 illustrates a functional diagram of an exemplary agent system 200-20A. As illustrated in FIG. 5, agent system 200-20A has a dotted box boundary that encloses input components 200-22, agent components 200-24, and output components 200-26. In some embodiments, agent system 200-20A includes fewer, more, and/or different components than illustrated in FIG. 5. In some embodiments, agent system 200-20 is implemented on a single device (e.g., computer system 100 and/or device 200). In some embodiments, agent system 200-20 is implemented on multiple devices. In some embodiments, one or more components of agent system 200-20 illustrated in and/or described with respect to FIG. 5 are external to but operatively coupled to agent system 200-20 (e.g., an accessory, an external device, an external sensor, an external actuator, an external display component, an external speaker, and/or an external database). In some embodiments, one or more components of agent system 200-20 are local to one or more other components of agent system 200-20. In some embodiments, one or more components of agent system 200-20 are remote from one or more other components of agent system 200-20.

In some embodiments, input components 200-22 includes components for performing sensing and/or communications functions of agent system 200-20. As illustrated in FIG. 5, input components 200-22 includes one or more sensors 200-22A. One or more sensors 200-22A can include any component that functions to detect data corresponding to a physical environment. Examples of one or more sensors 200-22A can include: a camera, a light sensor, a microphone, an accelerometer, a position sensor, a pressure sensor, a temperature sensor, olfactory sensor, and/or a contact sensor. This list is not intended to be exhaustive, and one or more sensors 200-22A can include other sensors not explicitly identified herein that detect, generate, and/or otherwise provide data that can be used (e.g., processed, stored, and/or transformed) for detecting data corresponding to a physical environment. As illustrated in FIG. 5, input components 200-22 includes one or more communications components 200-22B. One or more communications components 200-22B can include any component that functions to send and/or receive communications (e.g., an antenna, a modem, a network interface component, an encoder, a decoder, and/or a communication protocol stack) internal and/or external to agent system 200-20. Communications components 200-22B can be between different devices and/or between components of the same device. The communications can include control signals and/or data (e.g., messages, instructions, files, application data, and/or media streams). In some embodiments, input components 200-22 includes fewer, more, and/or different components than those illustrated in FIG. 5. In some embodiments, input components 200-22 is implemented in hardware and/or software.

In some embodiments, agent components 200-24 includes components that manage and/or carry out functions of an agent of agent system 200-20. As illustrated in FIG. 5, agent components 200-24 includes the following functional components: task flow, coordination, and/or orchestration component 200-24A, administration component 200-24B, perception component 200-24C, evaluation component 200-24D, interaction component 200-24E, policy and decision component 200-24F, knowledge component 200-24G, learning component 200-24H, models component 200-241, and APIs component 200-24J. Each of these components is described briefly below. Notably, this list of agent components 200-24 is not intended to be exhaustive, and agent components 200-24 can include other functional components not explicitly identified herein that can be used (e.g., processed, stored, and/or transformed) for performing any function of an agent, such as those described herein. In some embodiments, agent components 200-24 includes fewer, more, and/or different components than those illustrated in FIG. 5. In some embodiments, agent components 200-24 is implemented in hardware and/or software.

In some embodiments, task flow, coordination, and/or orchestration component 200-24A performs operations that enable an agent to handle coordination between various components. For example, operations can include handling a data processing task flow to move from perception component 200-24C (e.g., that detects speech input) to models component 200-241 (e.g., for processing the detected speech input using a large language model to determine content and/or intent of the speech input). In some embodiments, task flow, coordination, and/or orchestration component 200-24A performs operations that enable an agent to handle coordination between one or more external components (e.g., resources). For example, FIG. 5 illustrates examples of external components, such as external database 200-30. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, administration component 200-24B performs operations that enable an agent system to handle administrative tasks like managing system and/or component updates, managing user accounts, managing system settings, and/or managing component settings. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, perception component 200-24C performs operations that enable an agent to perceive environmental input. For example, operations can include detecting that a context and/or environmental condition has occurred, detecting the presence of a user (e.g., user, person, object, and/or animal in an environment), detecting an input that includes speech, detecting an input that includes an air gesture, detecting facial expressions, detecting characteristics (e.g., visible and/or non-visible) of a user, and/or detecting verbal and/or physical cues. In some embodiments, perception component 200-24C includes functionality performed by an operating system of a device implementing agent system 200-20. In some embodiments, perception component 200-24C includes functionality performed by one or more applications of a device implementing agent system 200-20.

In some embodiments, evaluation component 200-24D performs operations that enable an agent to process evaluate data (e.g., to determine a context such as a user context, an environmental context, and/or an operating context). For example, operations can include evaluating data gathered from perception component 200-24C, knowledge component 200-24G, external database 200-30, and/or remote processing resource 200-32. In some embodiments, evaluation component 200-24D includes functionality performed by an operating system of a device implementing agent system 200-20. In some embodiments, evaluation component 200-24D includes functionality performed by one or more applications of a device implementing agent system 200-20.

Reference is made herein to environmental context (also referred to herein as a “context of an environment” and/or “a context corresponding to an environment”). In some embodiments, an environmental context is a context based on one or more characteristics of the environment (e.g., users, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) using one or more of detecting input (e.g., via one or more input components) and/or receiving data (e.g., from one or more other devices and/or components in communication with the device).

Reference is made herein to user context (also referred to herein as a “context of a user” and/or “a context corresponding to a user”) (and/or a user context). In some embodiments, a user context is a context based on one or more characteristics of the user. For example, a user context can include the user's appearance and/or clothing, personality, actions, behavior, movement, location, and/or pose. In some embodiments, a device (e.g., using an agent) determines a user context (e.g., to be currently true, occurring, and/or applicable) using one or more of detecting input (e.g., via one or more input components) and/or receiving data (e.g., from one or more other devices and/or components in communication with the device). In some embodiments, a device determines user context based on historical context and/or learned characteristics of the user, where one or more characteristics of the user are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include the internal state of the device (and/or of one or more components of the device), an internal dialogue of the device (e.g., the device's understanding of a context), operations being performed by the device, applications and/processes that are executing (e.g., running and/or open) on the device. In some embodiments, a device (e.g., using an agent) determines an operational context (e.g., to be currently true, occurring, and/or applicable) using one or more of detecting input (e.g., via one or more input components) and/or receiving data (e.g., from one or more other devices and/or components in communication with the device). In some embodiments, a device (e.g., using an agent) determines an operational context (e.g., to be currently true, occurring, and/or applicable) using one or more internal states (e.g., accessed, retrieved, and/or queried by a process of the device).

In some embodiments, interaction component 200-24E performs operations that enable an agent to manage and/or perform interactions with users. For example, operations can include determining an appropriate interaction model for a particular context and/or in response to a particular input. In some embodiments, interaction component 200-24E includes functionality performed by an operating system of a device implementing agent system 200-20. In some embodiments, interaction component 200-24E includes functionality performed by one or more applications of a device implementing agent system 200-20.

In some embodiments, policy and decision component 200-24F performs operations that enable an agent to take actions in view of available data. For example, operations can include determining which operations to perform and/or which functional components to utilize in response to a detected context. In some embodiments, policy and decision component 200-24F includes functionality performed by an operating system of a device implementing agent system 200-20. In some embodiments, policy and decision component 200-24F includes functionality performed by one or more applications of a device implementing agent system 200-20.

In some embodiments, knowledge component 200-24G performs operations that enable an agent to access and use stored knowledge. For example, operations can include indexing, storing, and/or retrieving data from a data store, a database, and/or other resource. In some embodiments, knowledge component 200-24G includes functionality performed by an operating system of a device implementing agent system 200-20. In some embodiments, knowledge component 200-24G includes functionality performed by one or more applications of a device implementing agent system 200-20.

In some embodiments, learning component 200-24H performs operations that enable an agent to learn through experiences. For example, operations can include observing and/or keeping track of data that includes preferences, routines, user characteristics, and/or environmental characteristics in a manner in which such data can be used to inform future operation by the agent and/or a component thereof (e.g., such as when performing tasks and/or interactions with users). In some embodiments, learning component 200-24H includes functionality performed by an operating system of a device implementing agent system 200-20. In some embodiments, learning component 200-24H includes functionality performed by one or more applications of a device implementing agent system 200-20.

In some embodiments, models component 200-241 performs operations that enable an agent to apply ML models (e.g., such as a large language model (LLM)) to process data. For example, operations can include storing ML models, executing ML models, training and/or re-training ML models, and/or otherwise managing aspects of implementing ML models. In some embodiments, models component 200-241 includes functionality performed by an operating system of a device implementing agent system 200-20. In some embodiments, models component 200-241 includes functionality performed by one or more applications of a device implementing agent system 200-20.

In some embodiments, agent system 200-20 responds to natural language input. For example, agent system 200-20 responds to a natural language input that is in the form of a statement, a question, a command, and/or a request. In some embodiments, agent system 200-20 outputs text and/or speech output that is provided in a natural language or mimicking a natural language style. For example, agent system 200-20 can process the natural language question “How hot is it outside?” with a speech response that indicates the current temperature outside at the user's location (e.g., “It is 18 degrees outside.”). In some embodiments, agent system 200-20 responds to natural language input by providing information (e.g., weather, travel, and/or calendar information) and/or performing a task (e.g., opening a document, searching a database, and/or opening an application).

In some embodiments, agent system 200-20 includes and/or relies on one or more data models to process input (e.g., natural language input, gesture input, visual input, and/or other data input) and/or provide output (e.g., output of information via natural language output, visual output, audio output, and/or textual output). Such data models can include and/or be trained using user data (e.g., based on particular interactions and/or data from the user being interacted with) and/or global data (e.g., general data based on interactions and/or data from many users). For example, user data (e.g., preferences, previous use of language and/or phrases, calendar entries, a contact list, and/or activity data) can be used to better infer user intent and/or provide responses that are more likely to address a user's request. In some embodiments, data models used by agent system 200-20 include, are used by, and/or are implemented using one or more machine learning components (e.g., hardware and/or software) (e.g., one or more neural networks). Such machine learning components can be used to process verbal input to determine words and/or phrases therein, one or more contexts that correspond to the words, a user intent corresponding to the words, one or more confidence scores, and/or a set of one or more actions to take in response to the verbal input. Analogous operations can be performed to process other types of inputs, such as visual input, data input, and/or textual input. Such data models can include machine learning and/or data processing models, including, but not limited to, natural language processing models, language models, speech recognition models, object recognition models, visual processing models, ontologies, task flow models, and/or intent recognition models (e.g., used to determine user intent).

In some embodiments, Application Programming Interfaces (APIs) component 200-24J performs operations that enable an agent to interface with services, devices, and/or components. For example, operations can include relaying data (e.g., requests, responses, and/or other messages) between data interfaces (e.g., between software programs, between a system process and application process, between system processes, between application processes, between communication protocols, between a client and a server, between file systems, and/or between components on different sides of a trust boundary). In some embodiments, the data interfaces served by APIs component 200-24J are local (e.g., to the device, such as two application processes exchanging data) and/or remote (e.g., from the device, such as interfacing with a web service via a remote server). In some embodiments, APIs component 200-24J includes functionality performed by an operating system of a device implementing agent system 200-20. In some embodiments, APIs component 200-24J includes functionality performed by one or more applications of a device implementing agent system 200-20.

In some embodiments, output components 200-26 includes components for performing output functions of agent system 200-20. The exemplary output components illustrated in FIG. 5 are described briefly below. In some embodiments, output components 200-26 include fewer components, more, and/or different components than those illustrated in FIG. 5. In some embodiments, input components are implemented in hardware and/or software.

As illustrated in FIG. 5, output components 200-26 includes one or more visual output components 200-26A. One or more visual output components 200-26A can include any component that functions to output (e.g., generate, create, and/or display), and/or cause output of, a visual output (e.g., an output that is visually perceptible, such as graphical user interface, playback of visual media content, and/or lighting). Examples of one or more visual output components 200-26A can include: a display component, a projector, a head mounted display (HMD), a light-emitting diode (“LED”), and/or a component that creates visually perceptible effects (e.g., movement). This list is not intended to be exhaustive, and one or more visual output components 200-26A can include other visual output components not explicitly identified herein that detect, generate, and/or otherwise provide data that can be used (e.g., processed, stored, and/or transformed) for outputting visual output.

As illustrated in FIG. 5, output components 200-26 include one or more audio output components 200-26B. One or more audio output components 200-26B can include any component that functions to output (e.g., generate and/or create), and/or cause output of, an audio output (e.g., an output that is audibly perceptible, such as a sound, music, speech, and/or audio media content). Examples of one or more audio output components 200-26B can include: a speaker, an audio amplifier, a tone generator, and/or a component that creates audibly perceptible effects (e.g., movement such as vibrations). This list is not intended to be exhaustive, and one or more audio output components 200-26B can include other audio output components not explicitly identified herein that detect, generate, and/or otherwise provide data that can be used (e.g., processed, stored, and/or transformed) for outputting audio output.

As illustrated in FIG. 5, output components 200-26 include one or more movement output components 200-26C (also referred to herein as a “movement component”). One or more movement output components 200-26C can include any component that functions to output (e.g., generate and/or create), and/or cause output of, a movement output (e.g., an output that includes physical movement of the device and/or another device/component). Examples of one or more movement output components 200-26C can include: a movement controller, an actuator, a mechanical linkage, an electromechanical device, and/or a component that creates physical movement. This list is not intended to be exhaustive, and one or more movement output components 200-26C can include other movement output components not explicitly identified herein that detect, generate, and/or otherwise provide data that can be used (e.g., processed, stored, and/or transformed) for outputting movement output. As illustrated in FIG. 5, output components 200-26 include one or more haptic output components 200-26D. One or more haptic output components 200-26D can include any component that functions to output (e.g., generate, create, and/or display), and/or cause output of, a haptic output (e.g., an output that is physically perceptible using tactile sensation, such as a vibration, pressure, texture, and/or shape). Examples of one or more haptic output components 200-26D can include: a speaker, a component that generates vibrations, a component that generates texture changes, a component that generates pressure changes, and/or a component that creates perceivable tactile effects. This list is not intended to be exhaustive, and one or more haptic output components 200-26D can include other haptic output components not explicitly identified herein that detect, generate, and/or otherwise provide data that can be used (e.g., processed, stored, and/or transformed) for outputting haptic output.

As illustrated in FIG. 5, output components 200-26 include one or more communications components 200-26E. One or more communications components 200-26E can include any component that functions to send and/or receive communications (e.g., an antenna, a modem, a network interface component, an encoder, a decoder, and/or a communication protocol stack) internal and/or external to agent system 200-20. In some embodiments, the communications can be between different devices and/or between components of the same device. In some embodiments, the communications can include control signals and/or data (e.g., messages, instructions, files, application data, and/or media streams). In some embodiments, one or more communications components 200-26E includes one or more features of one or more communications components 200-22B (e.g., as described above). In some embodiments, one or more communications components 200-26E are the same as one or more communications components 200-22B (e.g., one or more components that handle communication inputs and outputs and thus be considered as either and/or both an input component and an output component).

Throughout this disclosure, reference can be made to movement output (e.g., referred to in various forms such as: movement, device movement, output of movement, device motion, output of motion, and/or motion output). In some embodiments, outputting (e.g., causing output of) movement refers to movement of an electronic device (e.g., a portion or component thereof relative to another portion and/or of the whole electronic device). For example, referring back to FIG. 2B, movement output can refer to device 200 actuating movement component 200-3 to move display portion 200-1 to the position illustrated in FIG. 2B (e.g., from the position in FIG. 2A). In some embodiments, movement output is not (e.g., does not include and/or does not only include) haptic output (e.g., haptic movement output). In some embodiments, movement output is not (e.g., does not include and/or does not only include) vibration output. In some embodiments, movement output is not (e.g., does not include and/or does not only include) oscillating movement (e.g., movement of an actuator that merely causes vibration by moving a component repeatedly along a path that is internal to the device). In some embodiments, movement output includes (e.g., requires and/or results in) changing a location and/or pose of at least a portion of (and/or the entirety of) a component or the electronic device. In some embodiments, movement output includes output that moves at least a portion of (and/or the entirety of) a component or the electronic device from a first location and/or first pose to a second location and/or second pose. For example, with respect to FIGS. 2A-2C, display portion 200-1 is shown in a different location (e.g., in space) and pose (e.g., relative to base portion 200-2) in each of FIGS. 2A, 2B, and 2C. In some embodiments, movement output includes output that moves at least a portion (and/or the entirety of) a component or the electronic device to a third location and/or third pose (e.g., from the first location and/or first pose and/or from the second location and/or the second pose). In some embodiments, the third location and/or the third pose is the same as the first location and/or first pose and/or as the second location and/or the second pose. For example, movement output can include device 200 in FIG. 2A beginning from the first position illustrated in FIG. 2A, moving to the second position illustrated in FIG. 2B, and moving to return to the first position illustrated in FIG. 2A. For example, movement output can include device 200 in FIG. 2A beginning from the first position illustrated in FIG. 2A, moving to the second position illustrated in FIG. 2B, and continuing movement to come to rest at the third position illustrated in FIG. 2C.

Throughout this disclosure, an electronic device can be illustrated in (and/or described as being in) different locations and/or poses at different times. For example, in FIG. 2A illustrates device 200 in the first position, FIG. 2B illustrates device 200 in the second position, and FIG. 2A illustrates device 200 in the third position. In some embodiments, the electronic device moves itself between such locations and/or poses (e.g., using movement output). For example, device 200 moves from the first position to the second position under its own power (e.g., using a power source and one or more actuators to cause movement). In particular, any example herein that illustrates and/or describes an electronic device being at different locations and/or poses (e.g., at different times) should be understood to cover a scenario in which the device moved itself between such locations and/or poses (e.g., unless otherwise clearly indicated).

Throughout this disclosure, reference can be made to “performing output,” “causing output,” and/or “outputting” (e.g., by one or more output generation devices and/or by one or more output generation components) (and/or similar such phrases). In some embodiments, outputting (e.g., or the aforementioned variants) includes (and/or is) outputting movement (e.g., movement output as described above).

Throughout this disclosure, reference can be made to “displaying,” “causing display of,” and/or “outputting visual content” (e.g., by one or more display components) (and/or similar such phrases). In some embodiments, displaying (e.g., or the aforementioned variants) includes displaying visual content in connection with outputting movement (e.g., movement output as described above).

Throughout this disclosure, reference can be made to “outputting audio,” “causing output of audio,” and/or “providing audio output” (e.g., by one or more audio generation components and/or by one or more audio output devices) (and/or similar such phrases). In some embodiments, outputting audio (e.g., or the aforementioned variants) includes outputting audio content in connection with outputting movement (e.g., movement output as described above).

Throughout this disclosure, reference can be made to movement of an avatar (e.g., or other representation of a user, an agent and/or a character that is displayed) (e.g., by one or more display components) (and/or similar such phrases). In some embodiments, moving an avatar (e.g., or the aforementioned variants) includes displaying movement of visual content in connection with outputting movement (e.g., movement output as described above). For example, displaying an avatar nodding in agreement can include movement of the electronic device in a similar manner as the avatar movement (e.g., mimicking nodding). In some embodiments, moving an avatar (e.g., or the aforementioned variants) includes outputting movement (e.g., movement output as described above) without displaying movement of visual content. For example, a device can perform movement output that mimics nodding without moving a displayed avatar (e.g., the avatar does not move relative to the display). As illustrated in FIG. 5, agent system 200-20 can optionally interface with external components such as external database 200-30, remote processing component 200-32, and/or remote administration component 200-34. In some embodiments, external database 200-30 represents one or more functions that provide data storage resources accessible to agent system 200-20. In some embodiments, access to the data of external database 200-30 is provided directly to agent system 200-20 (e.g., the agent system manages the database) and/or indirectly to agent system 200-20 (e.g., a database is managed by a different system, but data stored therein can be provided and/or stored for use by agent system 200-20). In some embodiments, external database 200-30 is dedicated to (e.g., only for use by) agent system 200-20, is not dedicated to agent system 200-20 (e.g., is a database of a web service accessible to different agent systems), and/or is a combination of both dedicated and non-dedicated database resources. In some embodiments, remote processing component 200-32 represents one or more components that function as a data processing resource that is accessible to agent system 200-20. In some embodiments, access to remote processing component 200-32 is provided directly to agent system 200-20 (e.g., the agent system manages the processing resources) and/or indirectly to agent system 200-20 (e.g., a processing resource managed by a different system, but that can provide data processing for the benefit of agent system 200-20). In some embodiments, remote processing component 200-32 is dedicated to (e.g., only for use by) agent system 200-20, is not dedicated to agent system 200-20 (e.g., is a processing resource of a web service accessible to different agent systems), and/or is a combination of both dedicated and non-dedicated processing resources. Examples of data processing include processing image data (e.g., for feature extraction and/or object detection), processing audio data (e.g., for processing natural language speech input via a large language model), and/or training a machine learning algorithm and/or model. In some embodiments, remote administration component 200-34 represents functions that include and/or are related to administrative functions. For example, such administrative functions can include providing component updates to agent system 200-30 (e.g., software and/or firmware updates), managing accounts (e.g., permissions, access control, and/or preferences associated therewith), synchronizing between different agent systems and/or components thereof (e.g., such that an agent accessible via multiple devices of a user can provide a consistent user experience between such devices), managing cooperation with other services and/or agent systems, error reporting, managing backup resources to maintain agent system reliability and/or agent availability, and/or other functions required by agent system 200-20 to perform operations, such as those described herein.

The various components of agent system 200-20 described above with respect to FIG. 5 represent functional blocks that represent functionality. This functionality can be implemented on the same and/or different hardware (e.g., physical components) and/or by the same and/or different software. For example, the functional blocks can be implemented using one or more physical components, devices (e.g., computer system 100 and/or device 200), and/or software programs. In other words, each functional block does not necessarily represent a single, discrete physical component, device, and/or software program, but can be implemented using one or more of these. Further, agent system 200-20 can include multiple implementations of functionality represented by a respective functional block. For example, agent system 200-20 can include multiple different model components representing ML models that are used in different contexts, can include multiple different API components representing different APIs that are used for different services, and/or can include multiple different visual output components that are used for outputting different types of visual output.

Attention is now turned to discussion of concepts that can arise with respect to operation of an agent.

As discussed throughout, an agent can be capable of interacting with a user. In some embodiments, this capability includes the ability to process explicit requests, commands, and/or statements. In some embodiments, explicit requests, commands, and/or statements include and/or are interpreted as instructions directed to accomplishing a task (e.g., display X, complete task Y, and/or perform operation Z). In some embodiments, an agent includes the ability to process implicit requests, commands, and/or statements. In some embodiments, an implicit request, command, and/or statement does not include an explicit request, command, and/or statement. For example, “I like going to Europe,” can be interpreted as an implicit request, command, and/or statement which, in response to detecting, device 200 displays an itinerary in response to the statement. As another example, “This picture is for my grandmother,” can be interpreted as an implicit request, command, and/or statement which, in response to detecting, device 200 displays suggestions for modifying the picture). As another example, “I'm so tired,” can be interpreted as an implicit request, command, and/or statement which, in response to detecting, device 200 causes a sleep meditation application to begin a meditation session. As yet another example, “I miss my grandad” can be interpreted as an implicit request, command, and/or statement when, in response to detecting, device 200 can initiate a live communication session (e.g., telephone call, video call, and/or text messaging session) with grandad. In some embodiments, an implicit request is more likely to be processed according to one or more current environmental context, operational context, and/or user context, while an explicit request is less likely to be processed according to one or more current environmental context, operational context, and/or user context. For example, the phrase, “call my grandad,” can be an explicit request, and in response to detecting the request, device 200 will initiate a live communication session with grandad, irrespective of one or more current environmental context, operational context, and/or user context. However, the phrase, “I miss my grandad,” can be an implicit request, and in response to detecting the request, device 200 can display a list of gifts to buy for grandad if a user has been recently talking about buying gifts or could call grandad in another context that does not include the user recently discussing buying gifts. In some embodiments, a request can include one or more explicit requests and one or more implicit requests. In some embodiments, an implicit request is responded to independently from an explicit request; and in other embodiments, a response to an implicit request is dependent on an explicit request.

Reference can be made herein to a response by an agent that is output by a device. In some embodiments, a response includes an audio portion (e.g., audio output, audible output, sound, and/or speech) (also referred to herein as a “verbal response,” an “audio response,” and/or an “audible response) and/or a visual portion (e.g., display and/or movement of a representation and/or avatar). In some embodiments, a response includes a movement portion (e.g., movement of the device). In some embodiments, a response includes a haptic portion (e.g., touch and/or vibration).

Reference can be made herein to an internal dialogue, internal context, and/or an operational context, which can refer to a dynamic context or dynamic decision-making process of the device, an internal state of device 200, and/or internal data the device is partially basing its decision on. In some embodiments, an internal dialogue includes a set of one or more rules, characteristics, detections, and/or observations that the computer system uses to generate a response to one or more commands, questions, and/or statements). In some embodiments, the set of one or more rules, characteristics, detections, and/or observations are learned and/or generated via deep learning and/or one or more machine learning algorithms, and/or using one or more machine learning and/or system agents. In some embodiments, an internal dialogue is generated in real-time. In some embodiments, an internal dialogue is locally stored and/or stored via the cloud. In some embodiments, an internal dialogue can be modified, updated, and/or deleted. In some embodiments, an internal dialogue is generated based on other internal dialogues.

Reference can be made herein to personality and/or behavior (or a representation of personality/behavior) (e.g., of an agent, user, and/or character). In some embodiments, personality and/or behavior refers to a set of one or more characteristics that the device detects, has knowledge of, conforms to, applies, and/or tracks. In some embodiments, the personality or behavior is used as basis to perform operations. For example, an agent can detect a user's personality and respond in a manner based on the personality (e.g., output different responses in response to different user personalities). As another example, the agent can output a response having characteristics that correspond to one or more characteristics that correspond to the personality and/or behavior (e.g., output a response in different ways that depend on personality of the agent). In some embodiments, such characteristics represent and/or mimic personality of a user, such as how the user acts and/or speaks. In some embodiments, such characteristics approximate a user's personality.

In some embodiments, an agent is a system agent. In some embodiments, a system agent is an agent that corresponds to a process that originates from and/or is controlled by an operating system of the device (e.g., the device implementing the agent). In some embodiments, an agent is an application agent. In some embodiments, an application agent is an agent that corresponds to a process that originates from and/or is controlled by an application of (e.g., installed on and/or executed by) the device (e.g., the device implementing the agent).

Reference can be made herein to a representation (e.g., an avatar and/or avatar representation) of an agent (e.g., and/or of a user (e.g., person, object, and/or an animal) and/or a user interface object (e.g., an animated character)). In some embodiments, a representation of an agent refers to a set of output characteristics (e.g., visual and/or audio) of the agent (and/or the user and/or the user interface object). For example, a representation of an agent can include (and/or correspond to) a set of one or more visual characteristics (e.g., facial features of an animated face) and/or one or more audio characteristics (e.g., language and voice characteristics of audio output). In some embodiments, a representation (e.g., of an agent) is used to represent output by the agent. For example, a device implementing an interactive agent outputs audio in a voice of the agent and displays an animated face of the agent moving in a manner to simulate the agent speaking the audio output. In this way, a user can feel like they are having a normal conversation with the agent. In some embodiments, a representation of an agent is (or is not) inclusive of personality and/or behavior characteristics (e.g., as described above). For example, a representation of an agent can include (and/or correspond to) a set of visual characteristics (e.g., facial features of an animated face) and also a set of personality characteristics. In some embodiments, a representation of an agent includes a set of user characteristics that correspond to visual representation of a user (e.g., representations of a user's appearance, voice, and/or personality are used as an avatar that appears to move and/or speak). In some embodiments, a representation is a representation of a face (e.g., a user interface object that is output having features that simulate a face and/or facial expressions of a person (e.g., for conveying information to a viewer)).

In some embodiments, a character (e.g., of an agent and/or avatar) refers to a particular set of characteristics of a representation. For example, an avatar can take on (e.g., use, apply, interact with, and/or output according to) characteristics of a fictional and/or non-fictional character (e.g., from a movie, a show, a book, a series, and/or popular culture).

In some embodiments, a voice (e.g., of an agent and/or avatar) refers to a set of one or more characteristics corresponding to sound output that resembles (e.g., represents, mimics, and/or recreates) vocal utterance (e.g., attributable and/or simulated as being output by an agent and/or avatar). For example, device 200 can output a sentence that sounds different depending on a voice used. In some embodiments, a particular character and/or avatar can be configured to use a particular voice (e.g., have a corresponding voice). In some embodiments, the particular voice can mimic a user's voice.

In some embodiments, an appearance (e.g., of an agent and/or avatar) refers to a set of one or more characteristics corresponding to visual output that represents an avatar (and/or an agent). For example, device 200 can output an avatar that has a set of facial features forming an appearance that resembles a particular character from a movie.

In some embodiments, an expression of an avatar refers to a set of one or more characteristics corresponding to a particular visual appearance of a user, an avatar, and/or an agent. For example, device 200 can output an avatar that has a set of facial features arranged in a particular way to give the appearance of a facial expression (e.g., which can be used as a form of non-verbal communication to a user) (e.g., a frown is an expression of sadness, a smile is an expression of happiness, and/or wide open eyes is an expression of surprise). As another example, device 200 can output an avatar that has a set of body features (e.g., arms and/or legs) arranged in a particular way to give the appearance of a body expression (e.g., which can be used as a form of non-verbal communication to a user) (e.g., a hand gesture is an expression of approval, covering eyes is an expression of fear, and/or shrugging shoulders is an expression of lack of knowledge). In some embodiments, an expression includes movement (e.g., a head nod is an expression of agreement and/or disagreement) of the avatar. In some embodiments, device 200 can move, via the movement component, to indicate an expression with or without the avatar moving. In some embodiments, an agent performs one or more operations that depend on a user's expression (e.g., detects if a person is sad and responds with a kind statement or question). In some embodiments, expressions (e.g., whether and/or how they are used and/or how they are output) depends on personality. For example, a first personality can use a particular expression more than a second personality. As another example, an expression (e.g., frown, smile, and/or how wide eyes are opened) for the first personality can appear different from the expression (and/or a similar and/or equivalent expression) for a second personality (e.g., the first personality smiles in a manner that reveals teeth, but the second personality smiles without revealing teeth).

In some embodiments, an agent (e.g., an avatar of the agent and/or an agent system (e.g., hardware and/or software) implementing the agent) mimics characteristics of another user, agent, and/or character (e.g., in personality, behavior, expressions, and/or voice). In some embodiments, mimicking includes mirroring a user (e.g., copying use of a phrase and/or movement detected from a user interacting with the agent). In some embodiments, mimicking characteristics of a user includes attempting to reproduce the characteristics of the user (e.g., in the exact same manner and/or in manner that resembles the characteristics but is not an exact reproduction of the characteristics). For example, an agent mimicking voice and/or expressions does not require the agent have the exact same voice and/or expressions as the user being mimicked (e.g., but rather simply resembles the user's voice and/or expressions).

In some embodiments, a component and/or device uses (e.g., performs operations, makes decisions, and/or determines context based on) learned characteristics (e.g., characteristics of a context, user, and/or environment that the device has learned over time (e.g., via detection, prior experience, and/or feedback (e.g., from one or more users)). For example, characteristics learned over time can include a user's routine. In such example, if a particular user asks an agent for a summary of any new messages for the user at the same time every day, the agent can learn to perform operations automatically based on the learned characteristics of the routine (e.g., what data is needed, when the data is needed, and/or for which user). In some embodiments, use of learned characteristics enables an agent (and/or device) to improve understanding of (and/or responses to) a context, user, and/or environment, and/or to understand a context, user, and/or environment that otherwise was not (and/or would not be) understood (e.g., not responded to or responded to incorrectly). In some embodiments, learned characteristics are formed (e.g., by and/or for an agent) using reinforcement learning. In some embodiments, learned characteristics correspond to one or more levels of confidence, certainty, and/or reward (e.g., that are shaped by one or more reward functions). In some embodiments, learned characteristics (and/or how they are used to affect output of an agent and/or device) can change over time (e.g., levels confidence, certainty, and/or reward change over time). For example, output of a device before learning a set of learned characteristics can be different from output of the device after learning the set of learned characteristics. In some embodiments, a component and/or device uses learned knowledge. For example, similar to described above with respect to learned characteristics, learned knowledge can refer to information used to update (e.g., enhance, add to, and/or augment) a knowledge base of a device (e.g., for use by an agent implemented thereon). In some embodiments, multiple sets of learned characteristics for a user can be stored and/or used. In some embodiments, different sets of learned characteristics for different users can be stored and/or used.

Reference can be made herein to interaction with an agent (and/or a device). In some embodiments, an interaction refers to a set of one or more inputs and/or outputs of a device implementing the agent and one or more users. For example, an interaction can be an input by a user (e.g., “Please turn on the lights”) and a corresponding output (e.g., causing the lights to turn on and/or a response by the device of “Okay”). In some embodiments, interaction can include multiple inputs/outputs by one or more of the parties to the interaction (e.g., device and/or users). For example, an interaction can include a first input by a user (e.g., “Please turn on the lights”) and a corresponding first output (e.g., “Which lights?”), and also include a second input by the user (e.g., “Kitchen lights”) and a second output from the device (e.g., “Okay”). In some embodiments, which inputs and/or outputs are considered together as an interaction is based on a logical and/or contextual grouping (e.g., interactions within the previous thirty (30) seconds and/or interactions relating to turning on the lights). As one of skill will appreciate, an interaction can be considered in a manner that depends on the implementation (e.g., determining when an interaction is complete can involve determining if the user still present (e.g., speaking at all) and/or if the user still talking about the lights or has moved onto a different topic). In some embodiments, an interaction is a current interaction (e.g., ongoing, presently occurring, and/or active). In some embodiments, an interaction is a previous interaction. The examples above describe a device having a conversation with a user. In some embodiments, a conversation is between two or more users (e.g., users in an environment). For example, a device can detect a conversation between to users (e.g., the users are directing speech and responses to each other, rather than to the device).

In some embodiments an agent (and/or device) determines and/or performs an operation based on an intent corresponding to a user. For example, a device detects user input and outputs a response that depends on an intent of the user input. For example, a device detects user input that includes a pointing gesture detected together with verbal instruction to “turn on that light,” and in response, the device turns on the light that is determined to correspond to the intent of the input (e.g., the light toward which the pointing gesture directed). In some embodiments, intent is determined (e.g., by the device that detects input and/or by one or more other devices) using one or more of: one or more inputs, knowledge (e.g., learned knowledge about a user based on a history of observed behavior, personality, and interactions), learned characteristics, and/or context. In some embodiments, intent is determined from one or more types of input (e.g., verbal input, visual input via a camera, and/or contextual input).

Attention is now directed towards embodiments of user interfaces (“UI”) and associated processes that are implemented on an electronic device, such as computer system 100 and/or device 200.

FIGS. 6A-6D illustrate exemplary user interface for moving to a location corresponding to a user in accordance with some embodiments. The user interfaces in these figures are used to illustrate the processes described below, including the processes in FIG. 7.

In some embodiments, FIGS. 6A-6D illustrate an exemplary scenario, where computer system 600 moves to face a user in response to receiving a telephone call for the user. In some embodiments, moving to face the user in response to receiving the telephone call allows computer system 600 to move to a position that is more accessible to the user. In some embodiments, the user can see the display of computer system 600 more easily and/or interact with computer system 600 more easily by performing one or more inputs directed to computer system 600, such as touch inputs and/or air gestures. While the techniques described below in relation to FIGS. 6A-6D include a use case where a telephone call is received, computer system 600 can move to face one or more users in response to detecting other events, such as receiving a request to participate in a live communication session, receiving a notification, such as a message notification, an application notification, and/or receiving an indication that a calendar event will occur.

The left side of FIG. 6A illustrates computer system 600 displaying interface 602, which is a home screen interface of computer system 600. The right side of FIG. 6A illustrates environment 604. Within environment 604 is computer system 600, user 612 at a left-most position, user 608 in a middle position, and user 610 in a right-most position. The dotted lines angled from computer system 600 represent the area of visibility of computer system 600 (e.g., the field of view). In some embodiments, the display screen of computer system 600 is visible to the elements of environment 604 that are within the dotted lines.

In some embodiments, computer system 600 moves to face a user in response to an event occurring. For example, at FIG. 6A, computer system 600 detects an incoming video call intended for user 608. As illustrated on the right side of FIG. 6B, in response to detecting that user 608 is the intended recipient for the incoming video call, computer system 600 rotates to the left so that user 608 is within the area of visibility. In some embodiments, computer system can move to face one or more users in response to detecting other events, such as receiving a request to participate in a live communication session, receiving a notification, (such as a message notification and/or an application notification) and/or receiving an indication that a calendar event will occur.

In some embodiments, computer system 600 moves so that the display of computer system 600 is facing user 608, which prevents the user from having to move to interact with the call. For example, as illustrated in FIG. 6B, computer system 600 displays incoming call user interface 614 in response to receiving the incoming call. Incoming call user interface 614 includes indicator 616, which indicates that Jane is the name of the caller, and photo 618, which is the contact photo of Jane that is saved within computer system 600 and/or is a live feed of Jane. Incoming call user interface 614 also includes control 622, which provides the option to reject the incoming call, and control 620, which provides the option to accept the incoming call. Thus, by moving, computer system 600 has made the various controls (e.g., 620 and 622) and representations (e.g., 616 and 618) displayed via incoming call user interface 614 more accessible (e.g., closer to the user) to user 608.

In some embodiments, the type of event can determine who the computer system moves to face. Note that FIG. 6B illustrates both user 608 and user 610 within the area of visibility. Here, user 608 and user 610 are within the area of visibility because the incoming call is not highly sensitive and/or private. However, in some embodiments, when a determination is made that the incoming call is highly sensitive and/or private, computer system 600 could rotate further counterclockwise so that a portion (e.g., the portion inside of the dotted lines on the right side of FIG. 6B) of computer system 600 is not visible to user 610 but remains visible to user 608. For example, computer system 600 can scan an area for a particular user and choose to face in the direction of that particular user. Before (and/or while and/or after) such scanning, computer system 600 can determine whether the phone call is personal (e.g., highly sensitive and/or private). Computer system 600 can determine whether the call should be transferred to a personal device of the particular user (e.g., a phone and/or a wearable device). For example, if the user's parent is calling and all of the user's siblings are standing nearby, computer system 600 can find and face in the direction of the user and allow the conversation to be taken from the device, even though the parent is calling the particular user. For example, however, if a health care provider is calling for the particular user (e.g., or a different user), computer system 600 can recommend transferring the call to a personal device the particular user (e.g., or other user that the health care provider is calling for).

In some embodiments, computer system 600 can move in different ways. In some embodiments, computer system 600 can tilt (e.g., 0-270 degrees), can rotate (e.g., 0-360 degrees), and/or move right, left, up, down, and/or any combination thereof. In some embodiments, computer system 600 performs a preset movement in conjunction with moving to face a user. In some embodiments, a preset movement can include computer system 600 shaking, bowing, and/or vibrating. For example, upon receiving a call, computer system 600 can shake and then move to face the intended recipient of the event (e.g., as computer system 600 moved to face user 608 as illustrated in FIG. 6B). In some embodiments, computer system 600 shakes while moving to face user 608. In some embodiments, computer system 600 shakes after moving to face user 608. In some embodiments, if a determination is made that user 608 is not located in environment 604 (through processes described below), computer system 600 performs the preset movement but does not move to face user 608. In some embodiments, types of movements differentiate between types of events. For example, a shake can indicate a video call, a bow can indicate an application notification, and a vibration can indicate a text message.

In some embodiments, if computer system 600 does not detect user 608 in environment 604, computer system 600 stays in the same position. For example, computer system determined that the incoming call detected in FIG. 6A was intended for user 608. If computer system 600 determined that user 608 was not present in environment 604, computer system would stay in the same position as illustrated in FIG. 6A. Computer system 600 determines that user 608 is or is not located in environment 604 based on previous interactions. For example, if computer system 600 has not detected user 608 for a predetermined period of time before receiving the call, computer system 600 determines that user 608 is not present within environment 604. In some embodiments, computer system 600 determines that user 608 is not located in environment 604 via one or more cameras pointed in different directions of environment 604. In some embodiments, computer system 600 determines that user 608 is not located in environment 604 via sound detectors (e.g., microphones). At FIG. 6B, computer system 600 detects input 605B on control 620. In some embodiments, input 605B can be a touch input via a touch-sensitive surface, an air input, a gaze input, and/or a voice input.

As illustrated in FIG. 6C, in response to detecting input 605B, computer system 600 accepts the incoming call and displays call user interface 624. Call user interface 624 includes live preview 626 wherein computer system 600 displays Jane in real time. Call user interface 624 also includes user preview 630 in a corner of live preview 626 wherein computer system 600 displays a live preview of the camera of computer system 600. As illustrated in FIG. 6C, as computer system 600 is facing user 608, computer system 600 displays user 608 in user preview 630. Although user 610 is within the area of visibility, the camera of computer system 600 does not detect user 610 due to the distance of user 610 from the camera. Thus, user 610 is not displayed in user preview 630 along with user 608. Call user interface 624 also includes controls region 628, which provides control options related to the call.

In some embodiments, computer system 600 moves based on characteristics other than and/or as an alternative to who the event is for. In some embodiments, computer system 600 moves to face as many users as possible. For example, if computer system 600 determines that the incoming call as described above with respect to FIG. 6A is intended for a household and/or is not highly sensitive and/or private, computer system 600 can move to face user 608, user 610, and user 612. Computer system 600 turning to face all or most of the users in environment 604 makes call user interface 624, as illustrated in FIG. 6C, more accessible and visible to all users. In some embodiments, computer system 600 moves to face a lesser amount of people. For example, if computer system 600 determines that the incoming call is highly sensitive and/or private, computer system 600 can move to face user 608 or user 608 and user 610. In some embodiments, user 608 is the primary owner of computer system 600 and, in response to detecting an incoming call, computer system 600 turns to face user 608 by default. At FIG. 6C, computer system 600 detects user 608 moving through environment 604.

As illustrated in FIG. 6D, in response to detecting user 608 moving from their position in FIG. 6C, computer system 600 moves in such a way that maintains user 608 within the area of visibility. FIG. 6D illustrates the call between Jane and user 608 as still active. Thus, for call user interface 624 to remain visible to user 608, computer system 600 follows user 608 as they move positions.

FIG. 7 is a flow diagram illustrating a method (e.g., process 700) for moving to a location corresponding to a user in accordance with some embodiments. Some operations in process 700 are, optionally, combined, the orders of some operations are, optionally, changed, and some operations are, optionally, omitted.

As described below, process 700 provides an intuitive way for moving to a location corresponding to a user. Process 700 reduces the cognitive burden on a user for interacting with a computer system, thereby creating a more efficient human-machine interface. For battery-operated computing devices, enabling a user to interact with the computer system faster and more efficiently conserves power and increases the time between battery charges.

In some embodiments, process 700 is performed at a computer system (e.g., 100, 200, and/or 600) that is in communication with a movement component (e.g., as described above with respect to FIG. 6A-6B) (e.g., an actuator, a movable base, a rotatable component, and/or a rotatable base). In some embodiments, the computer system is in communication with a display component (e.g., a display screen, a projector, and/or a touch-sensitive display). In some embodiments, the computer system is in communication with one or more input devices (e.g., a touch-sensitive surface, an input mechanism (e.g., a physical input mechanism, such as a button and/or a rotational input mechanism), a camera, a depth sensor, and/or a microphone). In some embodiments, the computer system is a watch, a phone, a tablet, a processor, a head-mounted display (HMD) device, a communal device, a media device, a speaker, a television, and/or a personal computing device. In some embodiments, the computer system is in communication with one or more output devices (e.g., a display component, an audio generation component, a speaker, a haptic output device, a display screen, a projector, and/or a touch-sensitive display).

While the computer system (e.g., 600) (e.g., via the movement component) is at a first position in an environment (e.g., 604), the computer system receives (702) a notification (e.g., an indication of a request to connect to a communication session (e.g., an incoming telephone call and/or an incoming video call) and/or content for a specific user) (e.g., 614) corresponding to a first user (e.g., 608) (e.g., as described above with respect to FIG. 6A-6B).

In response to receiving the notification corresponding to the first user, the computer system moves (704) (e.g., rotates, tilts, laterally moves, horizontally moves, vertically moves, and/or any combination thereof), via the movement component, a portion (e.g., a display component, a display, a center of a display, another portion of the display, a hardware button, a camera, and/or a portion (e.g., center portion and/or another portion) of a field-of-view of the camera) of the computer system (e.g., 600) to a second position, different from the first position, in the environment (e.g., 604), wherein the second position corresponds to a location of the first user (e.g., 608) in the environment (e.g., as described above with respect to FIG. 6B). In some embodiments, the first position does not correspond to the location of the first user in the environment. In some embodiments, the computer system faces the first user while in the second position (e.g., in this way the second position corresponds to the location of the user). In some embodiments, the computer system does not face the first user while in the first position. In some embodiments, the computer system faces a user when the display of the computer system is directed toward the first user, the center of the display of the computer system is directed to the first user, and/or the first user is in the center and/or another portion of a field of view of a camera. Moving the portion of the computer system in response to receiving the notification corresponding to the first user allows the computer system to move to a position that is more convenient for a user, thereby reducing the number of inputs needed to perform an operation and providing additional control options without cluttering the user interface with additional displayed controls.

In some embodiments, receiving the notification corresponding to the first user (e.g., 608) includes receiving a request to connect to a communication session (e.g., a live communication session, a video call, a telephone call, and/or a messaging session) between the first user and a second user different from the first user (e.g., described above with respect to FIG. 6B). In some embodiments, the second user is not in the environment. In some embodiments, the second user is outside of and/or away from the environment. Moving the portion of the computer system in response to receiving a request to connect to a communication session between the first user and a second user allows the computer system to move to a position that is more convenient for a user to participate in a communication succession, thereby reducing the number of inputs needed to perform an operation and providing additional control options without cluttering the user interface with additional displayed controls.

In some embodiments, the notification (e.g., an application (e.g., a news application, a ride sharing application, a food delivery application, a fitness application, and/or a health application) notification, a push notification, and/or a pull notification) is a message that was sent (e.g., described above with respect to FIG. 6B) (e.g., by a third user to the first user and/or by an application) (and/or received by the computer system from another computer system, such as a server or a personal device of another user). Moving the portion of the computer system in response to receiving a message that is sent allows the computer system to move to a position that is more convenient for a user to consume the message, thereby reducing the number of inputs needed to perform an operation and providing additional control options without cluttering the user interface with additional displayed controls.

In some embodiments, in accordance with a determination that the location of the first user (e.g., 608) in the environment (e.g., 604) is a first location, the second position corresponds to the first location (e.g., described above with respect to FIG. 6A). In some embodiments, in accordance with a determination that the location of the first user (e.g., 608) in the environment (e.g., 604) is a second location different from the first location, the second position corresponds to the second location (e.g., described above with respect to FIG. 6B) (and not the first location). In some embodiments, the computer system moves the portion of the computer system to a location and/or orientation where the first user is in the environment. In some embodiments, the computer system tracks and/or follows the first user and/or movement of the computer system tracks and/or follows movement of the first user while displaying information corresponding to the notification. In some embodiments, the portion of the computer system tracks and/or follows the first user and/or movement of the portion of the computer system tracks and/or follows movement of the first user while displaying information corresponding to the notification. Moving the portion of the computer system to a position that corresponds to the second location in response to receiving the notification corresponding to the first user allows the computer system to move to a position that is more convenient for a user, thereby reducing the number of inputs needed to perform an operation and providing additional control options without cluttering the user interface with additional displayed controls.

In some embodiments, in accordance with a determination that the location of the first user (e.g., 608) in the environment (e.g., 604) is the first location, the computer system (e.g., 600) does not move (e.g., the portion of the computer system) to a position corresponding to the second location (e.g., but does move (e.g., the portion of the computer system) to a position corresponding to the first location) (e.g., described above with respect to FIG. 6A). In some embodiments, in accordance with a determination that the location of the first user (e.g., 608) in the environment (e.g., 604) is the second location, the computer system (e.g., 600) does not move (e.g., the portion of the computer system) to a position corresponding to the first location (but does move (e.g., the portion of the computer system) to a position corresponding to the second location) (e.g., described above with respect to FIG. 6B).

In some embodiments, the computer system receives a respective notification. In some embodiments, in response to receiving the respective notification, in accordance with a determination that the respective notification corresponds to a first user (e.g., 608) and does not correspond to a second user, the computer system moves (and/or directs), via the movement component, the portion of the computer system (e.g., 600) toward the first user without moving, via the movement component, the portion of the computer system toward the second user (e.g., described above with respect to FIG. 6A-6B). In some embodiments, in response to receiving the respective notification, in accordance with a determination that the respective notification corresponds to the second user and does not correspond to the first user (e.g., 608), the computer system moves (and/or directs), via the movement component, the portion of the computer system (e.g., 600) toward the second user without moving, via the movement component, the portion of the computer system toward the first user (e.g., described above with respect to FIG. 6A-6B). In some embodiments, while the computer system is at the second position in the environment, the computer system receives a notification (e.g., an indication of a request to connect to a communication session (e.g., an incoming telephone call and/or an incoming video call) and/or content for a specific user) corresponding to a user different from the first user. In some embodiments, in response to receiving the notification corresponding to the user different from the first user, the computer system moves (e.g., rotates, tilts, and/or laterally moves), via the movement component, the portion of the computer system to another position, different from the first position and the second position, in the environment. In some embodiments, the other position corresponds to a location of the second user in the environment (and, in some embodiments, does not correspond to the location of the first user in the environment). In some embodiments, in accordance with a determination that the notification corresponds to the first user and the second user, the computer system moves to face the first user and the second user (e.g., face one, after the other; or face them at the same time). In some embodiments, in accordance with a determination that the respective notification corresponds to the first user and the second user, the computer system does not move to face the first user. In some embodiments, in accordance with a determination that the respective notification corresponds to the first user and the second user, the computer system does not move to face the second user. Moving toward a particular user based on the user to which the notification corresponds allows the computer system to intelligently move to face a user to which the notification might be more relevant, thereby reducing the number of inputs needed to perform an operation and providing additional control options without cluttering the user interface with additional displayed controls.

In some embodiments, in response to receiving the notification corresponding to the first user (e.g., 608), in accordance with a determination that a first number of users are detected in the environment (e.g., 604), the computer system moves, via the movement component, the portion of the computer system (e.g., 600) toward a first area of the environment (e.g., described above with respect to FIG. 6A-6D). In some embodiments, in response to receiving the notification corresponding to the first user, in accordance with a determination that a second number of users, different from the first number of users, are detected in the environment (e.g., 604), the computer system moves, via the movement component, the portion of the computer system (e.g., 600) toward a second area, different from the first area, of the environment (e.g., described above with respect to FIG. 6A-6D) (e.g., without moving the portion of the computer system toward and/or being directed to the first area). In some embodiments, in response to receiving the notification corresponding to the first user and in accordance with a determination that the first number of users are detected in the environment, the computer system does not move, via the movement component, the portion of the computer system toward the second area. Moving the portion of the computer system toward a particular area based on whether or not there are a certain number of users in the particular area allows the computer system to limit (e.g., decrease and/or increase) the amount of people for which the portion of the computer system is more convenient, thereby reducing the number of inputs needed to perform an operation and providing additional control options without cluttering the user interface with additional displayed controls.

In some embodiments, in response to receiving the notification corresponding to the first user (e.g., 608), in accordance with a determination that a first type of user (e.g., a guest, an identified user, a child, a parent, a friend, and/or a family member) is detected in the environment (e.g., 604), the computer system moves (and/or directs), via the movement component, the portion of the computer system (e.g., 600) toward a third area in the environment (e.g., described above with respect to FIG. 6A-6B). In some embodiments, in response to receiving the notification corresponding to the first user, in accordance with a determination that the first type of user is not detected in the environment (e.g., 604), the computer system moves (and/or directs), via the movement component, the portion of the computer system (e.g., 600) toward a fourth area, different from the third area, in the environment (e.g., without the third portion being directed to the third area). In some embodiments, in accordance with a determination that the first type of user is not detected in the environment, the computer system moves the portion of the computer system toward another area that is different from the third area. Moving the portion of the computer system toward a particular area based on the type of user to which the notification corresponds allows the computer system to limit (e.g., decrease and/or increase) the amount of people for which the portion of the computer system is more convenient, thereby reducing the number of inputs needed to perform an operation and providing additional control options without cluttering the user interface with additional displayed controls.

In some embodiments, moving the portion of the computer system (e.g., 600) to the second position includes translating (e.g., horizontally, vertically, inwardly, and/or outwardly moving, and/or a combination thereof), via the movement component, the portion of the computer system from a first lateral position to a second lateral position different from the first lateral position (e.g., described above with respect to FIG. 6A-6B). Laterally moving the portion of the computer system in response to receiving the notification corresponding to the first user allows the computer system to move to a position that is more convenient for a user, thereby reducing the number of inputs needed to perform an operation and providing additional control options without cluttering the user interface with additional displayed controls.

In some embodiments, moving the portion of the computer system (e.g., 600) to the second position includes tilting (e.g., 0-360 degrees), via the movement component, the portion of the computer system from a first tilt position to a second tilt position different from the first tilt position (e.g., described above with respect to FIG. 6A-6B). Tilting the portion of the computer system in response to receiving the notification corresponding to the first user allows the computer system to move to a position that is more convenient for a user, thereby reducing the number of inputs needed to perform an operation and providing additional control options without cluttering the user interface with additional displayed controls.

In some embodiments, moving the portion of the computer system (e.g., 600) to the second position includes rotating (e.g., 0-360 degrees), via the movement component, the portion of the computer system from a first rotational position to a second rotational position different from the first rotational position (e.g., described above with respect to FIG. 6A-6B). Rotating the portion of the computer system in response to receiving the notification corresponding to the first user allows the computer system to move to a position that is more convenient for a user, thereby reducing the number of inputs needed to perform an operation and providing additional control options without cluttering the user interface with additional displayed controls.

In some embodiments, while the computer system (e.g., 600) is at the second position in the environment (e.g., 604), the computer system receives a notification (e.g., an indication of a request to connect to a communication session (e.g., an incoming telephone call and/or an incoming video call) and/or content for a specific user) corresponding to a fourth user (e.g., described above with respect to FIG. 6A-6B). In some embodiments, in response to receiving the notification corresponding to the fourth user, in accordance with a determination that the fourth user is detected in the environment (e.g., 604), the computer system moves (e.g., rotates, tilts, moves to the right, moves to the left, moves up, moves down, and/or moves sideways, and/or a combination thereof), via the movement component (e.g., from the second position to another position) (e.g., the portion of the computer system) (e.g., described above with respect to FIG. 6A-6B). In some embodiments, in response to receiving the notification corresponding to the fourth user, in accordance with a determination that the fourth user is not detected in the environment (e.g., 604), the computer system forgoes moving, via the movement component (e.g., described above with respect to FIG. 6A-6B) (e.g., the portion of the computer system).

In some embodiments, while the computer system (e.g., 600) is at the second position in the environment (e.g., 604), the computer system receives a notification (e.g., an indication of a request to connect to a communication session (e.g., an incoming telephone call and/or an incoming video call) and/or content for a specific user) corresponding to a fifth user. In some embodiments, in response to receiving the notification corresponding to the fifth user, in accordance with a determination that the fifth user is detected in the environment (e.g., 604), the computer system moves (e.g., rotates, tilts, moves to the right, moves to the left, moves up, moves down, moves sideways, and/or a combination thereof), via the movement component, the portion of the computer system (e.g., 600) in a manner that is based on the location of the fifth user (e.g., described above with respect to FIG. 6A-6B). In some embodiments, in response to receiving the notification corresponding to the fifth user, in accordance with a determination that the fifth user is not detected in the environment (e.g., 604), the computer system moves (e.g., rotates, tilts, moves to the right, moves to the left, moves up, moves down, moves sideways, and/or a combination thereof), via the movement component, the portion of the computer system (e.g., 600) in a manner that is not based on the location of the fifth user (e.g., described above with respect to FIG. 6A-6B). In some embodiments, the manner that is not based on the location of the fifth user is a preset manner, such that the computer system performs a movement (e.g., a bow, an upward movement, a shake, and/or a spiral movement) of the portion of the computer system when the computer system receives a notification. In some embodiments, the manner that is not based on the location of the fifth user is a preset manner, such that the computer system performs a movement (e.g., a bow, an upward movement, a shake, and/or a spiral movement) of the portion of the computer system when the computer system receives a notification from a particular type of user and/or from a particular user. In some embodiments, the movement is different for different types of notifications.

In some embodiments, in response to receiving the notification corresponding to the fifth user, in accordance with a determination that the fifth user is detected in the environment (e.g., 604), the computer system moves, via the movement component, the portion of the computer system (e.g., 600) in the manner that is not based on the location of the fifth user (e.g., described above with respect to FIG. 6A-6B) (e.g., in conjunction with, after, and/or before moving, via the movement component, the portion of the computer system in a manner that is based on the location of the fifth user). In some embodiments, in accordance with a determination that the fifth user is detected in the environment, the computer system does not move, via the movement component, the portion of the computer system in the manner that is based on the location of the fifth user. Moving, via the movement component, the portion of the computer system in the manner that is not based on the location of the fifth user in accordance with a determination that the fifth user is detected in the environment allows the computer system to perform a preset motion to provide feedback that a notification is being received, thereby reducing the number of inputs needed to perform an operation and providing additional control options without cluttering the user interface with additional displayed controls.

FIGS. 8A-8H illustrate exemplary user interface for outputting a response to an input in accordance with some embodiments. The user interfaces in these figures are used to illustrate the processes described below, including the processes in FIGS. 9-12.

The left side of FIGS. 8A-8H illustrates computer system 800 (e.g., a tablet) displaying different user interfaces. It should be recognized that computer system 800 can be other types of computer systems such as a smart phone, a smart watch, a laptop, a communal device, a smart speaker, an accessory, a personal gaming system, a desktop computer, a fitness tracking device, and/or a head-mounted display (HMD) device. In some embodiments, computer system 800 includes and/or is in communication with one or more sensors (e.g., a camera, a LiDAR detector, a motion sensor, an infrared sensor, and/or a microphone). Such sensors are used to detect presence, attention, statements, requests, and/or instructions from a user in an environment. In some embodiments, computer system 800 includes and/or is in communication with one or more output devices (e.g., a display screen, a projector, a touch-sensitive display, speaker, and/or a movement component). Such output devices can be used to present information and/or cause different visual changes of computer system 800. In some embodiments, computer system 800 includes and/or is in communication with one or more movement components (e.g., an actuator, a moveable base, a rotatable component, and/or a rotatable base). Such movement components, as discussed above, can be used to change a position (e.g., location and/or orientation) of computer system 800 and/or a portion (e.g., including one or more sensors, input components, and/or output components) of computer system 800. In some embodiments, computer system 800 includes one or more components and/or features described above in relation to computer system 100 and/or device 200.

The right side of FIGS. 8A-8H include diagram 808. Diagram 808 is a visual aid representing a physical space and/or an environment that includes computer system 800. Diagram 808 includes computer system representation 810 (e.g., for computer system 800), user representation 812 (e.g., for a user, such as a person, a user, an animal, and/or an electronic device)), first object representation 814 (e.g., for a first object), second object representation 816 (e.g., for a second object), and third object representation 818 (e.g., for a third object). The positioning of computer system representation 810, user representation 812, first object representation 814, second object representation 816, and third object representation 818 within diagram 808 is representative of the real-world positioning of computer system 800 with respect to the user, the first object, the second object, and the third object. Diagram 808 includes dotted lines which represent the field of view of computer system representation 810. In some embodiments, the field of view of computer system representation 810 corresponds to the field of view of one or more front facing sensors of computer system 800 in the real-world. It should be recognized that, instead of a field of view, a field of detection can be used with techniques described herein. In this example, there are three objects in addition to the user. In some embodiments, there are more or less than three objects and/or more than one user.

FIGS. 8A-8H illustrate a process where computer system 800 helps the user complete a task based on a request from the user. In the example illustrated in FIGS. 8A-8H, the request and task correspond to making something to eat. The process described below begins with the user making a request and computer system 800 identifying objects in a physical environment that correspond to the request. After identifying the objects, computer system 800 outputs one or more indications of the objects and/or a suggested task based on the objects. In some embodiments, as part of the described process, computer system 800 outputs step-by-step instructions (e.g., a recipe) for the user to follow, including corrective steps for detected mistakes.

As illustrated in FIG. 8A, computer system 800 displays idle screen user interface 802. In some embodiments, computer system 800 displays idle screen user interface 802 when computer system 800 has not detected input by any user and/or has not output content as a result of an event for a predetermined amount of time. In other examples, computer system 800 displays idle screen user interface 802 when computer system 800 has received a request to do so. Idle screen user interface 802 can include one or more indicators and/or controls. In this example, idle screen user interface 802 includes time indicator 804, which displays the current real-world time, at a central location of idle screen user interface 802.

As indicated in diagram 808, the user corresponding to user representation 812 is within the field of view of computer system 800. At FIG. 8A, computer system 800 detects the user within the field of view and identifies the user. As illustrated in FIG. 8A, because computer system 800 identifies the user and detects the user within the field of view, computer system 800 displays user indicator 806 at the top center of idle screen user interface 802 (e.g., a default and/or predefined location for indications of users within the field of view). In this example, user indicator 806 includes the initials of the user (e.g., JA for Jake Allen). It should be recognized that user indicator 806 can include other and/or different content, such as an image of the user and/or an avatar (e.g., an image chosen by the user).

At FIG. 8A, computer system 800 detects first audio input 820 from the user. In this example, first audio input 820 is an implicit verbal request that corresponds to one or more objects (e.g., “What can I make?”) (e.g., not an explicit verbal request) (e.g., a verbal request that does not include an identifier of an object). In some embodiments, first audio input 820 is an explicit verbal request that corresponds to one or more objects (e.g., a verbal request that includes an identifier of an object). For example, the user can ask, “What can I make with chicken and broccoli?” In some embodiments, in conjunction with detecting first audio input 820, computer system 800 detects an air gesture from the user in a particular direction, so as to indicate where computer system 800 should look for objects that correspond to first audio input 820. In other examples, computer system 800 has an understanding of the environment and, without input corresponding to a direction, moves a portion of computer system 800 to locate one or more objects in the environment that correspond to first audio input 820.

As illustrated in FIG. 8B, in response to and/or after detecting first audio input 820, computer system 800 ceases displaying idle screen user interface 802 and displays identification user interface 822. In some embodiments, identification user interface 822 includes item list 826 in the middle of identification user interface 822 with a title (e.g., “Items”) corresponding to first audio input 820. In some embodiments, when initially displayed, identification user interface 822 does not include any items in item list 826 (e.g., as a result of no items being identified yet). In other examples, identification user interface 822 is not displayed until at least one object (e.g., corresponding to first audio input 820) is identified in the environment, as further discussed below.

At FIG. 8B, in response to detecting first audio input 820, computer system 800 scans, using the one or more sensors, the one or more input devices, and/or the one or more movement components, the environment for objects to generate a response to first audio input 820. For example, in response to detecting first audio input 820, computer system 800 can capture images of the environment and/or move the portion of computer system 800 to be at different positions while capturing images of the environment. In some embodiments, moving includes rotating, tilting, extending, and/or translating the portion of computer system 800.

In some embodiments, in response to detecting an air gesture from the user in a particular direction, computer system 800 moves the portion of computer system 800 in the particular direction until facing one or more objects. In some embodiments, computer system 800 moves the portion of computer system 800 to face a direction based on audio input from the user. For example, the verbal request can include locational information such as “What can I make from the items on the counter?”. In some embodiments, computer system 800 does not detect an input corresponding to a direction (e.g., an air gesture and/or a verbal input from the user), and, in response to detecting first audio input 820, moves the portion of computer system 800 based on an understanding computer system 800 has of the environment. For example, based on information from earlier interactions, computer system 800 understands where objects corresponding to the request are normally located and moves the portion of computer system 800 to face that location.

At FIG. 8B, as indicated in diagram 808, computer system 800 has rotated to an orientation where the first object, the second object, and the third object are within the field of view of computer system 800. Also indicated in diagram 808, the user is not within the field of view of computer system 800, causing computer system 800 to not detect the user within the field of view. As illustrated in FIG. 8B, in response not detecting the user within the field of view, computer system 800 ceases displaying user indicator 806.

At FIG. 8B, in conjunction with moving the portion of computer system 800, computer system 800 captures one or more images of the environment. In some embodiments, computer system 800 can capture multiple images in a single direction in case of changes in the environment over time. In some embodiments, after capturing one or more images, computer system 800 moves the portion of computer system 800 further (e.g., the same as or different from the amount discussed above) and captures one or more other images after moving further. For example, computer system 800 can move the portion of computer system 800 from an orientation facing the user to an orientation for capturing images of objects on the counter, then move the portion of computer system 800 from an orientation corresponding to the counter to an orientation for capturing images of objects on the shelf. In some embodiments, computer system 800 stops at different places for different amounts of time. For example, the shelf may contain more objects than the counter, causing computer system 800 to stop longer at the shelf than at the counter in order to capture the needed images. In some embodiments, computer system 800 stops at different places for the same amount of time. It should be recognized that computer system 800 can move the portion of computer system 800 more than two times and/or stop more than two times to capture images and/or output content.

At FIG. 8B, computer system 800 identifies the first object (e.g., broccoli), the second object (e.g., chicken), and the third object (e.g., lettuce) in the captured images and determines that first audio input 820 corresponds to the first object, the second object, and the third object. As illustrated in FIG. 8B, in response to the determination that first audio input 820 corresponds to the first object, the second object, and the third object, computer system 800 outputs an indication of the first object, an indication of the second object, and an indication of the third object. In this example, computer system 800 outputs the indications by displaying visual indications within item list 826. As illustrated in FIG. 8B, item list 826 includes a word identifier for each of the objects (e.g., “chicken,” “broccoli,” and “lettuce”). It should be recognized that other visual representations can be used for the objects, including another word identifier, an icon representing the object, and/or an image of the object captured by computer system 800. In some embodiments, computer system 800 outputs the indications by outputting an audio indication (e.g., an audio tone, a musical phrase, and/or reading a word identifier for the object). For example, computer system 800 can say the name of each object identified in the environment that corresponds to first audio input 820. In some embodiments, computer system 800 outputs indications by displaying one or more visual indications and outputting one or more audio indications.

In this example the first object (e.g., broccoli), the second object (e.g., chicken), and the third object (e.g., lettuce) are different types of objects. In some embodiments, the first object, the second object, and/or the third object are the same type of object. For example, the first object and the second object can both be bell peppers. In this example, because the first object, the second object, and the third object are different types of objects, computer system 800 displays separate visual indications for each object. In some embodiments, as a result of two objects being the same type of object, computer system 800 displays a single indication corresponding to both objects. For example, if there are three cans of tomatoes, computer system 800 can display a single indication for “canned tomatoes” or “canned tomatoes-3”. In some embodiments, computer system 800 displays an indication for each individual object, even if the objects are the same type of objects.

In some embodiments, computers system 800 does not output an indication of an object after moving the portion of computer system 800 a first amount and before moving the portion of computer system 800 a second amount. For example, computer system 800 can output the indications of all the objects after all objects have been identified and/or moving to face the user. In some embodiments, computer system 800 outputs an indication of an object after moving the portion of computer system 800 the first amount and before moving the portion of computer system 800 the second amount. For example, computer system 800 can output an indication of a first object before moving to capture the image of a second object. In some embodiments, after moving the second amount, computer system 800 outputs another indication of another object.

In some embodiments, computer system 800 continues to scan for items after displaying identification user interface 822 (as illustrated in FIG. 8B) without detecting input from the user. For example, computer system 800 can display an indication of one or more objects and then move the portion of computer system 800 to capture an image of another area without detecting input from the user. In some embodiments, computer system 800 identifies other objects and outputs the corresponding indications while displaying identification user interface 822. For example, computer system 800 can output the indications of objects as objects are identified. In some embodiments, in response to detecting an input that corresponds to a request to continue scanning, computer system 800 continues to scan for items after displaying an indication of one or more objects. For example, after displaying identification user interface 822 (as illustrated in FIG. 8B), computer system 800 can wait at an orientation for input from the user and/or change orientation back to the user, and if the input from the user corresponds to a request to continue scanning for objects, computer system 800 can continue scanning for objects.

At FIG. 8C, computer system 800 determines all objects have been identified. In some embodiments, computer system 800 determines that first audio input 820 does not correspond to one or more objects, causing computer system 800 to not output an indication corresponding to the one or more objects. For example, if the audio input was for help making a drink and computer system 800 identifies a bottle of juice, a lime, and a remote control, computer system 800 would not output an indication for the remote control in item list 826, because a remote control is usually not involved in making a drink. In some embodiments, an audio input corresponds to an object, but the object is not in the environment, causing computer system 800 to not output the indication that corresponds to that object. For example, if the user has tomatoes and the verbal request corresponds to tomatoes, but the tomatoes are in the garden where computer system 800 cannot detect them, computer system 800 will not output an indication for them.

At FIG. 8C, in response to the determination that all objects have been identified, computer system 800 moves the portion of computer system 800 to face the user (e.g., moves so the user is within the field of view). As indicated in diagram 808, computer system 800 has rotated causing the user to be within the field of view of computer system 800. At FIG. 8C, computer system 800 detects the user within the field of view. As illustrated in FIG. 8C, in response to detecting the user within the field of view, computer system 800 displays user indicator 806.

As illustrated in FIG. 8C, in response to the determination that all objects have been identified, computer system 800 outputs a first question corresponding to if computer system 800 missed something (e.g., “Did I miss anything?”). In this example, computer system 800 displays first question text 828 on the left side of identification user interface 822 while shrinking and moving item list 826 to the right. In some embodiments, computer system 800 acoustically outputs the first question (e.g., an audio tone, a musical phrase, and/or reading first question text) instead of and/or in addition to displaying first question text 828 with or without shrinking and moving item list 826. In some embodiments, computer system 800 can output an audio tone to alert the user that scanning for objects is complete.

At FIG. 8C, computer system 800 detects second audio input 830, which corresponds to the user responding to the first question. In this example, second audio input 830 is negative (e.g., “No”), indicating that computer system 800 has not failed to identify any objects. In some embodiments, second audio input 830 is positive (e.g., “yes”), indicating that computer system 800 failed to identify one or more objects, causing computer system 800 to prompt the user for what was missed and/or resume scanning for objects by repeating the process as described above. In some embodiments, if computer system 800 detects second audio input 830 corresponding to a response that computer system 800 failed to identify one or more objects, computer system 800 resumes scanning for objects in a direction based on a location included in second audio input 830. For example, the user can respond to the first question with “Yes, you missed some things on the table.” In some embodiments, after detecting second audio input 830 corresponding to a response that computer system 800 failed to identify one or more objects, computer system 800 detects an air gesture from the user in a direction towards one or more objects, so as to indicate where computer system 800 should look for the missed objects. In some embodiments, if second audio input 830 corresponds to a response that computer system 800 failed to identify one or more objects and computer system 800 does not detect an input corresponding to a location and/or direction (e.g., an air gesture and/or a verbal input from the user), computer system 800 moves the portion of computer system 800 to locate the missed objects based on an understanding computer system 800 has of the environment. In some embodiments, second audio input 830 includes one or more verbal identifications of the objects missed by computer system 800. For example, the user can respond to the first question with “Yes, you missed milk and eggs.”, verbally identifying the missed object to computer system 800. In some embodiments, in response to detecting second audio input 830 including verbal identifications of one or more objects, computer system 800 displays the indications of the verbally identified objects within item list 826.

As illustrated in FIG. 8D, in response to detecting second audio input 830, computer system 800 outputs a first answer to first audio input 820 based on one or more objects detected in the environment and/or verbally identified by the user. In this example, the first answer does not include an identification of any of the objects. In some embodiments, the first answer does include an identification of one or more of the objects. For example, the first answer can include wraps with chicken and lettuce, which identifies two of the objects. In some embodiments, the first answer is based on previous verbal input detected by computer system 800. For example, if the user often requests help making soup, the first answer can be based on these requests and include chicken soup. In this example, outputting the first answer includes displaying first answer text 832, which corresponds to a product or products that can be created using the object or objects identified. As illustrated in FIG. 8D, first answer text 832 includes information that a recipe is to follow. In some embodiments, outputting the first answer includes outputting an audio indication (e.g., an audio tone, a musical phrase, and/or reading first answer text 832). In some embodiments, outputting the first answer includes displaying an image and/or representation of the one or more products included in the first answer.

In some embodiments, after outputting the first answer, computer system 800 detects an audio input from the user that corresponds to the user asking computer system 800 for a different answer, causing computer system 800 to output a second answer. For example, the user can say, “I am not in the mood for a salad,” and computer system 800 can reply by outputting, “You can make stir fry. Here is a recipe to follow.” The steps output by computer system 800 following the output of the second answer correspond to the second answer instead of the first answer.

At FIG. 8E, the user has moved the first object (e.g., broccoli) and the second object (e.g., chicken) to be within the field of view of computer system 800. As indicated in diagram 808, the first object and the second object are within the field of view of computer system 800. At FIG. 8D, computer system 800 detects the first object and the third object within the field of view. In some embodiments, the user moves next to the first object and computer system 800 physically moves the portion of computer system 800 to keep the user within the field of view.

As illustrated in FIG. 8E, in response to detecting the user and the first object within the field of view, computer system 800 ceases displaying identification user interface 822 and displays recipe user interface 834 (e.g., as seen in FIG. 8F). In some embodiments, computer system 800 ceases displaying identification user interface 822 and displays recipe user interface 834 at a predetermined time after displaying first answer text 832.

As illustrated in FIG. 8E, in response to detecting the user and the first object within the field of view, computer system 800 outputs a first step which corresponds to the first answer. In some embodiments, computer system 800 outputs the first step at a predetermined time after displaying first answer text 832. In this example, computer system 800 outputs the first step by displaying first step text 836 within recipe user interface 834. In some embodiments, outputting the first step includes outputting an audio indication (e.g., an audio tone, a musical phrase, and/or reading the text of first step text 836). In some embodiments, outputting the first step includes outputting multiple indications of different types. In some embodiments, the type of indication output is based on the type of action being taken by the user. For example, if the action for the step requires the user to keep their eyes focused on the action, the type of indication can be audio. In some embodiments, outputting the first step includes displaying a visual representation (e.g., a video, a GIF, an animation, and/or a set of images) of the action required to complete the step.

In some embodiments, computer system 800 moves the portion of computer system 800 as the user moves in the physical environment to stay within view of and/or near the user. For example, as the user moves from the cutting board to the frying pan, computer system 800 can move the portion of computer system 800 to keep the user within the field of view and/or maintain a viewable distance and/or angle of the user and/or the task being performed. In some embodiments, computer system 800 displays a set of steps required to complete the task. For example, computer system 800 can display a list of steps required to complete the task adjacent to the currently displayed step. In this example, computer system 800 does not display the list of steps required to complete the task. In some embodiments, computer system 800 displays a count of steps required to complete the task.

At FIG. 8F, computer system 800 detects the user performing one or more actions that correspond to the first step (e.g., chopping the broccoli). As illustrated in FIG. 8F, in response to detecting the user performing the one or more actions that correspond to the first step, computer system 800 outputs an indication corresponding to the user performing the one or more actions without input directed to computer system 800. In this example, computer system 800 displays second step text 838 which corresponds to informing the user what the upcoming step (e.g., the second step) in the task will be. As illustrated in FIG. 8F, computer system 800 displays second step text 838 on the right side of recipe user interface 834. Also illustrated in FIG. 8F, in response to displaying second step text 838, computer system 800 shrinks and moves first step text 836 to the left side of recipe user interface 834. As indicated by the text in first step text 836 and the text in second step text 838, the steps required to complete the task include different types of actions.

In some embodiments, computer system 800 pauses tracking (e.g., tracking via one or more sensors) of the user (e.g., the user and/or the user's movements and/or actions) when the user is not detected and continues tracking when the user is detected again. In some embodiments, computer system 800 pauses output of content when detecting user is no longer performing a step of the process and continues outputting content when detecting user is performing a step of the process. For example, if computer system 800 detects the user has stopped chopping broccoli to get a glass of water, computer system 800 can pause outputting content until the user continues chopping and/or approaches the broccoli.

At FIG. 8G, computer system 800 detects an issue with an action or set of actions performed by the user (e.g., user skips a step, a step is taking longer than expected, and/or user is performing a step incorrectly). In this example, computer system 800 detects the user is not chopping the broccoli into small enough pieces.

As illustrated in FIG. 8G, in response to detecting an issue with an action or set of actions performed by the user, computer system 800 outputs an indication based on the issue. For example, computer system 800 can display third step text 840. For another example, computer system 800 can output an audio indication (e.g., an audio tone, a musical phrase, and/or reading the text of third step text 840). For another example, computer system 800 displays a visual representation (e.g., a video, a GIF, an animation, and/or a set of images) of the action required to correct the issue. As illustrated in FIG. 8G, third step text 840 includes a recommendation to correct performance of the first step (e.g., “The broccoli should be chopped in smaller pieces”). As illustrated in FIG. 8G, in response to detecting an issue with an action or set of actions performed the user, computer system 800 ceases displaying first step text 836 and second step text 838, so not to confuse the user by displaying multiple actions.

In some embodiments, in response to detecting an issue, computer system 800 outputs a recommendation to perform an action again. For example, if the user rolled cookie dough too thin, computer system 800 can output an indication to the dough into a ball and roll it out flat again. In some embodiments, in response to detecting an issue, computer system 800 outputs a recommendation to perform a previous step. For example, if the user added salt instead of sugar to butter, computer system 800 can output the previous step corresponding to the butter before or without repeating the step corresponding to the sugar. In some embodiments, in response to detecting an error, computer system 800 displays a new step that was not in the original set of steps (e.g., a corrective step). For example, if chocolate that the user is heating seizes, computer system 800 can output content including a recommendation to add hot milk, a step that was not in the original set of steps.

At FIG. 8H, computer system 800 detects that the instructions displayed in third step text 840 were completed by the user (e.g., the error was corrected). In some embodiments, computer system 800 detects that the error was not corrected, causing computer system 800 to continue to display third step text 840 until the error is corrected. For example, if the user cuts the lettuce instead of chopping the broccoli, computer system 800 can continue to display third step text 840 until the user chops the broccoli into the correct size pieces.

As illustrated in FIG. 8H, in response to detecting that the instructions displayed in third step text 840 were completed by the user, computer system 800 ceases displaying third step text 840 and outputs the next step (e.g., the second step) (e.g., cook the chicken) of the task which corresponds to the first answer. In this example, outputting the second step of the task includes displaying fourth step text 842. In some embodiments, outputting the second step of the task includes outputting an audio indication (e.g., an audio tone, a musical phrase, and/or reading the text of fourth step text 842). In some embodiments, in response to detecting that the instructions displayed in the third step text 840 were completed by the user, computer system 800 moves the portion of computer system 800 in a particular way (e.g., nods, bows, tilts, wiggles, and/or shakes).

In some embodiments, computer system 800 detects that the user has finished the second step of the task and outputs an indication that corresponds to the third step of the task. For example, in response to detecting the user has cooked the chicken, computer system 800 can display a fifth text that includes instructions to slice the chicken. In some embodiments, the user has completed all the steps required to complete the task, causing computer system 800 to display a different user interface. For example, in response to detecting the user has completed all the steps required to complete the task, computer system 800 can display a completion user interface that includes a congratulatory text and animation.

The examples illustrated above are in a kitchen setting with computer system 800 and the user interfaces being used to identify objects and create a recipe from those objects, as well was take a user through the steps of completing the recipe. In some embodiments, the setting is dressing table and the objects are clothes and jewelry. For example, the user can ask, “What should I wear to my cousin's wedding?”, and computer system 800 can output an answer (e.g., suggest an outfit) based on objects identified. In some embodiments, the setting can be general, and the objects can be gifts and wrapping paper with computer system 800 providing instructions for wrapping the presents. In some embodiments, the setting is an at home classroom with computer system 800 providing physics experiments using household items.

FIG. 9 is a flow diagram illustrating a method for outputting an indication of an object using a computer system in accordance with some embodiments. Process 900 is performed at a computer system (e.g., 100, 200, and/or 800). Some operations in process 900 are, optionally, combined, the orders of some operations are, optionally, changed, and some operations are, optionally, omitted.

As described below, process 900 provides an intuitive way for outputting an indication of an object. The method reduces the cognitive burden on a user for interacting with a computer system, thereby creating a more efficient human-machine interface. For battery operated computing devices, enabling a user to interact with a computer system faster and more efficiently conserves power and increases the time between battery charges.

In some embodiments, process 900 is performed at a computer system (e.g., 800) that is in communication with one or more output devices (e.g., a display screen, a projector, a touch-sensitive display, a speaker, a movement component (e.g., an actuator, a movable base, a rotatable component, and/or a rotatable base), and/or a haptic output device) and/or a microphone. In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more input devices (e.g., a camera, a depth sensor, a microphone, a hardware input mechanism, a rotatable input mechanism, a heart monitor, a temperature sensor, and/or a touch-sensitive surface). In some embodiments, the computer system is in communication with a movable component (e.g., an actuator (e.g., a pneumatic actuator, hydraulic actuator and/or an electric actuator), a movable base, a rotatable component, and/or a rotatable base).

The computer system detects (902), via the microphone, a verbal request (e.g., 820) corresponding to a request to identify one or more objects (e.g., 814, 816, and/or 818) present in a physical environment (e.g., 808). In some embodiments, the verbal request includes an implicit indication to identify one or more objects present in a physical environment. In some embodiments, the verbal request includes an explicit indication to identify one or more objects present in a physical environment. In some embodiments, a verbal request corresponding to a request to identify one or more objects present in a virtual environment (e.g., an AR environment and/or a VR environment) is detected in lieu of and/or in addition to detecting the verbal request corresponding to a request to identify one or more objects present in the physical environment.

In response to (904) detecting the verbal request (e.g., 820), in accordance with a determination that a first object (e.g., 814, 816, and/or 818) (e.g., sports equipment, food, furniture, dishes, workout equipment, stationary, buildings, and/or vehicles) is present in the physical environment (e.g., 808) and that the verbal request corresponds to the first object, the computer system outputs (906) (e.g., display, provide audio, play back media, and/or issue haptic output), via the one or more output devices, a first indication (e.g., 826) of the first object (e.g., as described above in FIGS. 8B-8D) (e.g., a name, visual representation, text, and/or symbol) (e.g., which is different from outputting a live photo and/or previously captured image of the first object). In some embodiments, in accordance with a determination that the first object is not present in the physical environment and the verbal request corresponds to the first object, the computer system does not output the first indication of the first object. In some embodiments, in accordance with a determination that the first object is present in the physical environment and the verbal request does not correspond to the first object, the computer system does not output the first indication of the first object. In some embodiments, the computer system moves to determine that the first object is present in the physical environment and/or before outputting the first indication of the first object.

In response to (904) detecting the verbal request, in accordance with a determination that a second object (e.g., 814, 816, and/or 818) is present in the physical environment (e.g., 808) and that the verbal request corresponds to the second object, the computer system outputs (908), via the one or more output devices, a second indication (e.g., 826) of the second object (e.g., a name, visual representation, text, and/or symbol) (e.g., which is different from outputting a live photo and/or previously captured image of the second object), wherein the second indication is different from the first indication (e.g., 826) (e.g., as described above in FIGS. 8B-8D). In some embodiments, the computer system detects that the object is present in the physical environment. In some embodiments, as a part of detecting that the object is present in the physical environment, the computer system captures one or more images of the physical environment, where the one or more images are processed to detect whether or not one or more objects are detected in the physical environment. In some embodiments, as a part of detecting that the object is present in the physical environment, the computer system captures sensor data (e.g., audio data, thermal data, motion data), where the sensor data is processed to detect whether or not one or more objects are detected in the physical environment. In some embodiments, in accordance with a determination that the second object is not present in the physical environment and the verbal request corresponds to the second object, the computer system does not output the second indication of the second object. In some embodiments, in accordance with a determination that the second object is present in the physical environment and the verbal request does not correspond to the second object, the computer system does not output the second indication of the second object. In some embodiments, the computer system moves to determine that the second object is present in the physical environment and/or before outputting the second indication of the second object. Outputting an indication of an object in response to detecting a verbal request corresponding to a request to identify one or more objects present in a physical environment provides the user with a control option to identify objects that are present in the environment, thereby providing additional control options without cluttering the user interface with additional displayed controls. Choosing whether to output an indication of an object based on prescribed conditions allows the computer system to intelligently provide feedback to the user concerning objects that are present in the environment, thereby providing additional control options without cluttering the user interface with additional displayed controls and performing an operation when a set of conditions has been met without requiring further user input.

In some embodiments, in response to detecting the verbal request (e.g., 820), in accordance with a determination that the first object and the second object are present in the physical environment (e.g., 808) and that the verbal request (e.g., 820) corresponds to the first object and the second object, the computer system outputs, via the one or more output devices, the first indication (e.g., 826) of the first object (e.g., 814, 816, and/or 818) and the second indication (e.g., 826) of the second object (e.g., 814, 816, and/or 818). In some embodiments, the computer system outputs the first indication before outputting the second indication, or vice-versa. In some embodiments, the computer system concurrently outputs the first indication and the second indication. Outputting multiple indications of multiple objects in response to detecting a verbal request corresponding to a request to identify one or more objects present in a physical environment provides the user with a control option to identify multiple objects that are present in the environment, thereby providing additional control options without cluttering the user interface with additional displayed controls. Choosing whether to output multiple indications of multiple objects based on prescribed conditions allows the computer system to intelligently provide feedback to the user concerning objects that are present in the environment, thereby providing additional control options without cluttering the user interface with additional displayed controls and performing an operation when a set of conditions has been met without requiring further user input.

In some embodiments, in response to detecting the verbal request (e.g., 820), in accordance with a determination that the verbal request (e.g., 820) does not correspond to the first object (e.g., 814, 816, and/or 818), the computer system forgoes outputting, via the one or more output devices, the first indication (e.g., 826) of the first object (even if the first object is present in the environment) (e.g., “please identify cooking objects” and the computer system ignores or does not output an indication of a baby's crib in the environment; or “please identify furniture” and the computer system ignores or does not output an indication of a person in the environment). In some embodiments, in response to detecting the verbal request and in accordance with a determination that the verbal request does not correspond to the second object, the computer system does not output the second indication of the second object. Not outputting an indication of an object based on prescribed conditions with respect to the verbal request allows the computer system to provide more accurate feedback to the user concerning objects that are present in the environment according to the verbal request, thereby providing additional control options without cluttering the user interface with additional displayed controls and performing an operation when a set of conditions has been met without requiring further user input.

In some embodiments, in response to detecting the verbal request (e.g., 820), in accordance with a determination that the first object is not in the physical environment (e.g., 808) (and/or verbal request does not correspond to the first object), the computer system forgoes outputting, via the one or more output devices, the first indication (e.g., 826) of the first object (e.g., 814, 816, and/or 818). In some embodiments, in response to detecting the verbal request and in accordance with a determination that the second object is not in the physical environment, the computer system does not output the second indication of the second object. Not outputting an indication of an object based on prescribed conditions with respect to the object allows the computer system to provide more accurate feedback to the user concerning objects that are present in the environment according to the object, thereby providing additional control options without cluttering the user interface with additional displayed controls and performing an operation when a set of conditions has been met without requiring further user input.

In some embodiments, in response to detecting the verbal request (e.g., 820), in accordance with a determination that the second object (e.g., 814, 816, and/or 818) is in the physical environment (e.g., 808) and that the verbal request does not correspond to the second object (e.g., 814, 816, and/or 818), the computer system forgoes outputting, via the one or more output devices, the second indication (e.g., 826) of the second object. In some embodiments, in response to detecting the verbal request and in accordance with a determination that the first object is in the physical environment and that the verbal request does not correspond to the first object, the computer system does not output, via the one or more output devices, the first indication of the first object. Not outputting an indication of an object based on prescribed conditions with respect to the verbal request when the object is present in the environment allows the computer system to provide more accurate feedback to the user concerning objects that are present in the environment according to the verbal request even if the object is present in the environment, thereby providing additional control options without cluttering the user interface with additional displayed controls and performing an operation when a set of conditions has been met without requiring further user input.

In some embodiments, the verbal request (e.g., 820) (e.g., an explicit verbal request to find the object) includes a first identifier (e.g., 826) (e.g., a name, a location, a characteristic, and/or a symbol) corresponding to a first respective object (e.g., 814, 816, and/or 818) (e.g., the first object and/or the second object). Outputting an indication of an object in response to detecting a verbal request with an identifier of a particular object provides the user with a control option to identify particular objects that are present in the environment, thereby providing additional control options without cluttering the user interface with additional displayed controls.

In some embodiments, the verbal request (e.g., 820) (e.g., an implicit verbal request to find the object) does not include a second identifier (e.g., 826) (e.g., a name, a location, a characteristic, and/or a symbol) corresponding to a second respective object (e.g., 814, 816, and/or 818) (e.g., the first object and/or the second object). In some embodiments, the verbal request is an implicit request (e.g., “I would like to cook tonight” and the computer system identifies food). Outputting an indication of an object in response to detecting a verbal request that does not include an identifier of a particular object provides the user with a control option to identify objects that are present in the environment without specifying the object and/or requesting specifically to identify the object, thereby providing additional control options without cluttering the user interface with additional displayed controls.

In some embodiments, after detecting the verbal request (e.g., 820), the computer system outputs, via the one or more output devices, a request (e.g., 824 and/or 832) (and/or a question and/or a statement) corresponding to identifying objects (e.g., 814, 816, and/or 818) (e.g., the one or more objects and/or the one or more other objects) (e.g., “did I miss something,” “did I identify the objects correctly,” and/or “should I add any objects”) (e.g., a request to confirm the one or more objects). Outputting the request corresponding to identifying objects after detecting the verbal request allows the computer system to automatically ask the user with feedback and/or provide additional input, thereby performing an operation when a set of conditions has been met without requiring further user input.

In some embodiments, the second object (e.g., 814, 816, and/or 818) is the same type of object (e.g., cleaning materials, utensils, food, dishware, electronics, and/or baby items) as the first object (e.g., 814, 816, and/or 818). In some embodiments, the verbal request is to identify a particular type of object.

In some embodiments, the second object (e.g., 814, 816, and/or 818) is a different type of object (e.g., cleaning materials, utensils, food, dishware, electronics, and/or baby items) than the first object (e.g., 814, 816, and/or 818).

In some embodiments, the computer system (e.g., 800) is in communication with a first movement component (e.g., an actuator (e.g., a pneumatic actuator, hydraulic actuator and/or an electric actuator), a movable base, a rotatable component, and/or a rotatable base). In some embodiments, in response to detecting the verbal request (e.g., 820), the computer system moves, via the first movement component, a portion (e.g., a display, a center of the display, a camera, and/or a physical hardware component, such as a button and/or a rotatable input device) of the computer system (e.g., 800) (e.g., from a first position to a second position different from the first position, from being in a first orientation to being in a second orientation different from the second orientation, and/or from moving and/or rotating in a first direction to moving and/or rotating in a second direction different from the first direction) (e.g., as described above at FIGS. 8A-8D). Moving the portion of the computer system in response to detecting the verbal request allows the computer system to scan the environment, thereby performing an operation when a set of conditions has been met without requiring further user input and optimizing output of the computer system.

In some embodiments, after moving, via the first movement component, the portion of the computer system (e.g., 800), the computer system outputs, via the one or more output devices, a third indication (e.g., 826) (e.g., as described above in relation to the first indication and/or the second indication) of a third object (e.g., 814, 816, and/or 818) (e.g., the first object, the second object, and/or another object). In some embodiments, the third indication is the same as the first indication or the second indication. In some embodiments, the third indication is different from the first indication and the second indication. In some embodiments, the computer system is not moving while outputting an indication of an object. Outputting the third indication of the third object after moving the portion of the computer system in response to detecting the verbal request allows the computer system to scan the environment, thereby performing an operation when a set of conditions has been met without requiring further user input and optimizing output of the computer system.

In some embodiments, after outputting the first indication (e.g., 826) of the third object (e.g., 814, 816, and/or 818), the computer system moves, via the first movement component (e.g., an actuator (e.g., a pneumatic actuator, hydraulic actuator and/or an electric actuator), a movable base, a rotatable component, and/or a rotatable base), the portion of the computer system (e.g., 800) (e.g., as described above at FIGS. 8A-8D). In some embodiments, after moving, via the first movement component, the portion of the computer system (e.g., 800), the computer system outputs, via the one or more output devices, a fourth indication (e.g., 826) (e.g., as described above in relation to the first indication and/or the second indication) of a fourth object (e.g., 814, 816, and/or 818) (e.g., the first object, the second object, and/or another object), different from the third object, wherein the fourth indication is different from the third indication (e.g., 826) (e.g., as described above at FIGS. 8B-8D). In some embodiments, the fourth indication is the same as the first indication or the second indication. In some embodiments, the fourth indication is the different from the first indication and the second indication. Outputting the fourth indication of the fourth object after outputting the first indication of the third object in response to detecting the verbal request allows the computer system to scan the environment and output indications for multiple users, thereby performing an operation when a set of conditions has been met without requiring further user input and optimizing output of the computer system.

In some embodiments, the computer system (e.g., 800) is in communication with a second movement component and one or more input devices (e.g., a camera, a smart watch, fitness tracking device, and/or a wearable device). In some embodiments, in conjunction with (e.g., after (e.g., immediately after), while, and/or before (e.g., immediately before)) detecting the verbal request (e.g., 820), the computer system detects, via the one or more input devices, an input (e.g., a verbal input (e.g., a verbal input, an audible request, an audible command, and/or an audible statement) and/or a non-verbal input (e.g., a swipe input, a hold-and-drag input, a gaze input, an air gesture, and/or a mouse click)). In some embodiments, in response to detecting the input, the computer system moves (e.g., rotating, tilting, and/or moving laterally), via the second movement component, in a detected direction (e.g., left, right, up, and/or down) of the input (e.g., as described above at FIGS. 8A-8D).

In some embodiments, the input is an air gesture (e.g., a pointing air gesture, a direction air gesture, a swiping air gesture, and/or a sweeping air gesture) (e.g., as described above at FIGS. 8A-8D).

In some embodiments, the first indication (e.g., 826) and the second indication (e.g., 826) are output. In some embodiments, the first indication and the second indication are concurrently output.

In some embodiments, in response to detecting the verbal request (e.g., 820), in accordance with a determination that a plurality of objects (e.g., 814, 816, and/or 818) is present in the physical environment (e.g., 808) and that the verbal request (e.g., 820) corresponds to the plurality of objects, the computer system outputs, via the one or more output devices, an indication (e.g., 826) of the plurality of objects. In some embodiments, in accordance with a determination that a plurality of objects is present in the physical environment and the verbal request corresponds to the plurality of objects, the first indication and the second indication are output. In some embodiments, in accordance with a determination that a plurality of objects is present in the physical environment and the verbal request corresponds to the plurality of objects, the first indication and the second indication are not output.

In some embodiments, the verbal request (e.g., 820) corresponds to a particular type of object (e.g., sports equipment, food, furniture, dishes, workout equipment, stationary, buildings, and/or vehicles). In some embodiments, in response to detecting the verbal request (e.g., 820), the computer system outputs, via the one or more output devices, an indication (e.g., 826) of the particular type of object. Outputting an indication of a type of object in response to detecting a verbal request corresponding to a request to identify one or more types of objects present in a physical environment provides the user with a control option to identify objects that are present in the environment, thereby providing additional control options without cluttering the user interface with additional displayed controls. Choosing whether to output an indication of a type of object based on prescribed conditions allows the computer system to intelligently provide feedback to the user concerning objects that are present in the environment, thereby providing additional control options without cluttering the user interface with additional displayed controls and performing an operation when a set of conditions has been met without requiring further user input.

In some embodiments, the computer system (e.g., 800) is in communication with a speaker (and/or an audio generation component). In some embodiments, outputting, via the one or more output devices, the first indication (e.g., 826) of the first object (e.g., 814, 816, and/or 818) (e.g., in accordance with a determination that the first object is present in the physical environment and the verbal request corresponds to the first object) includes providing, via the speaker, audio that includes the first indication (e.g., 826) of the first object (e.g., as described above at FIGS. 8B-8D). In some embodiments, outputting, via the one or more output devices, the second indication (e.g., 826) of the second object (e.g., 814, 816, and/or 818) (e.g., in accordance with a determination that a second object is present in the physical environment and the verbal request corresponds to the second object) includes providing, via the speaker, audio that includes the second indication (e.g., 826) of the second object (e.g., 814, 816, and/or 818) (e.g., as described above at FIGS. 8B-8D). Outputting an audio indication of an object in response to detecting a verbal request corresponding to a request to identify one or more objects present in a physical environment provides the user with a control option to output an audio indication of objects that are present in the environment, thereby providing additional control options without cluttering the user interface with additional displayed controls. Choosing whether to output an audio indication of an object based on prescribed conditions allows the computer system to intelligently provide audio feedback to the user concerning objects that are present in the environment, thereby providing additional control options without cluttering the user interface with additional displayed controls, providing improved feedback, and performing an operation when a set of conditions has been met without requiring further user input.

In some embodiments, the computer system (e.g., 800) is in communication with a displaying generation component (e.g., a display screen, a projector, and/or a touch-sensitive display). In some embodiments, outputting, via the one or more output devices, the first indication (e.g., 826) of the first object (e.g., 814, 816, and/or 818) (e.g., in accordance with a determination that the first object is present in the physical environment and the verbal request corresponds to the first object) includes displaying, via the displaying generation component, a representation (e.g., text, one or more symbols, one or more images, and/or one or more user interface elements) of the first indication (e.g., 826) of the first object. In some embodiments, outputting, via the one or more output devices, the second indication (e.g., 826) of the second object (e.g., 814, 816, and/or 818) (e.g., in accordance with a determination that a second object is present in the physical environment and the verbal request corresponds to the second object) includes displaying, via the display component, a representation (e.g., text, one or more symbols, one or more images, and/or one or more user interface elements) of the second indication (e.g., 826) of the second object. Displaying an indication of an object in response to detecting a verbal request corresponding to a request to identify one or more objects present in a physical environment provides the user with a control option to display an indication of objects that are present in the environment, thereby providing additional control options without cluttering the user interface with additional displayed controls. Choosing whether to display an indication of an object based on prescribed conditions allows the computer system to intelligently provide visual feedback to the user concerning objects that are present in the environment, thereby providing additional control options without cluttering the user interface with additional displayed controls, providing improved feedback, and performing an operation when a set of conditions has been met without requiring further user input.

In some embodiments, the computer system is a first computer system that includes and/or is communication with a movement component (e.g., as described above). In some embodiments, the verbal request is a request that the first computer system access data from the second computer system. In some embodiments, in response to detecting the input corresponding to the verbal request, the computer system moves, via the movement component, the portion of the first computer system towards the second computer system (e.g., as described below with respect to process 1400). In some embodiments, the data includes an identification of the one or more objects.

Note that details of the processes described above with respect to process 900 (e.g., FIG. 9) are also applicable in an analogous manner to the methods described below/above. For example, process 1000 optionally includes one or more of the characteristics of the various methods described above with reference to process 900. For example, the computer system can use one or more techniques of process 900 to output a particular response in accordance with detecting a user in an environment using one or more techniques of process 1000. For brevity, these details are not repeated below.

FIG. 10 is a flow diagram illustrating a method for outputting a response after moving a portion of the computer system using a computer system in accordance with some embodiments. Process 1000 is performed at a computer system (e.g., 100, 200, and/or 800). Some operations in process 1000 are, optionally, combined, the orders of some operations are, optionally, changed, and some operations are, optionally, omitted.

As described below, process 1000 provides an intuitive way for outputting a response after moving a portion of the computer system. The method reduces the cognitive burden on a user for outputting a response after moving a portion of the computer system, thereby creating a more efficient human-machine interface. For battery operated computing devices, enabling a user to output a response after moving a portion of the computer system faster and more efficiently conserves power and increases the time between battery charges.

In some embodiments, process 1000 is performed at a computer system (e.g., 800) that is in communication with one or more output devices (e.g., a display screen, a projector, a touch-sensitive display, a speaker, and/or a haptic output device), a microphone, and a movement component (e.g., an actuator, a movable base, a rotatable component, and/or a rotatable base). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more input devices (e.g., a camera, a depth sensor, a microphone, a hardware input mechanism, a rotatable input mechanism, a heart monitor, a temperature sensor, and/or a touch-sensitive surface). In some embodiments, the computer system is in communication with a movable component (e.g., an actuator (e.g., a pneumatic actuator, hydraulic actuator and/or an electric actuator), a movable base, a rotatable component, and/or a rotatable base).

While a portion (e.g., a housing and/or an enclosure including a display component and/or the one or more input devices) of the computer system (e.g., 800) is in a first orientation (and/or a first location), the computer system detects (1002), via the microphone, an input (e.g., 820) corresponding to a verbal request (e.g., as described above in relation to process 900). In some embodiments, the verbal request corresponds to a question related to objects in a physical environment. In some embodiments, the verbal request does not include an indication of a specific object but instead is a request that the computer system identify objects in a physical environment. In some embodiments, the verbal request is directed to a personal assistant executing at least partially on the computer system. In some embodiments, the verbal request includes an identification of the personal assistant.

In response to detecting the input (e.g., 820) corresponding to the verbal request, the computer system physically moves (1004) (e.g., causes to physically move, rotates, pushes, and/or pulls), via the movement component, the portion (e.g., as described above in relation to process 900) of the computer system (e.g., 800) from the first orientation to a second orientation different from the first orientation (e.g., as described above at FIGS. 8A-8D). In some embodiments, the portion is physically moved to an orientation in which the computer system detects one or more objects. In some embodiments, an object of the one or more objects relate to the verbal request. In some embodiments, an object of the one or more objects does not relate to the verbal request. In some embodiments, physically moving the portion is part of the computer system scanning a physical environment for one or more objects related to the verbal request.

After (1006) physically moving the portion to the second orientation (e.g., while the portion of the computer system is in (and/or facing) the first orientation and/or at the first location), in accordance with a determination that a first user (e.g., 812) (e.g., person, subject, animal, and/or object) is detected in a first image of a physical environment (e.g., 808) (e.g., in the field of view of one or more cameras), the computer system outputs (1008), via the one or more output devices, a first response (e.g., 824, 826, and/or 832) to the verbal request (e.g., as described above at FIGS. 8A-8D). In some embodiments, after and/or while physically moving the portion to the second orientation, the computer system captures, via a camera in communication with the computer system, the first image. In some embodiments, the first response includes an indication of the first object. In some embodiments, the first response does not include an indication of the first object. In some embodiments, the first response is based on the first object.

After (1006) physically moving the portion to the second orientation, in accordance with a determination that a second user (e.g., 812) is detected in a second image (e.g., the first image or another image different from the first image) of the physical environment (e.g., 808) (e.g., without detecting the first object in the second image), the computer system outputs (1010), via the one or more output devices, a second response (e.g., 824, 826, and/or 832) to the verbal request, wherein the second user is different from the first user, and wherein the second response is different from the first response (e.g., as described above at FIGS. 8A-8D). In some embodiments, the second response includes an indication of the second user. In some embodiments, the second response does not include an indication of the second user. In some embodiments, the second response is based on the second user. In some embodiments, the first response does not include an indication of the second user. In some embodiments, the second response does not include an indication of the first user. In some embodiments, the first response is not based on the second user. In some embodiments, the second response is not based on the first user. In some embodiments, the computer system outputs the first response in accordance with a determination that the second user is not detected in the first image of the physical environment. Outputting a response to a verbal request based on whether a particular user is detected in the environment allows the computer system to intelligently respond to the verbal request without additional user input concerning the user, thereby providing additional control options without cluttering the user interface with additional displayed controls, providing improved visual feedback to the user, and performing an operation when a set of conditions has been met without requiring further user input.

In some embodiments, the first response (e.g., 824, 826, and/or 832) does not include a first identification (e.g., 806) (e.g., as described above in relation to process 900 in relation to the first indication and/or the second indication) of the first user (e.g., 812). In some embodiments, the second response does not include an identification of the second user. Outputting a response that does not include an identification of a user to a verbal request based on whether a particular user is detected in the environment allows the computer system to intelligently respond to the verbal request without additional user input concerning the user, thereby providing additional control options without cluttering the user interface with additional displayed controls, providing improved visual feedback to the user, and performing an operation when a set of conditions has been met without requiring further user input.

In some embodiments, the first response is generated based on a first verbal input (e.g., as described above in relation to process 900) that was previously detected by the computer system (e.g., 800) (e.g., the verbal input and/or a different verbal input than the verbal input). In some embodiments, the second response is generated based on a second verbal input that was previously detected by the computer system. In some embodiments, the first verbal input is different from the second verbal input. Outputting a response that is generated based on a previous verbal request as a response to a verbal request based on whether a particular user is detected in the environment allows the computer system to intelligently respond to the verbal request within the context of a interaction (e.g., an interaction and/or conversation including multiple verbal requests), thereby providing additional control options without cluttering the user interface with additional displayed controls, providing improved visual feedback to the user, and performing an operation when a set of conditions has been met without requiring further user input.

In some embodiments, moving (e.g., as described above in relation to process 900), via the movement component, the portion of the computer system (e.g., 800) from the first orientation to the second orientation includes: shifting (e.g., rotating, traversing, moving laterally, and/or translating), via the movement component, the portion of the computer system (e.g., 800) a first amount (e.g., as described above at FIGS. 8A-8D); after shifting the first amount, ceasing shifting, via the movement component, the portion of the computer system (e.g., 800) (e.g., for a non-zero period of time, such as a predefined and/or determined period of time) (e.g., without intervening user input); and, in some embodiments, the computer system performs one or more operations while not shifting via the movement component, such as outputting content. after ceasing shifting, shifting, via the movement component, the portion of the computer system (e.g., 800) a second amount (e.g., as described above at FIGS. 8A-8D) (e.g., without intervening user input). In some embodiments, the second amount is different from the first amount. In some embodiments, the second amount is the same as the first amount. In some embodiments, after moving and/or shifting, via the movement component, the second amount, the computer system ceases shifting the portion of the computer system (e.g., again). Physically shifting the portion of the computer system, pausing movement, and continuing shifting the portion of the computer system allows the computer system to face multiple users based on a request, thereby providing improved visual feedback to the user, reducing the number of inputs needed to perform an operation, and performing an operation when a set of conditions has been met without requiring further user input.

In some embodiments, the first amount is different from the second amount. Physically shifting the portion of the computer system by an amount, pausing movement, and continuing shifting the portion of the computer system by a different amount allows the computer system to face multiple users that are in different areas of the environment based on a request, thereby providing improved visual feedback to the user, reducing the number of inputs needed to perform an operation, and performing an operation when a set of conditions has been met without requiring further user input.

In some embodiments, after shifting the second amount, the computer system ceases shifting, via the movement component, the portion of the computer system (e.g., 800), wherein the computer system is at a first position and not a second position while the computer system ceases shifting after moving the first amount for a first amount of time, and wherein the computer system is at the second position and not the first position while the computer system ceases shifting after moving the second amount for a second amount of time different from the first amount of time (e.g., as described above at FIGS. 8A-8D). In some embodiments, the first amount of time is longer than or shorter than the second amount of time. In some embodiments, the first amount of time is not the same as the second amount of time. In some embodiments, a measurement of the first amount of time does not get measured concurrently with a measurement of the first amount of time. Pausing movement by different amount of times as the computer system shifts allows the computer system to face multiple users that are in different areas of the environment based on a request and pause movement for different individuals for different amount of times, thereby providing improved visual feedback to the user, reducing the number of inputs needed to perform an operation, and performing an operation when a set of conditions has been met without requiring further user input.

In some embodiments, after shifting the first amount and before shifting the second amount, the computer system forgoes outputting, via the one or more output devices (e.g., one or more speakers and/or audio generation components), an audible response (and/or, in some embodiments, a visual response to the verbal request) to the verbal request (e.g., any response and/or any audio output).

In some embodiments, after shifting the first amount and before shifting the second amount, in accordance with a determination that the first user is detected in the first image (e.g., and/or at a first time of capture) of the physical environment (e.g., 808), the computer system outputs, via the one or more output devices, a second identification (e.g., 806) (e.g., as described above in relation to process 900) of the first user (e.g., 812). In some embodiments, after shifting the first amount and before shifting the second amount, in accordance with a determination that the second user is detected in the second image (e.g., and/or at a second time of capture) of the physical environment (e.g., 808), the computer system outputs, via the one or more output devices, a first identification (e.g., 806) (e.g., as described above in relation to process 900) of the second user (e.g., 812). Outputting an indication of a particular user after shifting the first amount and before shifting the second amount allows the computer system to provide an indication to one or more users that the portion of the computer system is facing the particular user, thereby providing improved visual feedback to the user, reducing the number of inputs needed to perform an operation, and performing an operation when a set of conditions has been met without requiring further user input.

In some embodiments, the one or more output devices include one or more speakers. In some embodiments, outputting, via the one or more output devices, the second identification (e.g., 806) of the first user (e.g., 812) includes providing, via the one or more speakers, the second identification (e.g., 806) of the first user (e.g., the second identification of the first user is an audible identification). In some embodiments, outputting, via the one or more output devices, the first identification (e.g., 806) of the second user (e.g., 812) includes providing, via the one or more speakers, the first identification of the second user is output via the one or more speakers (e.g., the first identification of the second user is an audible identification). Providing the indication of a particular user via one or more speakers after shifting the first amount and before shifting the second amount allows the computer system to provide an audible indication to one or more users that the portion of the computer system is facing a particular user, thereby providing improved visual feedback to the user, reducing the number of inputs needed to perform an operation, and performing an operation when a set of conditions has been met without requiring further user input.

In some embodiments, the one or more output devices include a display component. In some embodiments, outputting, via the one or more output devices, the second identification (e.g., 806) of the first user (e.g., 812) includes displaying, via the display component, the second identification of the first user. In some embodiments, outputting, via the one or more output devices, the first identification (e.g., 806) of the second user includes displaying, via the display component, the first identification of the second user (e.g., 812). Displaying the indication of a particular user after shifting the first amount and before shifting the second amount allows the computer system to provide an audible indication to one or more users that the portion of the computer system is facing a particular user, thereby providing improved visual feedback to the user, reducing the number of inputs needed to perform an operation, and performing an operation when a set of conditions has been met without requiring further user input.

In some embodiments, in accordance with a determination that a first plurality of users (e.g., 812, 814, 816, and/or 818) is detected in an environment (e.g., 808) in conjunction with (e.g., while and/or after) physically moving the portion of the computer system (e.g., 800) from the first orientation to the second orientation, the first response includes a first set of subject matter. In some embodiments, in accordance with a determination that a second plurality of users (e.g., 812, 814, 816, and/or 818) is detected in the environment (e.g., 808) in conjunction with (e.g., while and/or after) physically moving the portion of the computer system (e.g., 800) from the first orientation to the second orientation, the first response includes a second set of subject matter, different from the first set of subject matter (e.g., as described above at FIGS. 8A-8D). In some embodiments, in accordance with a determination that a third plurality of users is detected in an environment in conjunction with (e.g., while and/or after) physically moving the portion of the computer system from the first orientation to the second orientation, the second response includes a third set of subject matter. In some embodiments, in accordance with a determination that a fourth plurality of users, different from the third plurality of users, is detected in the environment in conjunction with (e.g., while and/or after) physically moving the portion of the computer system from the first orientation to the second orientation, the second response includes a fourth set of subject matter, different from the third and/or first set of subject matter.

In some embodiments, the computer system (e.g., 800) is in communication with a camera. In some embodiments, after physically moving the portion to the second orientation, the computer system captures, via the camera, an image (e.g., without detecting a request to capture the image) (and, in some embodiments, after capturing the image, the computer system displays a representation (e.g., a user interface element and/or an object) of the image and/or a representation of the image is stored and can be accessed by a user). Capturing, via the camera, an image after physically moving the portion to the second orientation allows the computer system to automatically capture an image without additional input from a user, thereby providing additional control options without cluttering the user interface with additional displayed controls.

In some embodiments, after physically moving the portion to the second orientation, in accordance with a determination that the first user (e.g., 812) is detected in the first image of the physical environment (e.g., 808) (e.g., in the field of view of one or more cameras), the computer system changes, via the one or more output devices, a portion (e.g., face, eyes, mouth, nose, ears, and/or mouth) of a system avatar from a first state (e.g., an appearance, a state of a positioning and/or representation of the features and/or expression of an avatar at a particular point in time) to a second state, different from the first state. In some embodiments, after physically moving the portion to the second orientation, in accordance with a determination that the second user (e.g., 812) is detected in the second image of the physical environment (e.g., 808) (e.g., in the field of view of one or more cameras), the computer system changes, via the one or more output devices, the portion of a system avatar from the first state to a third state, different from the first state and the second state. In some embodiments, the appearance of the system avatar changes based on the content that is displayed. Changing a portion of the system avatar based on the user detected in the environment allows the computer system to customize the appearance of the system avatar to one that is likely to be preferential for the user, thereby providing improved visual feedback to the user, reducing the number of inputs needed to perform an operation, and performing an operation when a set of conditions has been met without requiring further user input.

In some embodiments, the computer system is a first computer system that includes and/or is communication with a movement component (e.g., as described above). In some embodiments, the verbal request is a request that the first computer system access data from the second computer system. In some embodiments, in response to detecting the input corresponding to the verbal request, the computer system moves, via the movement component, the portion of the first computer system towards the second computer system (e.g., as described below with respect to process 1400).

Note that details of the processes described above with respect to process 1000 (e.g., FIG. 10) are also applicable in an analogous manner to the methods described below/above. For example, process 1100 optionally includes one or more of the characteristics of the various methods described above with reference to process 1000. For example, the computer system can use one or more techniques of process 1000 to display an indication of a step in response to detecting an action performed by a user using one or more techniques of process 1100. For brevity, these details are not repeated below.

FIG. 11 is a flow diagram illustrating a method for displaying an indication of a step using a computer system in accordance with some embodiments. Process 1100 is performed at a computer system (e.g., 100, 200, and/or 800). Some operations in process 1100 are, optionally, combined, the orders of some operations are, optionally, changed, and some operations are, optionally, omitted.

As described below, process 1100 provides an intuitive way for displaying an indication of a step. The method reduces the cognitive burden on a user for displaying an indication of a step, thereby creating a more efficient human-machine interface. For battery operated computing devices, enabling a user to display an indication of a step faster and more efficiently conserves power and increases the time between battery charges.

In some embodiments, process 1100 is performed at a computer system (e.g., 800) that is in communication with one or more input devices (e.g., a camera, a depth sensor, and/or a microphone) and one or more output devices (e.g., a display screen, a projector, a touch-sensitive display, a speaker, and/or a haptic output device). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more input devices (e.g., a camera, a depth sensor, a microphone, a hardware input mechanism, a rotatable input mechanism, a heart monitor, a temperature sensor, and/or a touch-sensitive surface). In some embodiments, the computer system is in communication with a movable component (e.g., an actuator (e.g., a pneumatic actuator, hydraulic actuator and/or an electric actuator), a movable base, a rotatable component, and/or a rotatable base).

The computer system detects (1102), via the one or more input devices, a request (e.g., 820 and/or 830) to perform a process (e.g., a series of steps, an ordered series of steps, and/or a predefined process) including a plurality of steps. In some embodiments, detecting the request includes detecting, via the one or more input devices, an input corresponding to a verbal request. In some embodiments, the verbal request corresponds to a request to initiate the process. In some embodiments, the verbal request does not include an indication of a specific process but instead is a request to accomplish a goal that is determined to correspond to the process. In some embodiments, the verbal request is directed to a personal assistant executing at least partially on the computer system. In some embodiments, the verbal request includes an identification of the personal assistant.

After (and/or in response to) detecting the request (e.g., 820 and/or 830) to perform the process, the computer system outputs (1104) (e.g., displays, auditorily outputs, and/or haptically outputs), via the one or more output devices, an indication of a first step (e.g., 832, 836, 840, and/or 842) (e.g., an initial step and/or a step after the initial step) of the plurality of steps. In some embodiments, the indication of the first step includes a representation (e.g., a visual representation) of the first step. In some embodiments, the indication of the first step is output in accordance with a determination that a user is at a location corresponding to the first step. In some embodiments, the indication of the first step is output in accordance with a determination that a previous step has been performed, is within a threshold of being performed, and/or is currently being performed.

After (and/or while) outputting the indication of the first step (e.g., 832, 836, 840, and/or 842), the computer system detects (1106), via the one or more input devices, an action performed by a user (e.g., 812) (e.g., as described above at FIGS. 8E-8H) (e.g., a person, a user, and/or a machine in a physical environment). In some embodiments, detecting the action includes detecting a current state of the user. In some embodiments, detecting the action includes monitoring the user.

In response to detecting the action performed by the user (e.g., 812) and without detecting an input directed to the one or more input devices (and/or the computer system), the computer system displays (1108), via the one or more output devices, an indication of a second step (e.g., 832, 836, 840, and/or 842) of the plurality of steps, wherein the second step is different from the first step (e.g., 832, 836, 840, and/or 842), and wherein the indication of the second step is different from the indication of the first step. In some embodiments, the second step is after the first step in the plurality of steps. In some embodiments, in response to detecting the action performed by the user and without detecting an input directed to the one or more input devices, the computer system displays, via the one or more output devices, the indication of the second step without outputting the indication of the first step. In some embodiments, in response to detecting the action performed by the user and without detecting an input directed to the one or more input devices, the computer system displays, via the one or more output devices, the indication of the second step while outputting the indication of the first step. In some embodiments, in response to detecting the action performed by the user and without detecting an input directed to the one or more input devices, the computer system outputs, via the one or more output devices, the indication of the second step. In some embodiments, in response to detecting the action performed by the user and without detecting an input directed to the one or more input devices, the computer system outputs, via the one or more output devices, a second indication of the second step, where the second indication is different from the indication of the second step. After detecting a request to perform a process including a plurality of steps, outputting an indication of a first step of the plurality of steps enables a computer system to notify a user of information needed to complete a requested process, thereby providing improved visual feedback to the user and/or providing additional control options (e.g., notifications, instructions, and/or alerts) without cluttering the user interface with additional displayed controls. In response to detecting the action performed by the user and without detecting an input directed to the one or more input devices, displaying the indication of the second step allows the computer system to automatically update based on actions by the user without requiring inputs directed to the computer system, thereby reducing the number of inputs needed to perform an operation, providing additional control options without cluttering the user interface with additional displayed controls, and/or performing an operation when a set of conditions has been met without requiring further user input.

In some embodiments, after displaying the indication of the second step (e.g., 832, 836, 840, and/or 842) of the plurality of steps and in accordance with a determination that the second step has been completed or will be completed within a threshold (e.g., a threshold number of actions and/or a threshold amount of time), the computer system outputs, via the one or more output devices, an indication (e.g., video, images, text, graphics, and/or animation) of a third step (e.g., 832, 836, 840, and/or 842) of the plurality of steps, wherein the third step is different from the second step and the first step, and wherein the indication of the third step is different from the indication of the first step (e.g., 832, 836, 840, and/or 842) and the indication of the second step (e.g., as described above at FIGS. 8E-8H). In some embodiments, after and/or while displaying the indication of the second step of the plurality of steps, the computer system detects, via the one or more input devices, a particular action corresponding to the second step of the plurality of steps performed by one or more users (e.g., the user and/or another user different from the user). In some embodiments, while detecting the particular action corresponding to the second step of the plurality of steps and in accordance with a determination that the second action includes a first set of one or more characteristics (e.g., completion of a task and/or the second step by a user, a status of an item (e.g., ingredients, foods, and/or drinks) before, after, and/or while the second action (e.g., heating, mixing, beating, stirring, pouring, boiling, broiling, cooking, frying, baking, cooling and/or assembling) is performed by the one or more users), the computer system outputs, via the one or more output devices, the indication of the third step. In some embodiments, while the particular action is performed and in accordance with a determination that the second action does not include the first set of one or more characteristics, the computer system forgoes outputting, via the one or more output devices, the indication of the third step. After displaying the indication of the second step of the plurality of steps and in accordance with a determination that the second step has been completed or will be completed within a threshold, outputting an indication of a third step of the plurality of steps enables a computer system to provide a user with timely information corresponding to the next step of a requested process, thereby providing improved visual feedback to the user and/or providing additional control options (e.g., notifications, instructions, and/or alerts) without cluttering the user interface with additional displayed controls.

In some embodiments, after (and/or while) displaying the indication of the second step (e.g., 832, 836, 840, and/or 842) of the plurality of steps, the computer system detects, via the one or more input devices, an issue (e.g., an error and/or an action performed by the user) with (and/or with respect to, associated with, corresponding to, and/or related to) the second step of the plurality of steps. In some embodiments, in response to (and/or while) detecting the issue, the computer system outputs, via the one or more output devices, additional content (e.g., corrective measures and/or updated directions) corresponding to (e.g., related to and/or associated with) the second step (e.g., 840) (e.g., as described above at FIG. 8H). In some embodiments, while detecting one or more actions performed by the user and in accordance with a determination that the one or more actions do not correspond to an action, the computer system forgoes outputting, via the one or more output devices, the additional content corresponding to the second step. Detecting an issue with the second step of the plurality of steps and outputting additional content corresponding to the second step enables a computer system to provide the user with corrective measures when an error is detected, thereby providing improved visual feedback to the user and/or providing additional control options (e.g., notifications, instructions, and/or alerts) without cluttering the user interface with additional displayed controls.

In some embodiments, outputting the indication of the first step (e.g., 832, 836, 840, and/or 842) of the plurality of steps includes displaying, via the one or more output devices, the indication of the first step of the plurality of steps. Displaying the indication of the first step of the plurality of steps enables a computer system to display information needed to complete a requested process, thereby providing improved visual feedback to the user and/or providing additional control options (e.g., notifications, instructions, and/or alerts) without cluttering the user interface with additional displayed controls.

In some embodiments, in conjunction with (e.g., before, after, and/or while) displaying the indication of the second step (e.g., 832, 836, 840, and/or 842) of the plurality of steps, the computer system auditorily output via the one or more output devices, an indication (e.g., an audio (e.g., verbal instructions in a selected language) output corresponding to) of the second step of the plurality of steps. Displaying the indication of the second step of the plurality of steps and auditorily outputting an indication of the second step of the plurality of steps enables a computer system to provide a user with timely information corresponding to the next step of a requested process in multiple different channels (e.g., in case one or more channels are not accessible by the user), thereby providing improved feedback to the user and/or providing additional control options (e.g., notifications, instructions, and/or alerts) without cluttering the user interface with additional displayed controls.

In some embodiments, the one or more input devices includes one or more cameras. In some embodiments, the request (e.g., 820 and/or 830) (e.g., an air gesture, a user movement, and/or a user action) is detected via the one or more cameras (e.g., via one or more images captured via the one or more cameras). The request is detected via the one or more cameras enables a computer system to receive the request in a variety of manners for the process so that the computer system can provide relevant content related to the requested process, thereby providing improved feedback to the user and/or providing additional control options (e.g., notifications, instructions, and/or alerts) without cluttering the user interface with additional displayed controls.

In some embodiments, the one or more input devices includes one or more microphones. In some embodiments, the request (e.g., 820 and/or 830) (e.g., a verbal request) is detected via the one or more microphones (e.g., via one or more audio recordings captured via the one or more microphones). The request is detected via the one or more microphones enables a computer system to receive the request in a variety of manners for the process so that the computer system can provide relevant content related to the requested process, thereby providing improved visual feedback to the user and/or providing additional control options (e.g., notifications, instructions, and/or alerts) without cluttering the user interface with additional displayed controls.

In some embodiments, the process (e.g., the first step, the second step, another step different from the first step and/or the second step, and/or the plurality of steps) is defined (e.g., explicitly included) in the request (e.g., 820 and/or 830) to perform the process. In some embodiments, the first step of the plurality of steps and the second step of the plurality of steps is defined in the request to perform the process. In some embodiments, each of the steps of the plurality of steps is defined in the request to perform the process. In some embodiments, the request to perform the process includes and/or is a verbal input. In some embodiments, the request to perform the process includes and/or is an air gesture. In some embodiments, the request to perform the process includes and/or is a written and/or typed request. The process being defined in the request to perform the process enables a computer system to receive requests that explicitly recite the process or some steps of the process for the user and provide relevant content related to the requested process to the user, thereby providing improved visual feedback to the user and/or providing additional control options (e.g., notifications, instructions, and/or alerts) without cluttering the user interface with additional displayed controls.

In some embodiments, the process (e.g., the first step, the second step, another step different from the first step and/or the second step, and/or the plurality of steps) is not defined (e.g., explicitly included) in the request (e.g., 820 and/or 830) to perform the process (e.g., the request described above at FIGS. 8A and 8D does define the process). In some embodiments, one or more but not all of the steps of the plurality of steps is defined in the request to perform the process. In some embodiments, the request to perform the process includes and/or is a verbal input. In some embodiments, the request to perform the process includes and/or is an air gesture. In some embodiments, the request to perform the process includes and/or is a written and/or typed request. The process not being defined in the request to perform the process enables a computer system to receive requests that do not explicitly recite the process or some steps of the process for the user and still provide relevant content related to the requested process to the user, thereby providing improved visual feedback to the user and/or providing additional control options (e.g., notifications, instructions, and/or alerts) without cluttering the user interface with additional displayed controls.

In some embodiments, after displaying the indication of the second step (e.g., 832, 836, 840, and/or 842) of the plurality of steps and in accordance with a determination that the process has been completed or will be completed within a threshold (e.g., a threshold number of actions and/or a threshold amount of time), the computer system displays (and/or outputs), via the one or more output devices, a new user interface (e.g., a user interface element, a graphical user interface and/or a graphical user interface element) (e.g., an indication of completion (e.g., video, images, text, graphics, and/or animation) of the process). In some embodiments, after displaying the indication of the second step of the plurality of steps and in accordance with a determination that the process has not been completed or will not be completed within a threshold, the computer system forgoes displaying (and/or outputting), via the one or more output devices, the new user interface. After displaying the indication of the second step of the plurality of steps and in accordance with a determination that the process has been completed or will be completed within a threshold, displaying a new user interface enables a computer system to notify a user when a requested process is completed, thereby providing improved visual feedback to the user and/or providing additional control options (e.g., notifications, instructions, and/or alerts) without cluttering the user interface with additional displayed controls.

In some embodiments, while outputting, via the one or more output devices, content corresponding to a respective step (e.g., 832, 836, 840, and/or 842) (e.g., the first step and/or the second step) of the plurality of steps, the computer system detects, via the one or more input devices, that the user (e.g., 812) is no longer performing the respective step (e.g., 832, 836, 840, and/or 842) (e.g., no longer performing an action corresponding to the respective step) (e.g., for a predetermined period of time). In some embodiments, in response to detecting that the user (e.g., 812) is no longer performing the respective step (e.g., 832, 836, 840, and/or 842), the computer system pauses (e.g., ceases, forgoes updating, and/or displays a pause indication) outputting the content corresponding to the respective step. In response to detecting that the user is no longer performing the respective step, pausing outputting the content corresponding to the respective step enables a computer system to intelligently output content corresponding to the process and/or notify the user that the computer system no longer detects the user performing a respective step, thereby providing improved visual feedback to the user and/or allowing the computer system to avoid burn-in of the display component.

In some embodiments, after pausing outputting the content corresponding to the respective step (e.g., 832, 836, 840, and/or 842), the computer system detects, via the one or more input devices, an action corresponding to the respective step being performed by the user (e.g., 812) (e.g., for a predetermined period of time). In some embodiments, in response to detecting the action corresponding to the respective step (e.g., 832, 836, 840, and/or 842) being performed by the user (e.g., 812) (e.g., for a predetermined period of time), the computer system outputs, via the one or more output devices, the content corresponding to the respective step. In response to detecting the action corresponding to the respective step being performed by the user, outputting the content corresponding to the respective step enables a computer system to re-output relevant content to the user after detecting the action corresponding to the respective step being performed again, thereby providing improved visual feedback to the user and/or providing additional control options (e.g., notifications, instructions, and/or alerts) without cluttering the user interface with additional displayed controls.

In some embodiments, after (and/or while) displaying the indication of the second step (e.g., 832, 836, 840, and/or 842) of the plurality of steps, the computer system detects, via the one or more input devices, a first respective action performed by the user (e.g., 812). In some embodiments, in response to detecting the first respective action, in accordance with a determination that the first respective action completed the second step (e.g., 832, 836, 840, and/or 842), the computer system outputs, via the one or more output devices, an indication corresponding to a fourth step (e.g., 832, 836, 840, and/or 842) different from the second step (and/or the first step). In some embodiments, in response to detecting the first respective action, in accordance with a determination that the first respective action did not complete the second step (e.g., 832, 836, 840, and/or 842), the computer system forgoes outputting, via the one or more output devices, the indication corresponding to the fourth step (e.g., 832, 836, 840, and/or 842). In response to detecting a first respective action performed by the user and in accordance with a determination that the first respective action completed the second step, outputting an indication corresponding to a fourth step different from the second step enables a computer system to provide relevant content based on a user's progress in the completion of steps included in the process, thereby providing improved visual feedback to the user and/or providing additional control options (e.g., notifications, instructions, and/or alerts) without cluttering the user interface with additional displayed controls.

In some embodiments, in response to detecting the first respective action and in accordance with a determination that the respective action corresponds to a fifth step (e.g., 832, 836, 840, and/or 842) different from the second step (e.g., 832, 836, 840, and/or 842), the computer system forgoes outputting, via the one or more output devices, the indication corresponding to the fourth step (e.g., 832, 836, 840, and/or 842). In response to detecting the first respective action and in accordance with a determination that the respective action corresponds to a fifth step different from the second step, forgoing outputting the indication corresponding to the fourth step enables a computer system to provide relevant content based on a user's progress in the completion of steps included in the process, thereby providing improved visual feedback to the user and/or providing additional control options (e.g., notifications, instructions, and/or alerts) without cluttering the user interface with additional displayed controls.

In some embodiments, in response to detecting the first respective action and in accordance with a determination that the respective action is destructive to a previous step (e.g., 832, 836, 840, and/or 842) (e.g., the first step and/or another step different from the first step) of the plurality of steps, the computer system outputs, via the one or more output devices, an indication (e.g., video, images, text, graphics, and/or animation) of the previous step (e.g., 832, 836, 840, and/or 842). In response to detecting the first respective action and in accordance with a determination that the respective action is destructive to a previous step of the plurality of steps, outputting an indication of the previous step enables a computer system to provide the user with corrective measures when an error is detected without requiring the user to navigate through a user interface to find the previous step, thereby providing improved visual feedback to the user and/or providing additional control options (e.g., notifications, instructions, and/or alerts) without cluttering the user interface with additional displayed controls.

In some embodiments, the computer system is a first computer system that includes and/or is communication with a movement component (e.g., as described above). In some embodiments, the request to perform the process includes the user moving a second computer system, different from the first computer system, toward the first computer system and/or requesting that the first computer system access data from the second computer system. In some embodiments, in response to detecting the request to perform the process, the computer system moves, via the movement component, a portion (e.g., a housing and/or an enclosure including a display component and/or the one or more input devices) of the first computer system towards the second computer system (e.g., as described below with respect to process 1400).

Note that details of the processes described above with respect to process 1100 (e.g., FIG. 11) are also applicable in an analogous manner to the methods described below/above. For example, process 1200 optionally includes one or more of the characteristics of the various methods described above with reference to process 1100. For example, the computer system can use one or more techniques of process 1200 to output an error corresponding to a step being performed, where an indication of the step was displayed using one or more techniques of process 1100. For brevity, these details are not repeated below.

FIG. 12 is a flow diagram illustrating a method for outputting an indication of an error using a computer system in accordance with some embodiments. Process 1200 is performed at a computer system (e.g., 100, 200, and/or 800). Some operations in process 1200 are, optionally, combined, the orders of some operations are, optionally, changed, and some operations are, optionally, omitted.

As described below, process 1200 provides an intuitive way for outputting an indication of an error. The method reduces the cognitive burden on a user for outputting an indication of an error, thereby creating a more efficient human-machine interface. For battery operated computing devices, enabling a user to interact with a computer system faster and more efficiently conserves power and increases the time between battery charges.

In some embodiments, process 1200 is performed at a computer system that is in communication with one or more sensors (e.g., a camera (e.g., a telephoto camera, a wide-angle camera, and/or an ultra-wide-angle camera), a microphone, a heart rate sensor, and/or an accelerometer) and one or more output devices (e.g., a display component, an audio generation component, a speaker, a haptic output device, a display screen, a projector, and/or a touch-sensitive display).

The computer system detects (1202), via the one or more sensors, that a user (e.g., a person and/or an animal) is performing a first set of one or more actions (e.g., one or more movements, gestures, inputs, and/or verbal communications) to complete a task (e.g., in the field-of-view of the camera).

While detecting that the user is performing the first set of one or more actions to complete the task, the computer system detects (1204) a performance (e.g., determines, grades, judges and/or calculates by comparing the detected first set of one or more actions to complete the task to a model of the first set one or more actions to complete the task) of a first action by the user.

In response to (1206) detecting the performance of the first action by the user, in accordance with a determination that the performance of the first action satisfies a set of one or more criteria (and/or a predetermined difference between the model) with respect to a respective action (and/or respective actions) in the first set of one or more actions to complete the task, the computer system outputs (1208) (e.g., displays, provides, and/or issues), via the one or more output devices, an indication (e.g., text, symbol, sound, characters, haptic outputs, and/or vibrations) that an error occurred with respect to the respective action being performed (e.g., the action was not performed properly, the action was not performed at all, and/or the action was not performed in the right order and/or at the right time).

In response to (1206) detecting the performance of the first action by the, in accordance with a determination that the performance of the first action does not satisfy the set of one or more criteria (and/or a predetermined difference between the pre-stored model) with respect to the respective action (and/or respective actions) in the first set of one or more actions to complete the task, the computer system forgoes (1210) outputting, via the one or more output devices, the indication that the error occurred with respect to the respective action being performed. In some embodiments, in accordance with a determination that the performance of the first action does not satisfy the first set of one or more criteria with respect to the respective action in the first set of one or more actions to complete the task, the computer system outputs an indication that the action can be and/or should be performed again. Outputting or not outputting an indication that an error occurred with respect to the respective action being performed based on prescribed conditions being met enables the computer system to intelligently provide notifications of mistakes made by a user in performing certain activities, thereby providing improved feedback to the user and/or performing an operation when a set of conditions has been met without requiring further user input.

In some embodiments, the first set of one or more actions to complete the task includes a second action to complete the task and a third action to complete the task, different from the second action to complete the task. In some embodiments, the third action to complete the task is a first type of action and the second action to complete the task is a second type of action different from the first type of action. In some embodiments, the first action to complete the task includes use of a first type of tool, machine, and/or device, while the second action to complete the task includes use of a second type of tool, machine, and/or device different from the first type of tool, machine, and/or device. In some embodiments, the first action to complete the task includes performing the first action to complete the ask within a first period of time while performing the second action to complete the task within a second period of time different than the first period of time. In some embodiments, the first action to complete the task includes being performed in a first type of environment while performing, the second action to complete the task includes being performed in a second type of environment different from the first type of environment. In some embodiments, the first action to complete the task includes a first number of people, users, and/or machines, while the second action to complete the task includes a second number different from the first number of people, users, and/or machines. Having the first set of one or more actions to complete the task include a second action that is a first type of action and a third action that is a second type of action enables the computer system to intelligently provide notifications of mistakes made by the user while performing a variety of different types of activities, thereby providing improved feedback to the user and/or performing an operation when a set of conditions has been met without requiring further user input.

In some embodiments, the one or more sensors includes a camera (e.g., a telephone, a wide-angle camera, an ultra-wide-angle camera, and/or a periscope camera). In some embodiments, detecting the performance of the first action by the includes capturing, via the camera, the first action by the user (e.g., in a field of view of the camera and/or in a field of detection of another type of sensor). In some embodiments, the user performing the first set of one or more actions to complete the task is captured via the multiple cameras. Detecting the performance of the first action by the user includes capturing the performance via the camera enables the computer system to intelligently provide notifications of mistakes made by a user based on images of activities being performed, thereby providing improved feedback to the user and/or performing an operation when a set of conditions has been met without requiring further user input.

In some embodiments, the one or more sensors includes a microphone. In some embodiments, detecting the performance of the first action by the includes capturing, via the microphone, audio input (e.g., from the user, from a computer system corresponding to the user, and/or from a different user corresponding to the user). In some embodiments, the user performing the first set of one or more actions to complete the task is captured via multiple microphones and/or multiple devices. In some embodiments, the first action is detected via a microphone, a camera, a gyroscope, an accelerometer, and/or a heart rate sensor. Detecting the performance of the first action by the user includes capturing audio input via a microphone enables the computer system to intelligently provide notifications of mistakes made by the user by capturing audio of activities being performed, thereby providing improved feedback to the user and/or performing an operation when a set of conditions has been met without requiring further user input.

In some embodiments, outputting the that the error occurred with respect to the respective action being performed includes outputting a first recommendation (e.g., text, one or more symbols, one or more sounds, one or more haptic outputs, one or more colors, one or more user interface objects, and/or one or more characters) to re-perform (e.g., perform correctly, to do an action over, repeat, and/or redo) the respective action. In some embodiments, the first recommendation to re-perform the respective actions includes images and/or audio that depicts (e.g., points out, explains, illustrates, and/or displays) the error that occurred with the respect to the respective action being performed. In some embodiments, recommendation to re-perform the respective action remains outputted until the user performs the respective action correctly. Outputting the indication that the error occurred with respect to the respective action being performed includes outputting a first recommendation to re-perform the respective action enables the computer system to intelligently provide notifications of mistakes made by the user during an activity and to also provide instructions to redo a specific portion of the activity to the user, thereby providing improved feedback to the user and/or performing an operation when a set of conditions has been met without requiring further user input.

In some embodiments, outputting that the error occurred with respect to the respective action being performed includes outputting a second recommendation (e.g., an alert and/or warning) to correct a performance of the respective action (e.g., change, modify and/or or adjust the performance of the action) (e.g., to correct the performance of the first action). In some embodiments, the second recommendation to correct the performance of the respective action includes the speed at which respective task is performed, the amount of ingredients used in respective task, the amount of time used to respective task, device and/or tool used in the respective task. In some embodiments, the second recommendation to correct the respective actions includes images and/or audio. In some embodiments, the second recommendation to correct a performance of the respective action is outputted while the respective action is performed. Outputting the indication that the error occurred with respect to the respective action being performed includes outputting a second recommendation to correct a performance of the respective action enables the computer system to intelligently provide notifications of mistakes made by the user while performing an activity and to also provided instructions on how to correct the mistakes, thereby providing improved feedback to the user and/or performing an operation when a set of conditions has been met without requiring further user input.

In some embodiments, outputting the that the error occurred with respect to the respective action being performed includes outputting a third recommendation to resolve (e.g., an adjustment to the respective action such as extending or decreasing the amount of time the respective is performed, fixing the performance of the first operation, and/or changing other parameters at which the respective action is performed) the error with respect to the respective action. In some embodiments, the third recommendation to resolve the error with respect to the respective action is output while the respective action is performed. In some embodiments, the recommendation to resolve the error with respect to the respective action describes how the error should be resolved. In some embodiments, one or more of the first recommendation, the second recommendation, and/or the third recommendation are concurrently displayed with each other. Outputting the indication that the error occurred with respect to the respective action being performed includes outputting a third recommendation to resolve the error with respect to the respective action enables the computer system to intelligently provide notifications of mistakes made by the user while performing an activity and to also provide notifications on how to correct the mistakes made during the activity, thereby providing improved feedback to the user and/or performing an operation when a set of conditions has been met without requiring further user input.

In some embodiments, the performance of the first action by the user is a first performance of the first action by the user. In some embodiments, while outputting (e.g., displaying, outputting audio, and/or providing a haptic (and/or vibration) output) an indication that the error occurred with respect to the respective action being performed, the computer system detects that the user is performing a second set of one or more actions to complete the task. In some embodiments, while detecting that the user is performing the second set of one or more actions to complete the task, the computer system detects a second performance of a third action by the user different from the first performance of the first action by the user. In some embodiments, the third action is the same as the first action. In some embodiments, the third action is different from the first action. In some embodiments, the third action is a corrective action and/or an action to fix another action that was performed (e.g., an action to fix and/or resolve the first performance of the first action) and the first action is not a corrective action. In some embodiments, in response to detecting the second performance of the third action by the user, in accordance with a determination that the second performance satisfies the set of one or more criteria with respect to the respective action in the first set of one or more actions to complete the task, the computer system continues outputting, via the one or more output devices, the indication (e.g., at least a portion of the indication and/or the entirety of the indication) that the error occurred with respect to the respective action being performed (e.g., until the error is corrected and, in some embodiments, while detecting one or more performances of one or more other actions). In some embodiments, in response to detecting the second performance of the third action by the user, in accordance with a determination that the performance of the second action does not satisfy the set of one or more criteria with respect to the respective action in the first set of one or more actions to complete the task, the computer system ceases outputting, via the one or more output devices, the indication that the error occurred with respect to the respective action being performed (e.g., because the error has been corrected). Continuing outputting or ceasing the outputting of the indication that the error occurred with respect to the respective action being performed based on prescribed conditions being met, enables the computer system to intelligently provide notifications of mistakes made by the user while performing an activity and also provide a notification when the mistake is corrected, thereby providing improved feedback to the user and/or performing an operation when a set of conditions has been met without requiring further user input.

In some embodiments, the computer system outputs (e.g., in response to, after, and/or in conjunction with) detecting the user is performing the first set of one or more actions to complete the task), via the one or more output devices, one or more indications corresponding to the first set of one or more actions to complete the task. Outputting one or more indications corresponding to the first set of one or more actions to complete the task enables the computer system to provide instructions to perform an activity, thereby providing improved feedback to the user and/or reducing the number of inputs needed to perform an operation.

In some embodiments, the first set of one or more actions to complete the task includes a third set of one or more actions that are indicated to be performed before the first set of one or more actions to complete the task. In some embodiments, in response to detecting the performance of the first action by the user and in accordance with the determination that the performance of the first action satisfies the set of one or more criteria with respect to the respective action in the first set of one or more actions to complete the task, the computer system outputs (e.g., displays, issues, and/or provides), via the one or more output devices, an indication (e.g., one or more symbols, sound, text, characters, and/or haptic outputs) of the third set of one or more actions. In some embodiments, the first set of one or more actions to complete the task includes an ordered sequence of actions, where the third set of one or more actions are before the set of one or more actions. In some embodiments, the third set of one or more actions is different from the first set of one or more actions. In some embodiments, the third set of one or more actions is generated (and/or displayed and/or output) after generating (and/or displaying and/or outputting) the first set of one or more actions and/or after detecting and/or in response to detecting the performance of the first action by the user. Outputting an indication of the third set of one or more actions that are indicated to be performed before the first set of one or more actions to complete the task based on prescribed conditions being met enables the computer system to intelligently provide a notification of mistakes made by the user while performing an activity and to provide a notification on how to correct the mistake, thereby providing improved feedback to the user and/or performing an operation when a set of conditions has been met without requiring further user input.

In some embodiments, the first set of one or more actions to complete the task does not include a set of one or more actions to complete the task that was not in the first set of one or more actions to complete the task before detecting the performance of the first action by the user. In some embodiments, in response to detecting the performance of the first action by the user and in accordance with the determination that the performance of the first action satisfies a second set of one or more criteria with respect to the respective action in the set of one or more actions to complete the task, the computer system outputs (e.g., displays, issues, and/or provides), via the one or more output devices, an indication (e.g., one or more symbols, sound, text, characters, and/or haptic outputs) of the set of one or more actions to complete the task that was not in the first set of one or more actions to complete the task before detecting the performance of the first action by the user. In some embodiments, the set of one or more actions to complete the task includes an ordered sequence of actions. In some embodiments, the set of one or more actions to complete the task that was not in the first set of one or more actions to complete the task before detecting the performance of the first action by the user includes one or more corrective actions (e.g., one or more actions and/or tasks to correct an attempt at completing one or more of the set of one or more actions) not previously displayed. In some embodiments, the second set of one or more criteria with respect to the respective action in the set of one or more actions to complete the task is different from the set of one or more criteria with respective action in the set of one or more actions to complete the task. In some embodiments, the alternative set of one or more actions includes actions, such as getting new ingredients, ways to fix an error made with a tool (e.g., patching a hole and/or fixing a broken screw), and/or ways to correct a workout routine. Outputting an indication of the set of one or more actions to complete the task that was not in the first set of one or more actions to complete the task before detecting the performance of the first action by the user enables the computer system to intelligently provide a notification of mistakes made by the user while performing an activity and to provide a notification on how to correct the mistakes, thereby providing improved feedback to the user and/or performing an operation when a set of conditions has been met without requiring further user input.

In some embodiments, the first set of one or more actions to complete the task includes a fourth set of one or more actions performed after the first set of one or more actions to complete the task. In some embodiments, in response to detecting the performance of the first action by the user (e.g., 812) and in accordance with the determination that the performance of the first action satisfies the set of one or more criteria with respect to the respective action in the first set of one or more actions to complete the task, the computer system forgoes outputting (e.g., displaying and/or providing) an indication (e.g., 836, 838, and/or 842) (e.g., one or more symbols, sound, text, characters, and/or haptic outputs) of the fourth set of one or more actions performed after the first set of one or more actions to complete the task. ISE, the first set of one or more actions to complete the task includes an ordered sequence of actions. ISE, the third set of one or more actions performed after the first set of one or more actions to complete task is part of an ordered sequence action belonging to the first set of one or more actions to complete the task. Forgoing outputting an indication of the fourth set of one or more actions performed after the first set of one or more actions to complete the task based on prescribed conditions being met enables the computer system to intelligently provide notifications of mistakes made by the user while performing an action and intelligently stop providing further notifications for the activity when no longer needed, thereby providing improved feedback to the user and/or performing an operation when a set of conditions has been met without requiring further user input.

In some embodiments, the first set of one or more actions to complete the task includes a fourth set of one or more actions performed after the first set of one or more actions to complete the task. In some embodiments, in response to detecting the performance of the first action by the subject and in accordance with the determination that the performance of the first action satisfies the set of one or more criteria with respect to the respective action in the first set of one or more actions to complete the task, the computer system forgoes outputting (e.g., displaying and/or providing) an indication (e.g., one or more symbols, sound, text, characters, and/or haptic outputs) of the fourth set of one or more actions performed after the first set of one or more actions to complete the task. ISE, the first set of one or more actions to complete the task includes an ordered sequence of actions. ISE, the third set of one or more actions performed after the first set of one or more actions to complete task is part of an ordered sequence action belonging to the first set of one or more actions to complete the task. Forgoing outputting an indication of the fourth set of one or more actions performed after the first set of one or more actions to complete the task based on prescribed conditions being met enables the computer system to intelligently provide notifications of mistakes made by the subject while performing an action and intelligently stop providing further notifications for the activity when no longer needed, thereby providing improved feedback to the user and/or performing an operation when a set of conditions has been met without requiring further user input.

In some embodiments, in accordance with a determination that the performance of the first action is a first type of error, the that the error occurred with respect to the respective action is output in a first manner (e.g., displayed, haptic output, and/or audio output). In some embodiments, in accordance with a determination that the performance of the first action is a second type of error different from the first type of error, the that the error occurred with respect to the respective action is output in a second manner (e.g., displayed, haptic output, and/or audio output) different from the first manner. Outputting the indication that the error occurred with respect to the respective action in a first manner or in a second manner based on prescribed conditions being met enables the computer system to intelligently provide a specific notification for different types of mistakes made by the user while performing an activity, thereby providing improved feedback to the user and/or performing an operation when a set of conditions has been met without requiring further user input.

In some embodiments, outputting, via the one or more output devices, the that the error occurred with respect to the respective action includes: outputting a first that an error (e.g., a first error, a second error, and/or a third error) occurred with respect to the respective action in a third manner (e.g., audio outputs, visual outputs, and/or haptic outputs); and outputting a second that an error (e.g., a first error, a second error, and/or a third error) occurred with respect to the respective action in a fourth manner (e.g., audio outputs, visual outputs, and/or haptic outputs) different from the third manner. Outputting a first indication that an error occurred with respect to the respective action in a third manner and outputting a second indication that an error occurred with respect to the respective action in a fourth manner enables the computer system to intelligently provide notifications of different types of mistakes made by the user during an activity by presenting each type of mistake in unique way, thereby providing improved feedback to the user and/or performing an operation when a set of conditions has been met without requiring further user input.

In some embodiments, while detecting, via the one or more sensors, that the user is performing the first set of one or more actions to complete the task, the that is forgoes outputting (e.g., displaying and/or providing) an indication (e.g., one or more symbols, sound, text, characters, and/or haptic outputs) of an amount of times the user has performed one or more actions of the first set of one or more actions (e.g., a counter that is dynamically updated as the user performs the one or more actions, a counter, and/or a set of user interface objects that is displayed and/or is updated as the user performs the one or more actions).

In some embodiments, the computer system is a first computer system that includes and/or is communication with a movement component (e.g., as described above). In some embodiments, the performance of the first action by the user includes the user moving a second computer system, different from the first computer system, toward the first computer system and/or requesting that the first computer system access data from the second computer system. In some embodiments, the first computer system detects, via the one or more sensors, a request to transfer the data between the first computer system and the second computer system (e.g., the first computer system detects that the user moves the second computer system toward the first computer system and/or requests that the first computer system access the data from the second computer system. In some embodiments, in response to detecting the request to transfer the data between the first computer system and the second computer system, the computer system moves, via the movement component, a portion (e.g., a housing and/or an enclosure including a display component and/or the one or more input devices) of the first computer system towards the second computer system (e.g., as described below with respect to process 1400).

Note that details of the processes described above with respect to process 1200 (e.g., FIG. 12) are also applicable in an analogous manner to the methods described below/above. For example, process 1100 optionally includes one or more of the characteristics of the various methods described above with reference to process 1200. For example, the computer system can use one or more techniques of process 1200 to output an error corresponding to a step being performed, where an indication of the step was displayed using one or more techniques of process 1100. For brevity, these details are not repeated below.

FIGS. 13A-13E illustrate exemplary user interface for moving a computer system toward another computer system for transferring content in accordance with some embodiments. The user interfaces in these figures are used to illustrate the processes described below, including the processes in FIGS. 14 and 15.

In particular, FIGS. 13A-13E illustrate one or more scenarios, where content is transferred from computer system 1390 to computer system 1300. In response to receiving the request to receive transferred content, computer system 1300 moves toward computer system 1390. Moreover, after content is transferred from computer system 1390 to computer system 1300, computer system 1300 outputs one or more instructions to teach a skill related to the transferred content. It should be understood that, at FIGS. 13A-13D, the content transferred to computer system 1300 does not include instructions to teach the skill (e.g., is not an instructional video). However, at FIGS. 13A-13D, the one or more instructions to teach the skill are generated based on the content and, in some embodiments, are based on a request made by a user, such as verbal input 1305a in FIG. 13A (e.g., “Can you teach me this?”). In addition, in some embodiments, computer system 1300 can move toward computer system 1390 in response to receiving a request to transfer content to computer system 1390 as opposed to moving in response to receiving the request to receive transferred content.

FIG. 13A illustrates computer system 1300 and computer system 1390. In some embodiments, computer system 1300 and/or computer system 1390 is a smartphone, a smart watch, a fitness tracking device, a tablet, a head-mounted display (HMD) device, a communal device, and/or a personal computing device. In some embodiments, computer system 1300 and/or computer system 1390 can include one or more movement components and/or be attached to one or more movement components, which enable computer system 1300 and/or computer system 1390 to move in the environment. In some embodiments, computer system 1300 and computer system 1390 are the same type of device; in other embodiments, computer system 1300 and computer system 1390 are different types of devices. In some embodiments, computer system 1300 and/or computer system 1390 include one or more components and/or features as those described above in relation to computer system 100 and/or device 200.

As illustrated in FIG. 13A, computer system 1300 is displaying a user interface with an avatar (e.g., representation of face at FIG. 13A). In some embodiments, the avatar is a system avatar, where the avatar moves and/or changes based on one or more responses output by computer system 1300. Also illustrated in FIG. 13A is computer system 1390 displaying video 1392, a type of content that is currently available to be transferred. In some embodiments, computer system 1390 includes other types of content that are available to be transferred, such as images, files, music, other types of media, text, contact entries (e.g., including names and/or phone numbers of different contacts) in a contact database, and/or applications. In some embodiments, video 1392 (and/or another type of content) can be content that has been shared and/or transferred via social media. In some embodiments, computer system 1390 is currently displaying video 1392 in a social media application at FIG. 13A. However, in other embodiments, computer system 1390 is currently displaying video 1392 as a local video and/or in a different type of application than a social media application.

FIG. 13A also includes schematic 1380, which is provided to show the positioning of computer system 1300 relative to computer system 1390. At FIG. 13A, schematic 1380 shows that computer system 1300 is distance “d1” away from computer system 1390. Additionally, schematic 1380 includes user 1330. Notably, at FIG. 13A, user 1330 has a different appearance than the user depicted in video 1392. Thus, in some embodiments, user 1330 is not the user depicted in video 1392. In some embodiments, user 1330 is a user of computer system 1300 and/or computer system 1390. In some embodiments, computer system 1300 belongs to user 1330, but computer system 1390 does not belong to user 1330. In some embodiments, computer system 1300 is a communal device while computer system 1390 is a personal device of user 1330.

At FIG. 13A, computer system 1300 detects a request to receive content from computer system 1390. In FIG. 13A, the request is verbal request 1305b (“Can you teach me this?”) indicating that user 1330 would like to learn a skill in video 1392. In some embodiments, another type of input can be detected as a request to receive content from computer system 1390, such as an air gesture/input, a touch gesture/input, and/or a gesture/input directed to a physical hardware component (e.g., a physical button and/or rotatable input mechanism).

In some embodiments, the request can be a different type of request than the request denoted by verbal request 1305b (e.g., a request to receive content). In some embodiments, the request is a request to transfer content, where computer system 1300 sends content to computer system 1390 and an input is provided that corresponds to a request for computer system 1300 to send the content. In some embodiments, the request is a request to transfer desired content without specifying a device, such as obtaining content, and one or more devices are queried to ask if the desired content is available on the one or more devices.

In some embodiments, in response to detecting the request concerning transferring content (e.g., such as one or more of the different types of requests described above), computer system 1300 moves in one or more ways. For example, at FIG. 13B, computer system 1300 moves towards computer system 1390 in response to computer system 1300 detecting a request to receive content from computer system 1390 (e.g., as described above in relation to FIG. 13A). At FIG. 13B, computer system 1300 moves up and to the right to a position that is distance “d2” away from computer system 1390. Distance “d2” of FIG. 13B is less than distance “d1” of FIG. 13A; thus, computer system 1300 has effectively moved closer to computer system 1390 at FIG. 13B than computer system 1300 was at FIG. 13A.

In some embodiments, computer system 1300 can move in different ways in response to receiving the request to transfer content. In some embodiments, computer system 1300 can rotate, tilt, and/or move horizontally, vertically, and/or laterally towards computer system 1390. Moreover, in some embodiments, the type of movement performed by computer system 1300 is based on the location of computer system 1390 (and/or the computer system that is transferring content to and/or receiving content from computer system 1300). For example, at FIG. 13A, computer system 1390 is up and to the right of computer system 1300; thus, at FIG. 13B, computer system 1300 moves up and to the right toward computer system 1300. However, in embodiments where computer system 1390 is down and to the left of computer system 1300, computer system 1300 would move down and to the left to move closer to computer system 1390. In some embodiments, computer system 1300 moves based on movement of computer system 1390 if computer system 1390 moves while transferring content. For example, computer system 1300 can move with a speed, direction, and/or acceleration that is based on (e.g., matches and/or mirrors) the speed, direction, and/or acceleration of computer system 1390. In embodiments where there are more than two computer systems in the environment, computer system 1300 will move toward the computer system that is transferring content and will not move toward the computer system that is not transferring content (e.g., unless the computer system that is not transferring content is in the path and/or direction of the computer system transferring content). Thus, in some embodiments, computer system 1300 moves towards the computer system that a request and/or an indication that content is being transferred, will be transferred, and/or will be transferred after receiving permission to transfer the content.

In some embodiments, computer system 1300 moves towards computer system 1390 in a controlled manner. In some embodiments, computer system 1300 moves in a trajectory towards computer system 1390 amounting in the lowest amount of movement to reach a certain distance from computer system 1390. For example, computer system 1300 in FIGS. 13A-13B travels in a straight diagonal line (e.g., up and to the right) to reach the position of computer system 1300 at FIG. 13B instead of, for example, travelling up first and then right.

In some embodiments, the amount that computer system 1300 moves is based on the distance between computer system 1300 and computer system 1390. In some embodiments, computer system 1300 does not stop moving until computer system 1300 is within a predetermined distance from computer system 1390. In some embodiments, when computer system 1300 reaches the predetermined distance, computer system 1300 is not touching computer system 1390. In some embodiments, computer system 1300 moves a predetermined amount that is not based on how far computer system 1300 is from computer system 1390 (e.g., if computer system 1300 and computer system 1390 are separated by a threshold distance (e.g., 0.1-1 meters)). Thus, in some embodiments, in response to detecting the request concerning transferring content, computer system 1300 performs a preset movement (e.g., a bow, a shake, and/or a tilt) towards computer system 1390 that is not based on the distance between computer system 1300 and computer system 1390.

In some embodiments, computer system 1300 moves with respect to the content being transferred. For example, at FIGS. 13B-13C, computer system 1300 moves before computer system 1390 transfers content to computer system 1300. However, in some embodiments, computer system 1300 can move before computer system 1390 starts to and/or after computer system 1390 has transferred content to computer system 1300. In some embodiments, computer system 1300 moving towards computer system 1390 improves the fidelity and/or speed of transfer, such that computer system 1300 being a shorter distance from computer system 1390 improves the fidelity and/or speed one or more types of transfers. In some embodiments, content is transferred between computer system 1300 and/or computer system 1390 through different mediums, such as Bluetooth, Wi-Fi, and/or NFC.

In some embodiments, computer system 1300 moves before and/or while transferring content to indicate to user 1330 that content is about to be and/or is being transferred. In some embodiments, the indication that content is about to be and/or is being transferred also provides feedback to user 1330 that computer system 1300 received verbal input 1305a of FIG. 13A. In some embodiments, computer system 1300 can output other indications along with moving to indicate that content is about to be transferred, is being transferred, and/or has been transferred. For example, at FIG. 13B, computer system 1300 displays video image 1394 to indicate that video 1392 has been transferred. While, at FIG. 13B, computer system 1300 displays a frame of video 1392, computer system 1300 can output other types of indications, such as one or more visual indications (e.g., text and/or symbols), one or more audio indications (e.g., “Content being transferred” or “Content is being transferred”), and/or one or more haptic indications.

In some embodiments, computer system 1300 outputs an indication that content is being transferred that is different from an indication that computer system 1300 outputs after transfer of content has been completed. For example, the indication that content is being transferred can be accompanied by one type of sound (e.g., a ding and/or a bell) while the indication that transfer of content has been completed can be accompanied by another type of sound (e.g., a buzz and/or a clap).

In some embodiments, computer system 1300 transitions from operating in a non-training mode to a training mode in response to receiving the request to receive transferred content. As illustrated in FIG. 13C, computer system 1300 displays training avatar 1310 with instruction 1312 while operating in the training mode. Instruction 1312 dynamically changes as training avatar 1310 (e.g., avatar 1310 appears different from (e.g., with a hat and/or other distinguishing feature) user 1330 to show that they are different) moves to show user 1330 how to perform a dance that was included in video 1392 of FIG. 13A. In some embodiments, computer system 1300 displays user 1330 and/or a representation of user 1330 in lieu displaying avatar 1310. In some embodiments, as illustrated in FIG. 13D, computer system 1390 no longer needs to be active and/or on to perform further operations with respect to computer system 1300. In some embodiments, user 1330 can put away computer system 1390 after and/or while transferring the content to computer system 1390.

Notably, as alluded to above, video 1392 is not an actual instruction video of the dance and does not include one or more explicit instructions on how to perform the dance. Rather, at FIGS. 13B-13C, computer system 1300 generates a set of instructions by analyzing video 1392 and learning the characteristics of the dance performed in video 1392 to teach user 1330 how to perform the dance. In some embodiments, computer system 1300 can analyze a video and, based on input such as verbal input 1305a, can generate different sets of instructions. For example, if the user asked computer system 1300 to teach the user how to play the music of video 1392 on the piano, computer system 1300 would generate a set of instructions showing the user how the music of video 1392 can be played on the piano. As another example, if the user asked computer system 1300 to teach the user how to draw a scene from video 1392, computer system 1300 would generate a set of instructions showing the user how to draw a scene of video 1392.

At FIG. 13C, computer system 1300 updates avatar 1310 to move as user 1330 should move and/or is moving. For example, if user 1330 should move and/or is moving to the right, avatar 1310 is updated as moving to the right. In some embodiments, avatar 1310 is updated to give instructions to complete the dance and moves according to the next movements of the dance. In some embodiments, other types of instructions are output and/or updated using similar techniques, such as other visual instructions, audible instructions, and/or haptic instructions. In some embodiments, computer system 1300 rotates and/or moves to provide instructions. For example, if the dance move is completed by a user making a circular movement with the user's right arm, computer system 1300 can move in a circular motion. As another example, if the dance move is completed by a user sliding their feet to the left, computer system 1300 can move horizontally to the left.

As discussed above, the instructions can be output dynamically. For example, at FIG. 13C, instruction 1312 is updated dynamically to teach user 1330 how to perform the dance. In some embodiments, the tempo, speed, and/or beat at which the instructions are output is based on the tempo, speed, and/or beat of the dance performed in the video. At FIG. 13C, computer system 1300 can teach the dance at a slower tempo and/or speed than the dance is performed in video 1392 (and/or than the dance that video 1392 references is normally performed). In some embodiments, computer system 1300 manages the tempo and/or speed of the output of instructions based on the skill level of user 1330. In some embodiments, computer system 1300 teaches the dance at a higher speed when a determination is made that user 1330 is an expert dancer and at a slower speed when a determination is made that user 1330 is a beginner. In some embodiments, computer system 1300 speeds up the output of the instructions (or slows them down) based on how fast user 1330 is currently learning the dance. For example, computer system 1300 can speed up the output of the instructions if user 1330 is performing the dance with a high amount of accuracy (e.g., greater than 50-99%) and can slow down the output of instructions if user 1330 is performing the dance with a low amount of accuracy (e.g., less than 0-70% accuracy). Moreover, in some embodiments, the instructions can be output dynamically to indicate rather user 1330 is performing a portion of the dance correctly, such as displaying instruction 1312 as one color (e.g., green, blue, and/or orange) while user 1330 is performing the dance (and/or following the instructions) correctly and displaying instruction 1312 as another color (e.g., red, black, and/or yellow) while user is performing the dance (and/or following the instructions) incorrectly.

FIG. 13D illustrates computer system 1300 capturing a video after computer system 1300 has shown user 1330 how to perform the dance at FIG. 13C. In some embodiments, FIG. 13D and FIG. 13C can occur concurrently, where the video is captured while computer system 1300 is initially showing user 1330 how to perform the dance. In some embodiments, in response to detecting that user 1330 has successfully practiced the dance and/or in response to detecting a request from user 1330 (e.g., that user 1330 is ready to perform the dance on video and/or that user 1330 has practiced enough), computer system 1300 begins capturing a video of user 1330 performing the dance. In some embodiments, computer system 1300 begins capturing the video after displaying the initial instructions one or more times at FIG. 13C.

In some embodiments, in response to detecting the request, computer system 1300 can display a live preview. For example, as illustrated in FIG. 13D, while capturing the video, computer system 1300 displays live preview 1340, which is a live feed of the field-of-view of one or more cameras of computer system 1300. While showing live preview 1340, computer system 1300 overlays instruction 1312 on top of live preview 1340 to guide the user's performance of the dance. In some embodiments, computer system 1300 does not overlay instruction 1312 on top of live preview 1340. Instead, computer system 1300 displays instruction 1312 outside of live preview 1340. In some embodiments, one or more instructions are output (e.g., as described above in relation to FIG. 13C) while capturing the user's performance of the dance. In some embodiments, less instructions and/or different types of instructions are output while capturing the user's performance of the dance than were output while training the user to perform the dance at FIG. 13C. For example, computer system 1300 could not move to guide the user at FIG. 13D while moving to guide the user at FIG. 13C because computer system 1300 may need to keep the camera still at FIG. 13D while capturing the performance of the user.

FIG. 13E illustrates a user interface (e.g., share user interface 1320) that computer system 1300 can display after capturing the user performing the skill. Share user interface 1320 includes first application control 1322 and second application control 1324 along with edited performance video indications 1326. Share user interface 1320 is an example of a user interface that computer system 1300 can display to suggest that user 1320 share the performance of the dance captured at FIG. 13C. In some embodiments, first application control 1322 and second application control 1324 are controls for different applications, such as different social media applications, media storage applications, and/or communication applications (e.g., text messaging applications, video applications, and/or e-mail applications). In some embodiments, in response to detecting a request corresponding to first application control 1322, computer system 1300 initiates a process to share an edited video of the performance and/or the video of the performance via the first application. Likewise, in response to detecting a request corresponding to second application control 1324, computer system 1300 initiates a process to share an edited video of the performance and/or the video of the performance via the second application. In some embodiments, as a part of initiating the process, computer system 1300 autogenerates information, such as metadata and/or hashtags that are also transmitted to a selected application (e.g., the first application and/or the second application) along with edited video of the performance and/or the video of the performance. In some embodiments, the autogenerated metadata and/or hashtags are based on one or more characteristics (e.g., location, original hashtags, time, date, duration, and/or type of performance) of video 1392 and/or the video captured at FIG. 13C.

In some embodiments, as alluded to above, computer system 1300 is suggesting sharing, at FIG. 13D, an edited video of the performance of the dance captured at FIG. 13C. In some embodiments, the video performed at FIG. 13C is automatically and dynamically adjusted, such that relevant, important, and/or interesting portions of the captured video are preserved. In some embodiments, computer system 1300 cuts out one or more portions of the captured video. In some embodiments, computer system 1300 cuts out one or more portions of the captured video to provide an edit version of the video that will fit with one or more requirements of the first application and/or the second application. For example, computer system 1300 can cut the video, such that the video is smaller than a certain size and/or shorter than a certain length that could be required by the first application and/or the second application. In some embodiments, computer system 1300 has multiple versions of the edited video that are cut differently to have videos ready to upload using various applications with various requires.

At FIG. 13E, edited performance video indications 1326 represent scenes of the captured video, which have been preserved (e.g., as indicated by edited performance video indications 1326a-1326c, each representing a different scene). In some embodiments, computer system 1300 displays an indication of one or more scenes that have not been preserved as a part of user interface 1320. In some embodiments, a user can edit and/or change the edited video that was performed at FIG. 13C before the video is shared.

FIG. 14 is a flow diagram illustrating a method for moving a computer system toward another computer system for transferring content using a computer system in accordance with some embodiments. Process 1400 is performed at a computer system (e.g., 100, 200, and/or 1300). Some operations in process 1400 are, optionally, combined, the orders of some operations are, optionally, changed, and some operations are, optionally, omitted.

As described below, process 1400 provides an intuitive way for moving a computer system toward another computer system for transferring content. The method reduces the cognitive burden on a user for moving a computer system toward another computer system for transferring content, thereby creating a more efficient human-machine interface. For battery operated computing devices, enabling a user to move a computer system toward another computer system for transferring content faster and more efficiently conserves power and increases the time between battery charges.

In some embodiments, process 1400 is performed at a first computer system (e.g., 1300) that is in communication with a movement component (e.g., an actuator, a motor, an electronic arm, a lift, and/or a lever). In some embodiments, the first computer system is a watch, a phone, a tablet, a fitness tracking device, a processor, a head-mounted display (HMD) device, a communal device, a media device, a speaker, a television, and/or a personal computing device. In some embodiments, the first computer system is in communication with one or more output devices (e.g., a speaker, a haptic output device, a display screen, a projector, and/or a touch-sensitive display) and/or one or more input devices (e.g., a touch-sensitive display, a rotatable input mechanism, a camera (e.g., a telephoto, a wide angle, and/or an ultra-wide angle camera), and/or a sensor (e.g., a gyroscope and/or a heart rate sensor)).

The first computer system detects (and/or receives) (1402) a request (e.g., 1305a) corresponding to transferring content (e.g., 1392) (e.g., receiving content and/or sending content) between the first computer system (e.g., 1300) and a second computer system (e.g., 1390) (e.g., while in communication with the second computer system) (e.g., different from the first computer system) (e.g., as described above with respect to FIGS. 13A-13B).

In response to detecting the request corresponding to transferring content between the first computer system (e.g., 1300) and the second computer system (e.g., 1390), the first computer system moves (1404) (e.g., physically moves, moves within a physical environment, moves within a three-dimensional environment, and/or moves without further user input (e.g., without the user moving the first computer system and/or without the user issuing a command (e.g., via voice, touch, gaze, and/or an air gesture)) for the first computer system to be moved), via the movement component, a portion (e.g., a physical portion, a portion including a display screen, a portion including a hardware button, and/or a portion including a center of a display screen) of the first computer system toward the second computer system (e.g., 1390) (e.g., as described above with respect to FIGS. 13A-13B) (e.g., in a direction (e.g., of the second computer system), at a speed, at a rate, within a certain distance of the second computer system and/or within proximity to the second computer system). In some embodiments, the second computer system also moves towards the first computer system in response to a detection of the request corresponding to transferring content between the first computer system and the second computer system. Moving a portion of the first computer system toward the second computer system in response to detecting the request moving a portion of the first computer system toward the second computer system enables the computer system receiving content to be positioned closer to the computer system transmitting data and can improve the fidelity and/or reliability of transferred content, thereby providing improved feedback, reducing the number of inputs operation, and/or increasing security.

In some embodiments, the request corresponding to transferring content between the first computer system (e.g., 1300) and the second computer system (e.g., 1390) is a request to receive content (e.g., 1392) from the second computer system (e.g., as described above with respect to FIGS. 13A-13B). In some embodiments, the request to receive content from the second computer system was sent by the first computer system, the second computer system, and/or a computer system different from the first computer system and the second computer system. Having the request corresponding to transferring content between the first computer system and the second computer system be a request to receive content from the second computer system enables the computer system receiving content to position itself closer to the computer system transmitting data after receiving a request to receive content from another computer system and can improve the fidelity and/or reliability of transferred content, thereby providing improved feedback, reducing the number of inputs operation, and/or increasing security.

In some embodiments, the request corresponding to transferring content between the first computer system (e.g., 1300) and the second computer system (e.g., 1390) is a request to send content to the second computer system (or the first computer system). In some embodiments, the request to send content from the first computer system was sent by the first computer system, the second computer system, and/or a computer system different from the first computer system and the second computer system. Having the request corresponding to transferring content between the first computer system and the second computer system be a request to send content to the first computer system enables the computer system receiving data to position itself closer to the computer system transmitting data after transmitting a request to send content to another computer system and can improve the fidelity and/or reliability of transferred content, thereby providing improved feedback, reducing the number of inputs operation, and/or increasing security.

In some embodiments, after detecting the request corresponding to transferring content between the first computer system (e.g., 1300) and the second computer system (e.g., 1390), the first computer system receives content (e.g., as described above with respect to FIGS. 13A-13B) (e.g., 1394) (e.g., from the second computer system) (e.g., the requested content). In some embodiments, after detecting the request corresponding to transferring content between the first computer system and the second computer system, sending content (e.g., the requested content) (e.g., to the second computer system). Receiving content after detecting the request corresponding to transferring content between the first computer system and the second computer system enables the computer system receiving data to be positioned closer to the computer system transmitting data and can improve the fidelity and/or reliability of transferred content, thereby providing improved feedback, reducing the number of inputs operation, and/or increasing security.

In some embodiments, in response to detecting the request corresponding to transferring content between the first computer system (e.g., 1300) and the second computer system and in accordance with a determination that the second computer system (e.g., 1390) is in a first direction (e.g., with respect to the first computer system) while (and/or in conjunction with) detecting the request corresponding to transferring content between the first computer system (e.g., 1300) and the second computer system (e.g., 1390), the portion of the first computer system is moved in the first direction (and/or in a first manner and/or with a first movement pattern) (e.g., as described above with respect to FIGS. 13A-13B). In some embodiment, in response to detecting the request corresponding to transferring content between the first computer system (e.g., 1300) and the second computer system and in accordance with a determination that the second computer system (e.g., 1390) is in a second direction (e.g., with respect to the first computer system) while (and/or in conjunction with) detecting the request corresponding to transferring content between the first computer system (e.g., 1300) and the second computer system, the portion of the first computer system is moved in the second direction (and/or in a second manner and/or with a first second pattern), wherein the second direction is different from the first direction (e.g., as described above with respect to FIGS. 13A-13B) (and is not moved in the first direction). In some embodiments, in response to detecting the request corresponding to transferring content between the first computer system and the second computer system and in accordance with a determination that the second computer system is in the first direction while (and/or in conjunction with) detecting the request corresponding to transferring content between the first computer system and the second computer system, the portion of the first computer system is not moved in the second direction. Moving a portion of the first computer system in either a first direction or a second direction based on prescribed conditions related to the location of the first computer system and the second computer system being met enables the computer system receiving data to position itself closer to the computer system transmitting data and can improve the fidelity and/or reliability of transferred content, thereby providing improved feedback, reducing the number of inputs operation, and/or increasing security.

In some embodiments, the first computer system (e.g., 1300) is in communication with one or more output devices (e.g., a display component, a haptic output device, and/or a speaker). In some embodiments, after detecting the request corresponding to transferring content between the first computer system (e.g., 1300) and the second computer system (e.g., 1390), the first computer system outputs, via one or more output devices, an indication (e.g., 1394) (e.g., an audio indication, text, a symbol, an image, and/or a haptic output) that the content has been transferred (e.g., as described above with respect to FIG. 13B) (e.g., received and/or sent). Outputting an indication that the content has been transferred enables the computer system to generate a notification when the transfer of data is completed, thereby providing improved visual feedback to the user and/or reducing the number of inputs needed to perform an operation.

In some embodiments, the portion of the first computer system moves (e.g., 1300) laterally, via the movement component, while the portion of the first computer system moves toward the second computer system (e.g., 1390) (e.g., as described above with respect to FIGS. 13A-13B). In some embodiments, the portion of the computer system moves left, right, up, down, back, and/or forward. Having the portion of the first computer system move laterally while the portion of the first computer system moves toward the second computer system enables the computer system receiving data to position itself closer to the computer system transmitting data by moving in a lateral direction and can improve the fidelity and/or reliability of transferred content, thereby providing improved feedback, reducing the number of inputs operation and/or increasing security.

In some embodiments, the portion of the first computer system (e.g., 1300) rotates (e.g., changes yaw, pitch, and/or roll), via the movement component, while the portion of the first computer system moves toward the second computer system (e.g., 1390) (e.g., as described above with respect to FIGS. 13A-13B). Having the portion of the first computer system rotate while the portion of the first computer system moves toward the second computer system enables the computer system receiving data to position itself closer to the computer system transmitting data and can improve the fidelity and/or reliability of transferred content, thereby providing improved feedback, reducing the number of inputs operation and/or increasing security.

In some embodiments, the first computer system (e.g., 1300) is in an environment with the second computer system (e.g., 1390) and a third computer system, different from the first computer system and the second computer system. In some embodiments, while the first computer system (e.g., 1300) is in the environment with the second computer (e.g., 1390) system and the third computer system, the first computer system detects a request corresponding to transferring content between the first computer system and a respective computer system. In some embodiments, in response to detecting the request corresponding to transferring content between the first computer system (e.g., 1300) and the respective computer system and in accordance with a determination that the respective computer system is the second computer system (e.g., 1390), the first computer system moves, via the movement component, the portion of the first computer system toward the second computer system without moving the portion of the first computer system toward the third computer system. Detecting a request corresponding to transferring content between the first computer system and a respective computer system and in accordance with a determination that the respective computer system is the second computer system moving the portion of the first computer system toward the second computer system without moving the portion of the first computer system toward a third computer system enables the computer system to intelligently move toward a computer system transmitting data and avoid a computer system not transmitting data and can improve the fidelity and/or reliability of transferred content, thereby providing improved feedback, reducing the number of inputs operation and/or increasing security.

In some embodiments, in response to detecting the request corresponding to transferring content between the first computer system (e.g., 1300) and the respective computer system (and, in some embodiments, in response to a determination that the first computer system should obtain content from the third computer system), the first computer system moves, via the movement component, the portion of the first computer system toward the third computer system without moving the portion of the first computer system toward the second computer system (e.g., 1390). Moving the portion of the first computer system toward the third computer system without moving the portion of the first computer system toward the second computer in response to detecting the request corresponding to transferring content between the first computer system and the respective computer system enables the computer system to intelligently move toward a computer system for providing permission to obtain data from another computer system and can improve the fidelity and/or reliability of transferred content, thereby providing improved feedback, reducing the number of inputs operation and/or increasing security.

In some embodiments, while moving, via the movement component, the portion of the first computer system (e.g., 1300) toward the second computer system (e.g., 1390) and in accordance with a determination that the second computer system is within a predetermined distance of the first computer system, the first computer system decreases, via the movement component, an amount of movement of the portion of the first computer system toward the second computer system. In some embodiments, after initiating moving, via the movement component, the portion of the first computer system toward the second computer system and in accordance with a determination that the second computer system is within a predetermined distance of the portion of the first computer system, the first computer system stops moving and/or moves at a slower pace toward the portion of the second computer system. Decreasing an amount of movement of the portion of the first computer system toward the second computer system in accordance with a determination that the second computer system is within a predetermined distance of the first computer system enables the computer system receiving data to be positioned at a predetermined distance from the computer system transmitting data and can improve the fidelity and/or reliability of transferred content, thereby providing improved feedback, reducing the number of inputs operation and/or increasing security.

In some embodiments, while moving, via the movement component, the portion of the first computer system (e.g., 1300) toward the second computer system (e.g., 1390) and in accordance with a determination that the first computer system has moved a predetermined amount, the first computer system initiates a process to cease movement of the first computer system. In some embodiments, while moving, via the movement component, the portion of the first computer system toward the second computer system and in accordance with a determination that the first computer system has not moved the predetermined amount, the first computer system does not initiate the process to cease and/or slow down movement of the portion of the first computer system. In some embodiments, while moving, via the movement component, the portion of the first computer system toward the second computer system and in accordance with a determination that the portion of the first computer system has moved a predetermined amount, the first computer system slows down and/or stops moving the portion of the first computer system. Initiating a process to cease movement of the first computer system in accordance with a determination that the first computer system has moved a predetermined amount enables the computer system receiving data to stay within a predetermined area while moving itself toward the computer system transmitting data and can improve the fidelity and/or reliability of transferred content, thereby providing improved feedback, reducing the number of inputs operation and/or increasing security.

In some embodiments, after moving, via the movement component, the portion of the first computer system (e.g., 1300) toward the second computer system (e.g., 1390) and in accordance with a determination that a threshold amount (e.g., 0.1-100% of the content requested to be transferred) (e.g., the entire amount and/or a portion of the content) of content between the first computer system and the second computer system has been transferred, the first computer system moves, via the movement component, the portion of the first computer system away from the second computer system (e.g., as illustrated in FIG. 13C) (and/or moving in a direction and/or with a rotation that is opposite of the direction and/or rotation that the portion of the first computer system moved when moving toward the second computer system). In some embodiments, after moving the portion of the first computer system toward the second computer system and in accordance with a determination that a threshold amount of content between the first computer system and the second computer system has not been transferred, the first computer system does not move the portion of the first computer system away from the second computer system. Moving the portion of the first computer system away from the second computer system in accordance with a determination that a threshold amount of content between the first computer system and the second computer system has been transferred enables the computer system to return to its original location after obtaining data from the other computer system, thereby performing an operation when a set of conditions has been met without requiring further user input and/or increasing security.

In some embodiments, in response to detecting the request corresponding to transferring content between the first computer system (e.g., 1300) and the second computer system (e.g., 1390), the first computer system outputs, via one or more output devices, an indication (e.g., an audio indication, text, a symbol, an image, and/or a haptic output) that the request has been received (e.g., as described above with respect to FIGS. 13A-13B). In some embodiments, the indication that the request has been received is a different type of indication and/or a different indication than the indication that the content has been transferred. In some embodiments, after detecting the request corresponding to transferring content between the first computer system and the second computer system, in accordance with a determination that a threshold amount of content between the first computer system and the second computer system has been transferred, the first computer system outputs the indication that the content has been transferred. In some embodiments, while content is being transferred, the first computer system outputs an indication that content is being transferred. In some embodiments, the indication that content is being transferred is a different type of indication and/or a different indication than the indication that the content has been transferred and/or the indication that the request has been received. Outputting an indication that the request has been received in response to detecting the request corresponding to transferring content between the first computer system and the second computer system enables the computer system to generate an alert for the status of an operation to transfer content between two computer systems, thereby providing improved feedback to the user and/or reducing the number of inputs needed to perform an operation.

Note that details of the processes described above with respect to process 1400 (e.g., FIG. 14) are also applicable in an analogous manner to the methods described below/above. For example, process 1500 optionally includes one or more of the characteristics of the various methods described above with reference to process 1400. For example, the computer system can be moved toward a device to receive content using techniques described in relation to process 1400 and, afterwards, output instructions to perform a skill related to the received content using the techniques described in relation to process 1500. For brevity, these details are not repeated below.

FIG. 15 is a flow diagram illustrating a method for outputting generated instructions to perform a skill related to content using a computer system in accordance with some embodiments. Process 1500 is performed at a computer system (e.g., 100, 200, and/or 1300). Some operations in process 1500 are, optionally, combined, the orders of some operations are, optionally, changed, and some operations are, optionally, omitted.

As described below, process 1500 provides an intuitive way for outputting generated instructions to perform a skill related to content. The method reduces the cognitive burden on a user for outputting generated instructions to perform a skill related to content, thereby creating a more efficient human-machine interface. For battery operated computing devices, enabling a user to output generated instructions to perform a skill related to content faster and more efficiently conserves power and increases the time between battery charges.

In some embodiments, process 1500 is performed at a first computer system (e.g., 1300) that is in communication with one or more output devices (e.g., a speaker, a haptic output device, a display screen, a projector, and/or a touch-sensitive display). In some embodiments, the first computer system is a watch, a phone, a tablet, a fitness tracking device, a processor, a head-mounted display (HMD) device, a communal device, a media device, a speaker, a television, and/or a personal computing device. SE, the first computer system is in communication with one or more input devices (e.g., a touch-sensitive display, a rotatable input mechanism, a camera (e.g., a telephoto, wide angle, and/or ultra-wide-angle camera), and/or a sensor (e.g., a gyroscope and/or a heart rate sensor)).

While operating in a first mode (e.g., a non-training mode, a non-instructional mode, and/or a mode where the computer system is not outputting instructions corresponding to content) (e.g., as described above with respect to FIGS. 13A-13B), the first computer system receives (1502) data (e.g., data corresponding to 1392) corresponding to content (e.g., cooking instructions, a cooking video, dancing instructions, a dancing video, maintenance instructions, a maintenance video, building instructions, a building video, sign language instructions, a sign language video, repairing instructions, and/or a repairing video) (e.g., video content, audio content, and/or image content) from a second computer system (e.g., 1390) different from the first computer system (e.g., 1300).

In response to (1504) receiving the data corresponding to the content from the second computer system (e.g., 1390), the first computer system transitions (1506) from operating in the first mode to operating in a second mode (e.g., training mode, an instructional mode, and/or a mode where the computer system is outputting instructions corresponding to content) (e.g., as described above with respect to FIG. 13C) different from the first mode.

In response to (1504) receiving the data corresponding to the content from the second computer system, in accordance with a determination that a first skill (e.g., a set of characteristics, a set of actions, a set of movements, and/or audio (e.g., music, singing, and/or speech)) (e.g., dancing, as described above with respect to FIG. 13C) corresponds to the content, the first computer system outputs (1508), via the one or more output devices, a first set of one or more instructions (e.g., as described above with respect to FIGS. 13C-13D) (e.g., video, animation, audio, photos, a trail that guides a user to perform a move, where the trail is updated over time according to the performance of a skill, and/or text) corresponding to the first skill (e.g., as described above with respect to FIG. 13C).

In response to (1504) receiving the data corresponding to the content from the second computer system, in accordance with a determination that a second skill, different from the first skill, corresponds to the content, the first computer system outputs (1510), via the one or more output devices, a second set of one or more instructions corresponding to the second skill, wherein the second set of one or more instructions is different from the first set of one or more instructions (e.g., as described above with respect to FIG. 13C). Receiving data corresponding to content from a second computer system and outputting a first set of one or more instructions corresponding to a first skill or outputting a second set of one or more instructions corresponding to a second skill based on a type of skill contained in the content enables the computer system to provide a user with instructions on how to perform a skill from received content, thereby performing an operation when a set of conditions has been met without requiring further user input and/or providing improved feedback to the user.

In some embodiments, the content is first content. In some embodiments, while operating in the first mode, the first computer system receives second data corresponding to second content from the second computer system (e.g., 1390) (e.g., as described above in FIG. 13B). In some embodiments, in response to receiving the second data corresponding to the second content from the second computer system (e.g., 1390), the first computer system transitions from operating in the first mode to operating in the second mode. In some embodiments, in response to receiving the second data corresponding to the second content from the second computer system and in accordance with a determination that the second content from the second computer system (e.g., 1390) is a first type of content (e.g., audio, animation, photo, text, and/or video), the first computer system outputs, via the one or more output devices, a third set of one or more instructions (e.g., as described above with respect to FIG. 13C). In some embodiments, in response to receiving the second data corresponding to the second content from the second computer system and in accordance with a determination that the second content from the second computer system (e.g., 1390) is a second type of content (e.g., audio, animation, text, images, and/or video) different from the first type of content, the first computer system outputs, via the one or more output devices, a fourth set of one or more instructions different from the third set of one or more instructions (e.g., as described above with respect to FIG. 13C). Outputting a third set of one or more instructions or a fourth set of one or more instructions based on a type of content that corresponds to received content enables the computer system to provide a user with instructions on how to perform a skill based on the type of content that is received from the second computer system, thereby performing an operation when a set of conditions has been met without requiring further user input and/or providing improved feedback to the user.

In some embodiments, the computer system (e.g., 1300) is in communication with a first of one or more cameras. In some embodiments, the one or more output devices includes a first display component (e.g., a display screen, a projector, and/or a touch-sensitive display). In some embodiments, in response to receiving the data corresponding to the content from the second computer system (e.g., 1390, the first computer system displays, via the first display component, a live preview (e.g., as described above with respect to FIG. 13D) (e.g., streaming video and/or live feed) corresponding to one or more images (e.g., of a user, of a group of users, of an object (e.g., music instruments, tools, sporting equipment and/or appliances), and/or of a group of objects) captured in a field of view of the first set of one or more cameras (e.g., as described above with respect to FIG. 13D) (e.g., a telephoto camera, a wide-angle camera, an ultra-wide-angle camera, and/or a video camera). In some embodiments, while displaying the live preview corresponding to the one or more images, the first computer system detects a change with respect to the computer system and the field of view of the first set of one or more cameras (e.g., as described above with respect to FIG. 13D). In some embodiments, in response to detecting the change with respect to the computer system and the field of view of the first set one or more cameras, the first computer system updates the live preview (e.g., as described above with respect to FIG. 13D). In some embodiments, a second set of one or more images is captured and used to update the live preview. In some embodiments, updating the live preview includes displaying the live preview with a respective set of one or more images that is different from the one or more images. Detecting the change with respect to the computer system and the field of view of the first set one or more cameras updating the live preview enables the computer system to provide live updates of captured performance, thereby providing improved visual feedback to the user and/or reducing the number of inputs needed to perform an operation.

In some embodiments, outputting, via the one or more output devices, the first set of one or more instructions corresponding to the first skill includes displaying, via the first display component, a representation (e.g., 1312) of the first set of one or more instructions overlaid (e.g., picture in picture, text over video, and/or text over image) on the live preview (e.g., as described above with respect to FIG. 13C). In some embodiments, outputting, via the one or more output devices, the second set of one or more instructions corresponding to the second skill includes displaying, via the first display component, a representation (e.g., 1312) of the second set of one or more instructions overlaid with the live preview (e.g., as described above with respect to FIG. 13C). Displaying a representation of the first set of one or more instructions overlaid on the live preview enables the computer system to provide instructions on how to perform a task while displaying a user preforming the task, thereby providing improved visual feedback to the user and/or reducing the number of inputs needed to perform an operation.

In some embodiments, outputting, via the one or more output devices, the first set of one or more instructions corresponding to the first skill includes displaying, via the first display component, a representation (e.g., 1310) of a first avatar moving in a first direction (e.g., as described above with respect to FIG. 13C). In some embodiments, the computer system is moving the first avatar's head in the first direction around the first avatar's hand. In some embodiments, moving the second avatar in the first direction provides a user with instructions to perform a task or move in a certain manner. In some embodiments, the first avatar is generated based on one or more characteristics and/or a description of a particular character and/or a user. In some embodiments, outputting, via the one or more output devices, the second set of one or more instructions corresponding to the second skill includes displaying, via the first display component, a representation of a second avatar, different from the representation of the first avatar, moving in a second direction different from the first direction (e.g., as described above with respect to FIG. 13C). In some embodiments, the second avatar is moving the second avatar's head in the second direction around the second avatar's hand. In some embodiments, moving the second avatar in the second direction provides a user with instructions to perform a task or move in a certain manner. In some embodiments, the second avatar is generated based on one or more characteristics and/or a description of a particular character and/or a user. Outputting the first set of one or more instructions corresponding to the first skill includes displaying a representation of a first avatar moving in a first direction enables the computer system to provide a tutorial for a skill in friendly manner, thereby providing improved visual feedback to the user and/or reducing the number of inputs needed to perform an operation.

In some embodiments, the performance of the first action by the user includes data corresponding to the task (e.g., a completed sub-task and/or step), wherein the computer system is a first computer system, and wherein the computer system is in communication with a movement component. In some embodiments, the computer system detects, via the one or more sensors, a request to transfer the data corresponding to the task between the first computer system and a second computer system different from the first computer system. In some embodiments, in response to detecting the request corresponding to transferring the data corresponding to the task between the first computer system and the second computer system, the computer system moves, via a movement component, a portion of the first computer system towards the second computer system (e.g., as described below with respect to process 1400).

In some embodiments, displaying, via the first display component, the representation of the first avatar moving in the first direction includes, in accordance with a determination that a first user (e.g., in the field-of-view of the first set of cameras) is moving with a first set of one or more movement characteristics (e.g., style, speed, and/or fashion), moving the first avatar with a second set of one or more movement characteristics (e.g., as described above with respect to FIG. 13C). In some embodiments, the first set of one or more movement characteristics is the same as the second set of one or more movement characteristics. In some embodiments, the second set of one or more movement characteristics and the characteristics of the first set of one or more movement characteristics maintain a constant ratio between each other. In some embodiments, displaying, via the first display component, the representation of the first avatar moving in the first direction includes, in accordance with a determination that the first user is moving with a third set of one or more set movement characteristics, different from the first set of one or more set movement characteristics, moving the first avatar with a fourth set of one or more set movement characteristics different from the second set of one or more set movement characteristics (e.g., as described above with respect to FIG. 13C) (e.g., without moving with the second set of one or more movement characteristics). In some embodiments, the third set of one or more movement characteristics is the same as the fourth set of one or more movement characteristics. In some embodiments, the third set of one or more movement characteristics and the characteristics of the fourth set of one or more movement characteristics maintain a constant ratio between each other. Moving the first avatar with a second set of one or more movement characteristics or a fourth set of one or more set movement characteristics based on prescribed conditions being met enables the computer system to customize and mimic movement of avatar based on detected movement of a user, thereby providing improved visual feedback to the user and/or performing an operation when a set of conditions has been met without requiring further user input.

In some embodiments, outputting, via the one or more output devices, the first set of one or more instructions corresponding to the first skill includes, in accordance with a determination that the content from the second computer system (e.g., 1390) corresponds to (e.g., has, assigned, associated with, and/or includes) a first beat, providing, via the one or more output devices, audio of the first set of one or more instructions corresponding to the first skill at a second beat (e.g., as described above with respect to FIG. 13C). In some embodiments, the first beat and the second beat are equal. In some embodiments, the first beat and the second beat are different. In some embodiments, the first beat and the second beat maintain a constant ratio between each other. In some embodiments, the second beat is slower than the first beat. In some embodiments, the second beat is faster than the first beat. In some embodiments, outputting, via the one or more output devices, the first set of one or more instructions corresponding to the first skill includes, in accordance with a determination that the content from the second computer system (e.g., 1390) corresponds to a third beat, different from the first beat, providing, via the one or more output devices, audio of the first set of one or more instructions corresponding to the first skill at a fourth beat, different from the second beat (e.g., as described above with respect to FIG. 13C). In some embodiments, the third beat and the fourth beat are equal. In some embodiments, the third beat and the fourth beat are different. In some embodiments, the third beat and the fourth beat maintain a constant ratio between each other. In some embodiments, the third beat is slower than the fourth beat. In some embodiments, the third beat is faster than the fourth beat. In some embodiments, outputting, via the one or more output devices, the second set of one or more instructions corresponding to the second skill includes: in accordance with a determination that the content from the second computer system corresponds to a fifth beat, providing audio of the second set of one or more instructions corresponding to the second skill at a sixth beat; and in accordance with a determination that the content from the second computer system corresponds to a seventh beat, different from the fifth beat, providing, audio of the second set of one or more instructions corresponding to the second skill at an eighth beat, different from the sixth beat. In some embodiments, the fifth beat and the sixth beat are equal. In some embodiments, the fifth beat and the sixth beat are different. In some embodiments, the fifth beat and the sixth beat maintain a constant ratio between each other. In some embodiments, the sixth beat is slower than the fifth beat. In some embodiments, the sixth beat is faster than the fifth beat. In some embodiments, the seventh beat and the eighth beat are equal. In some embodiments, the seventh beat and the eighth beat are different. In some embodiments, the seventh beat and the eighth beat maintain a constant ratio between each other. In some embodiments, the eighth beat is slower than the seventh beat. In some embodiments, the eighth beat is faster than the seventh beat. Providing audio of the first set of one or more instructions corresponding to the first skill at a second beat or a fourth beat based on prescribed conditions being met enables the computer system to customize audio instructions to perform a respective skill obtained from a media based on the audio characteristics of the media, thereby providing improved feedback to the user and/or performing an operation when a set of conditions has been met without requiring further user input.

In some embodiments, outputting, via the one or more output devices, the first set of one or more instructions corresponding to the first skill includes, in accordance with a determination that the content from the second computer system (e.g., 1390) corresponds to (e.g., has, assigned, associated with, and/or includes) a first tempo, providing, via the one or more output devices, audio of the first set of one or more instructions corresponding to the first skill in a second tempo (e.g., as described above with respect to FIG. 13C). In some embodiments, the first tempo and the second tempo are equal. In some embodiments, the first tempo and the second tempo are different. In some embodiments, the first tempo and the second tempo maintain a constant ratio between each other. In some embodiments, the second tempo is slower than the first tempo. In some embodiments, the second tempo is faster than the first tempo. In some embodiments, outputting, via the one or more output devices, the first set of one or more instructions corresponding to the first skill includes, in accordance with a determination that the content from the second computer system (e.g., 1390) corresponds to a third tempo, different from the first tempo, providing, via the one or more output devices, audio of the first set of one or more instructions corresponding to the first skill in a fourth tempo different from the second tempo (e.g., as described above with respect to FIG. 13C). In some embodiments, the third tempo and the fourth tempo are equal. In some embodiments, the third tempo and the fourth tempo are different. In some embodiments, the third tempo and the fourth tempo maintain a constant ratio between each other. In some embodiments, the fourth tempo is slower than the third tempo. In some embodiments, the fourth tempo is faster than the third tempo. In some embodiments, outputting, via the one or more output devices, the second set of one or more instructions corresponding to the second skill includes, in accordance with a determination that the content from the second computer system corresponds to a fifth tempo, providing, via the one or more output devices, audio of the second set of one or more instructions corresponding to the second skill in a sixth tempo and in accordance with a determination that the content from the second computer system corresponds to a seventh tempo, different from the fifth tempo, providing, via the one or more output devices, audio of the second set of one or more instructions corresponding to the second skill in an eighth tempo, different from the sixth tempo. In some embodiments, the fifth tempo and the sixth tempo are equal. In some embodiments, the fifth tempo and the sixth tempo are different. In some embodiments, the fifth tempo and the sixth tempo maintain a constant ratio between each other. In some embodiments, the sixth tempo is slower than the fifth tempo. In some embodiments, the sixth tempo is faster than the fifth tempo. In some embodiments, the seventh tempo and the eighth tempo are equal. In some embodiments, the seventh tempo and the eighth tempo are different. In some embodiments, the seventh tempo and the eighth tempo maintain a constant ratio between each other. In some embodiments, the eighth tempo is slower than the seventh tempo. In some embodiments, the eighth tempo is faster than the seventh tempo. Providing audio of the first set of one or more instructions corresponding to the first skill in a second tempo or a fourth tempo based on prescribed conditions being met enables the computer system to customize audio instructions to perform a respective skill obtained from a media based on the audio characteristics of the media, thereby providing improved feedback to the user and/or performing an operation when a set of conditions has been met without requiring further user input.

In some embodiments, the first computer system (e.g., 1300) is in communication with a second set of one or more cameras. In some embodiments, after outputting the first set of one or more instructions corresponding to the first skill, the first computer system captures, via the second set of one or more cameras (e.g., a telephoto camera, a wide-angle camera, an ultra-wide-angle camera, and/or a video camera), one or more images of a second user (e.g., the user and/or another user) performing actions corresponding to the first set of one or more instructions (e.g., as described above with respect to FIG. 13D). In some embodiments, the second set of one or more cameras captures the one or more images when the second user starts performing actions corresponding to the first set of one or more instructions. In some embodiments, the second set of one or more cameras captures the one or more images a predetermined period of time after the second user starts performing actions corresponding to the first set of one or more instructions. In some embodiments, after outputting the second set of one or more instructions corresponding to the second skill capturing, via the second set of one or more cameras (e.g., a telephoto camera, a wide-angle camera, an ultra-wide-angle camera, and/or a video camera), one or more images of the second user (e.g., the user and/or another user) performing actions corresponding to the second set of one or more instructions. Capturing one or more images of a second user performing actions corresponding to the first set of one or more instructions enables the computer system to detect the user's performance of instructions provided to the user, thereby reducing the number of inputs needed to perform an operation and/or providing improved visual feedback to the user.

In some embodiments, after capturing, via the second set of one or more cameras, the one or more images of the second user (e.g., the user and/or another user) performing the actions corresponding to the first set of one or more instructions the first computer system outputs, via the one or more output devices, a share request (e.g., 1320) (e.g., to broadcast, to transmit, to post, to email, and/or to publish) for the one or more images of the second subject performing actions corresponding to the first set of one or more instructions (e.g., as described above with respect to FIG. 13E). In some embodiments, after capturing, via the second set of one or more cameras, the one or more images of the second user performing the actions corresponding to the second set of one or more instructions outputting, via the one or more output devices, a share request for the one or more images of the second user performing actions corresponding to the second set of one or more instructions. Outputting a share request for the one or more images of the second user performing actions corresponding to the first set of one or more instructions enables the computer system to distribute images of a performance by a user to a variety of devices conveniently, thereby providing improved feedback to the user and/or reducing the number of inputs needed to perform an operation.

In some embodiments, after (e.g., in response to and/or in conjunction with) capturing, via the second set of one or more cameras (e.g., a telephoto camera, a wide-angle camera, an ultra-wide-angle camera, and/or a video camera), the one or more images of the second user performing actions corresponding to the first set of one or more instructions, in accordance with a determination that a first set of one or more criteria is satisfied (e.g., that the set of images should be cut in a particular way (e.g., based on context, relevance, importance, and/or style of a video and/or content)), the first computer system displays, via a second display component, a representation (e.g., 626A, 626B, and/or 626C) of a first portion of the one or more images of the second user performing actions corresponding to the first set of one or more instructions (e.g., as described above with respect to FIG. 13E). In some embodiments, the first portion of the one or more images of the second user performing actions corresponding to the first set of one or more instructions is cut from the one or more images of the second user performing actions corresponding to the first set of one or more instructions. In some embodiments, after capturing, via the second set of one or more cameras, the one or more images of the second user performing actions corresponding to the first set of one or more instructions, In accordance with a determination that a second set of one or more criteria, different from the first set of one or more criteria, is satisfied (e.g., that the set of images should be cut in a particular way (e.g., based on context, relevance, importance, and/or style of a video and/or content)), the first computer system displays, via the second display component, a representation of a second portion of the one or more images of the second user performing actions corresponding to the first set of one or more instructions, wherein the first portion of the one or more images of the second user performing actions corresponding to the first set of one or more instructions is larger than the second portion of the one or more images of the second user performing actions corresponding to the first set of one or more instructions (e.g., as described above with respect to FIG. 13E). In some embodiments, the second portion of the one or more images of the second user performing actions corresponding to the first set of one or more instructions is cut from the one or more images of the second user performing actions corresponding to the first set of one or more instructions. In some embodiments, the representation of the first portion of the one or more images of the second user performing actions corresponding to the first set of one or more instructions overlaps the representation of the second portion of the one or more images of the second user performing actions corresponding to the first set of one or more instructions. In some embodiments, the representation of the first portion of the one or more images of the second user performing actions corresponding to the first set of one or more instructions does not overlap the representation of the second portion of the one or more images of the second user performing actions corresponding to the first set of one or more instructions. In some embodiments, the representation of the first portion of the one or more images of the second user performing actions corresponding to the first set of one or more instructions includes portions of the representation of the second portion of the one or more images of the second user performing actions corresponding to the first set of one or more instructions. In some embodiments, the representation of the second portion of the one or more images of the second user performing actions corresponding to the first set of one or more instructions does not include all of the representation of the first portion of the one or more images of the second user performing actions corresponding to the first set of one or more instructions. In some embodiments, after capturing, via the second set of one or more cameras, the one or more images of the second user performing actions corresponding to the second set of one or more instructions: in accordance with a determination that a third set of one or more criteria (and/or a third input to edit the one or more images of the second user performing actions is received) is satisfied, displaying, via the second display component, a representation of a first portion of the one or more images of the second user performing actions corresponding to the second set of one or more instructions; and in accordance with a determination that a fourth set of one or more criteria (and/or a fourth input to edit the one or more images of the second user performing actions is received), different from the third set of one or more criteria, is satisfied, displaying, via the second display component, a representation of a second portion of the one or more images of the second user performing actions corresponding to the second set of one or more instructions, wherein the first portion of the one or more images of the second user performing actions corresponding to the second set of one or more instructions is larger than the second portion of the one or more images of the second user performing actions corresponding to the second set of one or more instructions. In some embodiments, after capturing, via the second set of one or more cameras, the one or more images of the second user performing actions corresponding to the first set of one or more instructions: in accordance with a determination that a fifth set of one or more criteria is satisfied (and/or a fifth input to edit the one or more images of the second user performing actions is received), outputting, via the one or more output devices, a first edited (e.g., deleting images of the one or more images, adding visual filters, adding sound filters, changing audio parameters, and/or changing playing speed) image, and in accordance with a determination that a sixth set of one or more criteria (and/or a sixth input to edit the one or more images of the second user performing actions is received), different from the fifth set of one or more criteria is satisfied, outputting, via the one or more output devices, a second edited image, wherein the first edited image is different form the second edited image. In some embodiments, after capturing, via the second set of one or more cameras, the one or more images of the second user performing actions corresponding to the second set of one or more instructions: in accordance with a determination that a seventh set of one or more criteria is satisfied (and/or a seventh input to edit the one or more images of the second user performing actions is received), outputting, via the one or more output devices, a third edited (e.g., deleting images of the one or more images, adding visual filters, adding sound filters, changing audio parameters, and/or changing playing speed) image, and in accordance with a determination that an eighth set of one or more criteria (and/or a eighth input to edit the one or more images of the second user performing actions is received), different from the seventh set of one or more criteria is satisfied, outputting, via the one or more output devices, a fourth edited image, wherein the third edited image is different form the fourth edited image. Displaying a representation of a first portion or a second portion of the one or more images of the second user performing actions corresponding to the first set of one or more instructions based on prescribed conditions being met enables the computer system to customize the captured performance to only relevant portions of performance, thereby providing improved feedback to the user and/or performing an operation when a set of conditions has been met without requiring further user input.

In some embodiments, the one or more output devices includes a third display component (e.g., a display screen, a projector, and/or a touch-sensitive display). In some embodiments, after capturing, via the second set of one or more cameras, the one or more images of the second user performing actions corresponding to the first set of one or more instructions, in accordance with a determination that a third set of one or more criteria is satisfied (e.g., that the set of images should be edited and/or saved in a particular way (e.g., based on user input, on context, on relevance, on importance, and/or on style of a video and/or content)), the first computer system edits a respective image of the one or more images of the second user performing actions corresponding to the first set of one or more instructions and displaying via the third display component, an indication of the edited respective image (e.g., as described above with respect to FIG. 13E). In some embodiments, after capturing, via the second set of one or more cameras, the one or more images of the second user performing actions corresponding to the first set of one or more instructions, in accordance with a determination that a fourth set of one or more criteria is satisfied (e.g., that the set of images should be edited and/or saved in a particular way (e.g., based user input, on context, relevance, importance, and/or style of a video and/or content)), the first computer system forgoes editing the one or more images of the second user performing actions corresponding to the first set of one or more instructions and forgoing displaying, via the third display component, the indication of the edited respective image (e.g., as described above with respect to FIG. 13E). Editing or not editing a respective image of the one or more images of the second user performing actions corresponding to the first set of one or more instructions based on prescribed conditions being met enables the computer system to customize the captured performance to only relevant portions of performance, thereby providing improved feedback to the user and/or performing an operation when a set of conditions has been met without requiring further user input.

In some embodiments, the one or more output devices includes a fourth display component. In some embodiments, after (e.g., in response to and/or in conjunction with) capturing, via the second set of one or more cameras (e.g., a telephoto camera, a wide-angle camera, an ultra-wide-angle camera, and/or a video camera), the one or more images of the second user performing actions corresponding to the first set of one or more instructions, in accordance with a determination that the one or more images of the second user performing actions corresponding to the first set of one or more instructions, the first computer system generates a first set of one or more hashtags (e.g., labels, identifiers, categorizations, groupings, and/or characteristics) for the one or more images of the second user performing actions corresponding to the first set of one or more instructions (e.g., as described above with respect to FIG. 13E). In some embodiments, the first set of one or more hashtags for the one or more images of the second user performing actions corresponding to the first set of one or more instructions are displayed. In some embodiments, after capturing, via the second set of one or more cameras, the one or more images of the second user performing actions corresponding to the first set of one or more instructions, In accordance with a determination that the one or more images of the second user performing actions corresponding to the first set of one or more instructions, the first computer system generates a second set of one or more hashtags, different from the first set of hashtags, for the one or more images of the second user performing actions corresponding to the first set of one or more instructions (e.g., as described above with respect to FIG. 13E). In some embodiments, the second set of one or more hashtags for the one or more images of the second user performing actions corresponding to the first set of one or more instructions are displayed. In some embodiments, after capturing, via the second set of one or more cameras, the one or more images of the second user performing actions corresponding to the second set of one or more instructions in accordance with a determination that the one or more images of the second user performing actions corresponding to the second set of one or more instructions, generate a third set of one or more hashtags for the one or more images of the second user performing actions corresponding to the second set of one or more instructions; and in accordance with a determination that the one or more images of the second user performing actions corresponding to the second set of one or more instructions, generate a fourth set of one or more hashtags, different from the third set of hashtags, for the one or more images of the second user performing actions corresponding to the second set of one or more instructions. In some embodiments, the third set of one or more hashtags for the one or more images of the second user performing actions corresponding to the second set of one or more instructions are displayed. In some embodiments, the fourth set of one or more hashtags for the one or more images of the second user performing actions corresponding to the second set of one or more instructions are displayed. Generating a first set of one or more hashtags or a second set of one or more hashtags for the one or more images of the second user performing actions corresponding to the first set of one or more instructions based on prescribed conditions being met enables the computer system to accurately classify images across multiple categories, thereby providing improved visual feedback to the user and/or performing an operation when a set of conditions has been met without requiring further user input.

In some embodiments, the data corresponding to the content is (and/or includes) social media content (e.g., as described above with respect to FIG. 13E) (e.g., blogs, profiles, pictures, videos, and/or posts). Having the data corresponding to the content be social media content enables the computer system to provide instructions on how to replicate actions shared on social media, thereby performing an operation when a set of conditions has been met without requiring further user input.

Note that details of the processes described above with respect to process 1500 (e.g., FIG. 15) are also applicable in an analogous manner to the methods described below/above. For example, process 1400 optionally includes one or more of the characteristics of the various methods described above with reference to process 1500. For example, the content of process 1400 can be the data of process 1500. For brevity, these details are not repeated below.

The description above, has been described with reference to specific examples for the purpose of explanation. Such specific examples can be in the form of textual description above and/or in the accompanying drawings. However, such examples should not be interpreted as being exhaustive or limiting to the disclosure (e.g., limiting to the explicit manners described herein). Many modifications and variations are possible in view of the above teachings by one of ordinary skill in the art without departing from the scope of the present disclosure.

Aspects of the technology described above can include gathering and/or using data from various sources. Such data can include demographic data, telephone numbers, email addresses, location and/or location-related data, home addresses, work addresses, and/or any other identifying information. In some scenarios, such data can include personal information that is usable to uniquely identify a specific person. Such data can be used to improve interactions that a device has with its environment (e.g., interactions with users). The use of such data can require one or more entities handling such data. These entities can be involved in collecting, processing, disclosing, transferring, storing, or other functions that support the technologies described herein. The present disclosure expects that (e.g., does not preclude) that all use of such data complies with well-established privacy policies and/or privacy practices by such entities. As a general matter, such policies and practices should meet or exceed generally recognized industry standards and comply with all applicable data privacy and security-related governmental requirements. In particular, for example, entities should receive informed consent from users to collect and/or use such data, and such collection and/or use should only be for legitimate and reasonable uses. Further, such data should not be shared, disclosed, sold, and/or provided for uses other than legitimate and/or reasonable uses. Various scenarios can arise in which such data is not available, such as when a user selects not to share such data. For example, the user can withhold consent for collection and/or use of such data (e.g., “opt out” of sharing such data and/or not explicitly “opt in” during a registration process). The user can also employ the use of any of various hardware and/or software components that prevent collection and/or use of such data. While the use of such data can benefit a user by improving the operation of the device, the present disclosure contemplates that embodiments of the present technology can be used without such data. For example, operations of the device can use other data (e.g., instead of and/or in place of such data). Other techniques include making inferences based on other data or a minimal amount of such data. The use of such data can be utilized for the benefit of users of the device. For example, such data can be used to improve interactions that the device engages in with the user. Other benefits from the use for such data are also possible and within the scope of the present disclosure.

What is claimed is:

1. A method, comprising:
at a computer system that is in communication with a movement component:
while the computer system is at a first position in an environment, receiving a notification corresponding to a respective user; and
in response to receiving the notification corresponding to the respective user:
in accordance with a determination that the notification corresponds to a first user, moving, via the movement component, a portion of the computer system to a second position, different from the first position, in the environment, wherein the second position corresponds to a location of the first user in the environment; and
in accordance with a determination that the notification corresponds to a second user, different from the first user, moving, via the movement component, the portion of the computer system to a third position, different from the first position and the second position, in the environment, wherein the third position corresponds to a location of the second user in the environment.

2. The method of claim 1, wherein receiving the notification corresponding to the first user includes receiving a request to connect to a communication session between the first user and a third user different from the first user and the second user.

3. The method of claim 1, wherein the notification is a message that was sent.

4. The method of claim 1, wherein:
in accordance with a determination that the location of the first user in the environment is a first location, the second position corresponds to the first location; and
in accordance with a determination that the location of the first user in the environment is a second location different from the first location, the second position corresponds to the second location.

5. The method of claim 4, wherein:
in accordance with a determination that the location of the first user in the environment is the first location, the computer system does not move to a position corresponding to the second location; and
in accordance with a determination that the location of the first user in the environment is the second location, the computer system does not move to a position corresponding to the first location.

6. The method of claim 1, further comprising:
in response to receiving the notification corresponding to the respective user:
in accordance with a determination that a first number of users are detected in the environment, moving, via the movement component, the portion of the computer system toward a first area of the environment; and
in accordance with a determination that a second number of users, different from the first number of users, are detected in the environment, moving, via the movement component, the portion of the computer system toward a second area, different from the first area, of the environment.

7. The method of claim 1, further comprising:
in response to receiving the notification corresponding to the respective user:
in accordance with a determination that a first type of user is detected in the environment, moving, via the movement component, the portion of the computer system toward a third area in the environment; and
in accordance with a determination that the first type of user is not detected in the environment, moving, via the movement component, the portion of the computer system toward a fourth area, different from the third area, in the environment.

8. The method of claim 1, wherein moving the portion of the computer system to the second position includes translating, via the movement component, the portion of the computer system from a first lateral position to a second lateral position different from the first lateral position.

9. The method of claim 1, wherein moving the portion of the computer system to the second position includes tilting, via the movement component, the portion of the computer system from a first tilt position to a second tilt position different from the first tilt position.

10. The method of claim 1, wherein moving the portion of the computer system to the second position includes rotating, via the movement component, the portion of the computer system from a first rotational position to a second rotational position different from the first rotational position.

11. The method of claim 1, further comprising:
while the computer system is at the second position in the environment, receiving a notification corresponding to a fourth user; and
in response to receiving the notification corresponding to the fourth user:
in accordance with a determination that the fourth user is detected in the environment, moving, via the movement component; and
in accordance with a determination that the fourth user is not detected in the environment, forgoing moving, via the movement component.

12. The method of claim 1, further comprising:
while the computer system is at the second position in the environment, receiving a notification corresponding to a fifth user; and
in response to receiving the notification corresponding to the fifth user:
in accordance with a determination that the fifth user is detected in the environment, moving, via the movement component, the portion of the computer system in a manner that is based on the location of the fifth user; and
in accordance with a determination that the fifth user is not detected in the environment, moving, via the movement component, the portion of the computer system in a manner that is not based on the location of the fifth user.

13. The method of claim 1, further comprising:
while the computer system is at the second position in the environment, receiving a notification corresponding to a sixth user; and
in response to receiving the notification corresponding to the sixth user:
in accordance with a determination that the sixth user is detected in the environment, moving, via the movement component, the portion of the computer system in the manner that is not based on the location of the sixth user.

14. A non-transitory computer-readable storage medium storing one or more programs configured to be executed by one or more processors of a computer system that is configured to be in communication with a movement component, the one or more programs including instructions for:
while the computer system is at a first position in an environment, receiving a notification corresponding to a respective user; and
in response to receiving the notification corresponding to the respective user:
in accordance with a determination that the notification corresponds to a first user, moving, via the movement component, a portion of the computer system to a second position, different from the first position, in the environment, wherein the second position corresponds to a location of the first user in the environment; and
in accordance with a determination that the notification corresponds to a second user, different from the first user, moving, via the movement component, the portion of the computer system to a third position, different from the first position and the second position, in the environment, wherein the third position corresponds to a location of the second user in the environment.

15. A computer system that is configured to be in communication with a movement component, comprising:
one or more processors; and
memory storing one or more programs configured to be executed by the one or more processors, the one or more programs including instructions for:
while the computer system is at a first position in an environment, receiving a notification corresponding to a respective user; and
in response to receiving the notification corresponding to the respective user:
in accordance with a determination that the notification corresponds to a first user, moving, via the movement component, a portion of the computer system to a second position, different from the first position, in the environment, wherein the second position corresponds to a location of the first user in the environment; and
in accordance with a determination that the notification corresponds to a second user, different from the first user, moving, via the movement component, the portion of the computer system to a third position, different from the first position and the second position, in the environment, wherein the third position corresponds to a location of the second user in the environment.
